(19) United States
(12) Patent Application Publication
(10) Pub. No.: US 2026/0323196 A1
(43) Pub. Date: Oct. 15, 2026

(54) INTELLIGENT SPEAKER, AUTOMATIC MICROPHONE LIFTING STRUCTURE AND CONTROL METHOD

(71) Applicant: GUANGDONG TAIDE ZHILIAN TECHNOLOGY CO., LTD, Dongguan (CN)

(72) Inventors: Wei LIU, Dongguan (CN); Xilin XIE, Dongguan (CN); Qiangde ZHOU, Dongguan (CN); Zhi YANG, Dongguan (CN); Yuanxiong LAN, Dongguan (CN); Senxiao ZHANG, Dongguan (CN)

(21) Appl. No.: 19/700,627

(22) Filed: Jun. 8, 2026

Related U.S. Application Data
(63) Continuation of application No. PCT/CN2025/070540, filed on Jan. 3, 2025.

(30) Foreign Application Priority Data
Mar. 18, 2024 (CN) 2024205274172
May 30, 2024 (CN) 2024212103667
Sep. 30, 2024 (CN) 2024223977049
Oct. 31, 2024 (CN) 2024226454565
Oct. 31, 2024 (CN) 2024226454828
Nov. 5, 2024 (CN) 202422690813X
Nov. 5, 2024 (CN) 2024115636827
Nov. 5, 2024 (CN) 2024226908036
Nov. 5, 2024 (CN) 2024226908040
Nov. 5, 2024 (CN) 2024226908089
Nov. 5, 2024 (CN) 2024226908093

(51) Int. Cl. H04R 1/08; H02J 7/70; H04R 1/02; H04R 5/02

(52) U.S. Cl. CPC H04R 1/08; H02J 7/731; H04R 1/028; H04R 5/02; H04R 2499/15

(57) ABSTRACT

A smart speaker, an automatic microphone lifting structure and a control method. The automatic microphone lifting structure comprises a speaker body and at least one microphone; a screen is connected to the speaker body; a storage groove for storing the microphone is formed on the speaker body; the storage groove is provided with a receiving assembly electrically connected to the screen or the speaker body; when the screen is opened or closed, the receiving assembly automatically lifts or stores the microphone in the storage groove.

The application claims priority from the following Chinese patent applications:
1. Priority of the Chinese patent application entitled “Smart Speaker and Control Method Thereof”, filed with China National Intellectual Property Administration on Nov. 5, 2024, with application number 202411563682.7;
2. Priority of the Chinese patent application entitled “Automatic Lifting Structure for Microphone”, filed with China National Intellectual Property Administration on Mar. 18, 2024, with application number 202420527417.2;
3. Priority of the Chinese patent application entitled “Microphone Storage Device and Smart Speaker”, filed with China National Intellectual Property Administration on Oct. 31, 2024, with application number 202422645456.5;
4. Priority of the Chinese patent application entitled “Smart Speaker”, filed with China National Intellectual Property Administration on Oct. 31, 2024, with application number 202422645482.8;
5. Priority of the Chinese patent application entitled “Microphone Storage Structure and Electronic Device”, filed with China National Intellectual Property Administration on Nov. 5, 2024, with application number 202422690803.6;
6. Priority of the Chinese patent application entitled “Intelligent Acoustic Device”, filed with China National Intellectual Property Administration on May 30, 2024, with application number 202421210366.7;
7. Priority of the Chinese patent application entitled “Intelligent Microphone Accommodating Assembly and Smart Device”, filed with China National Intellectual Property Administration on Nov. 5, 2024, with application number 202422690813.X;
8. Priority of the Chinese patent application entitled “Smart Device”, filed with China National Intellectual Property Administration on Nov. 5, 2024, with application number 202422690808.9;
9. Priority of the Chinese patent application entitled “Smart Device”, filed with China National Intellectual Property Administration on Nov. 5, 2024, with application number 202422690804.0;
10. Priority of the Chinese patent application entitled “Intelligent Microphone Storage Assembly and Smart Device”, filed with China National Intellectual Property Administration on Nov. 5, 2024, with application number 202422690809.3;
11. Priority of the Chinese patent application entitled “Microphone Storage Structure and Smart Speaker”, filed with China National Intellectual Property Administration on Sep. 30, 2024, with application number 202422397704.9;

The entire contents of the above patent applications are incorporated herein by reference.

### TECHNICAL FIELD

The invention relates to the technical field of acoustic devices, in particular to a smart speaker, an automatic microphone lifting structure, and a control method.

### BACKGROUND ART

A speaker refers to an electronic device capable of producing sound, and is generally used for amplifying and playing audio signals. With the development of technology, smart speakers that only play sound can no longer meet user needs, and smart karaoke speakers with microphones have emerged as a result. Existing smart karaoke speakers are equipped with built-in microphones for users. A microphone storage structure is arranged on the smart speaker body, facilitating storage when the microphone is not in use. In the prior art, a fixing mechanism is required to fix the microphone when the microphone storage structure is in use. Existing fixing mechanisms are usually purely mechanical structures including a swing arm and a torsion spring, which tend to fail in locking or rebounding due to angle compatibility issues, resulting in insufficient stability and affecting the use efficiency of the microphone.

### SUMMARY OF THE INVENTION

The first purpose of the invention is to provide a smart speaker, which aims to solve the technical problems existing in the existing microphone storage structure, such as insufficient stability, and easy ingress of dust or other foreign matters caused by a large gap between the microphone and the storage groove, thereby affecting the use of the microphone.

To solve the abovementioned technical problems, the invention provides a smart speaker, comprising:
a speaker body;
a microphone storage assembly, arranged inside the speaker body and comprising a drive assembly and a bearing seat for bearing the microphone; the drive assembly is arranged opposite to the bearing seat and is connected to the bearing seat to drive the bearing seat to move along a first direction.

Further, the drive assembly comprises a drive motor and a gear; the gear is connected to a drive end of the drive motor, and the bearing seat is formed with a rack portion engaged with the gear.

Further, the microphone storage assembly further comprises a charging portion; the bearing seat is formed with a storage groove for storing the microphone; the storage groove is provided with an opening; the charging portion is arranged at one end of the storage groove remote from the opening.

Further, the bearing seat is provided with a first magnetic attraction component; the microphone is provided with a second magnetic attraction component matched with the first magnetic attraction component.

Further, the drive assembly is located on one side of the bearing seat.

Further, the microphone storage assembly comprises a fixing seat; the fixing seat is formed with a mounting groove, and the bearing seat is slidably mounted in the mounting groove.

Further, the fixing seat comprises a seat body and a guide post; the mounting groove is formed on the seat body; the guide post is arranged in the mounting groove; the bearing seat is slidably connected to the guide post.

Further, the speaker body comprises a housing; the housing comprising a peripheral side plate, a top plate and a bottom plate; the top plate and the bottom plate are respectively connected to opposite sides of the peripheral side plate; diffusion slots are distributed on the peripheral side plate; assume the area of the peripheral side plate to be S1, and assume the total area of all diffusion slots on the peripheral side plate to be S2, then the ratio S2/S1 is not less than 0.4.

Further, the guide post is mounted on the peripheral side plate or the bottom plate.

Further, the housing comprises an inner housing and an outer housing; the inner housing is nested within the outer housing; the diffusion slots are arranged on the outer housing; the inner housing comprises a front shell plate and a rear shell plate arranged on opposite sides.

Further, the speaker body further comprises a high-frequency speaker, a low-frequency speaker and a full-frequency speaker; the high-frequency speaker and the low-frequency speaker are mounted on the front shell plate, and the full-range speaker is mounted on the rear shell plate.

Further, the speaker body further comprises a screen, a damping shaft and a sensor; the screen is rotatably connected to the top plate via the damping shaft to close or open the storage groove; the sensor is used to detect the position of the screen.

The second purpose of the invention is to provide a control method for the smart speaker, which is used for controlling the smart speaker, comprising the following: when a first preset condition is satisfied, the microphone rises to a first position; otherwise, the microphone does not rise.

Further, when the first preset condition is satisfied, the method comprises the following: the smart speaker is powered on and started up, and the screen is turned on;
detecting an included angle between the top surface of the smart speaker and the screen, wherein the included angle is greater than or equal to a preset angle.

Further, when the second preset condition is satisfied, the microphone falls from a second position to a first position.

Further, the second preset condition comprises: the power supply of the speaker body is turned off; or the included angle is smaller than the preset angle; or the smart speaker receives a microphone storage instruction.

Further, when the second preset condition is satisfied, the microphone falls at a first speed; when the third preset condition is satisfied, the microphone falls at a second speed, and the second speed is greater than the first speed.

Further, when the fourth preset condition is satisfied, the microphone is determined to be unnecessary for use, and the microphone falls from the second position to the first position.

Further, when the fifth preset condition is satisfied, the microphone is determined to need to be raised again, and the microphone rises from the second position to the first position.

The embodiment of the invention has the following beneficial effects:

In the smart speaker according to this embodiment, the storage structure is modified to be motor-driven. Since motor driving enables more precise control, the positioning of the microphone during storage and retrieval is more accurate. In addition, a motor-driven structure is generally more stable and reduces gap variations caused by vibration or impact. Therefore, in the microphone storage assembly of the application, the gap between the storage groove and the microphone can be very small, and no guide groove is provided at the opening of the storage groove, which helps prevent dust or other foreign matters from entering the storage groove through the guide groove, thereby improving the stability of the microphone storage assembly and extending the service life of the microphone storage assembly and the microphone.

An automatic microphone lifting structure comprises a speaker body and at least one microphone; a screen is connected to the speaker body; a storage groove for storing the microphone is formed on the speaker body; the storage groove is provided with a receiving assembly electrically connected to the screen or the speaker body; when the screen is opened or closed, the receiving assembly automatically lifts or stores the microphone in the storage groove.

Preferably, a sensor is arranged in the screen or the speaker body, is electrically connected to the receiving assembly, and is used for sensing the rotation direction and angle of the screen or sensing the distance between the screen and the top surface of the placement slot to realize automatic lifting or storage of the microphone through the receiving assembly.

Preferably, the receiving assembly comprises a first magnetic attraction component and a second magnetic attraction component, and the first magnetic attraction component and the second magnetic attraction component generate identical or opposite magnetic forces; the first magnetic attraction component is arranged at the bottom of the microphone, and the second magnetic attraction component is arranged at the bottom of the storage groove; or the first magnetic attraction component is arranged at the bottom of the storage groove, and the second magnetic attraction component is arranged at the bottom of the microphone.

Preferably, both the first magnetic attraction component and the second magnetic attraction component are magnetic induction coils, which generate identical or opposite magnetic forces; or the first magnetic attraction component is a magnetic induction coil, and the second magnetic attraction component is a magnet; the magnetic induction coil is used to generate a magnetic force identical or opposite to that of the magnet.

Preferably, the upper surface of the speaker body is concave downward to form a placement slot, the screen is flipped and received in the placement slot, and the opening of the storage groove is located at the bottom of the placement slot.

Preferably, the number of the storage grooves corresponds to the number of microphones one to one; the depth of each storage groove is greater than or equal to the height of the microphone; the microphone is movably lifted or stored in the storage groove.

Preferably, a limit groove is provided on the outer circumference of the bottom of the microphone; a plurality of damping structures matched with the limit groove are arranged on the inside wall of the storage groove.

Preferably, the damping structures are arranged along the circumferential direction of the storage groove; the damping structures are silicone strips or rubber strips arranged on the inside wall of the storage groove. Preferably, a control button is arranged on the speaker body, is electrically connected to the receiving assembly and controls the operation of the receiving assembly;
or a control button is arranged on the microphone, is electrically connected to the receiving assembly and controls the operation of the receiving assembly;

Preferably, a voice control module is arranged inside the speaker body, is electrically connected to the receiving assembly and controls the operation of the receiving assembly.

Compared with the prior art, the invention has the following beneficial effects: the screen is used as a signal for activating the receiving assembly, and the receiving assembly automatically lifts or stores the microphone, thereby realizing automatic lifting or storage of the microphone in the storage groove. This solves the problems of lifting failure and locking failure of the microphone associated with manual pressing in the prior art, hereby improving the user experience.

A microphone storage device for storing the microphone, comprising a seat body with an accommodating cavity open at one end; a gear arranged beside the seat body and extending into the accommodating cavity such that the gear abuts against the microphone placed in the seat body; a drive motor arranged beside the gear, in driving connection with the gear and used for driving the gear to displace the microphone in the accommodating cavity.

Further, the microphone storage device further comprises a support and guide assembly, which is arranged beside the gear; when the microphone is placed in the accommodating cavity, the support and guide assembly is used to guide or fix the microphone during storage.

Further, the support and guide assembly comprises a pulley and a support shell fixed on the seat body; the pulley is connected to the support shell through a bearing.

Further, two support and guide assemblies are arranged; the gear and the two support and guide assemblies are arranged at equal intervals in the radial direction perpendicular to the central axis of the seat body.

Further, the length from the opening of the seat body to the gear is a first preset value, and the length from the bottom of the seat body to the gear is a second preset value; the first preset value is smaller than the second preset value.

Further, the gear comprises a gear, the drive motor is a motor, and the gear is in drive connection with the rotating shaft of the motor.

Further, the surface layer of the gear is covered with a first buffer layer.

Further, a sensing assembly is arranged at the opening of the seat body.

A smart speaker, comprising a microphone storage device, a speaker body and a microphone; the speaker body is provided with a storage groove, the microphone storage device is mounted in the storage groove, and the microphone is placed in the microphone storage device.

Further, the surface layer of the microphone is covered with a second buffer layer, which is the same as or different from the first buffer layer.

The invention has the following beneficial effects: In the application, the gear driven by the drive motor abuts against the microphone, and the microphone is driven to fall into the seat body by friction force; the seat body guides the displacement direction of the microphone during storage to realize automatic storage of the microphone; the movement speed of the gear can be precisely controlled by controlling the driving power of the drive motor, so that the falling speed and force of the microphone can be stably controlled, thereby reducing noise and vibration caused by shaking or impact of the microphone.

A smart speaker, comprising a speaker body, a telescopic assembly and a drive motor, wherein the speaker body is provided with a mounting groove; a microphone storage assembly is mounted in the mounting groove; the microphone storage assembly comprises a base located inside the speaker body; the telescopic assembly is located inside the base and is telescopic along the base; the drive motor is arranged on the base, is in driving connection with the telescopic assembly and drives the telescopic assembly to extend and retract.

Further, the drive motor comprises a rotary drive mechanism; the telescopic assembly comprises a lifting component and a rotating component, and the rotating component is in driving connection with the drive end of the rotary drive mechanism; the lifting component and the rotating component are connected through a transmission structure, which is used for converting the rotary motion of the rotating component into the lifting motion of the lifting component.

Further, the transmission structure comprises a first thread provided on the lifting component and a second thread provided on the rotating component, and the first thread and the second thread are fittingly connected with each other.

Further, the rotating component comprises a rotating cylinder, and the second thread is arranged inside the rotating cylinder; the lifting component comprises a lifting cylinder, and the first thread is arranged on the outer side of the lifting cylinder.

Further, a guide portion is arranged inside the seat body; the telescopic assembly is provided with a limit portion matched with the guide portion; the telescopic assembly extends and retracts along the guide portion via the limit portion.

Further, the guide portion comprises a guide protrusion, and the limit portion comprises a limit groove.

Further, a magnetic layer is arranged inside the lifting component.

Further, a sensing assembly is arranged at the opening of the seat body.

Further, a hollow placement layer is formed between the bottom of the rotating component and the bottom of the seat body and is designed to place electronic components.

Further, reinforcing ribs are arranged on the rotating component.

The invention has the following beneficial effects: The invention uses the drive motor and the telescopic assembly to replace the traditional mechanical reciprocating motion; the drive motor controls the telescopic assembly to extend and retract in the seat body to realize the storage and removal of the microphone; this design avoids noise generated by physical impact and mechanical friction, thereby significantly reducing the noise level during the storage and removal of the microphone.

A microphone storage device, comprising a housing, a lifting assembly, a microphone and at least one storage groove for accommodating the microphone;

an opening connected to the outer wall of the housing is arranged at one end of the storage groove; the lifting assembly is arranged at the end of the storage groove away from the opening; the lifting assembly is connected to the microphone to drive the microphone to reciprocate between a first position and a second position in the storage groove.

Optionally, a plurality of storage grooves are provided, and the lifting assembly is arranged at the end of each storage groove away from the opening.

Optionally, the lifting assembly is installed inside the housing; the lifting assembly comprises a lifting motor, a fixing seat and a lead screw connected with the output shaft of the lifting motor; a threaded hole is formed at the bottom of the fixing seat, and the lead screw is in threaded connection with the threaded hole; when the lifting motor drives the lead screw to rotate, the lead screw drives the fixing seat to move; the microphone is detachably connected to the fixing seat, and the fixing seat is driven to move and drive the microphone to reciprocate between the first position and the second position in the storage groove.

Optionally, a limit seat is also comprised; the limit seat is arranged inside the housing, the fixing seat is movably arranged in the limit seat, and the lead screw passes through the limit seat and is in threaded connection with the threaded hole of the fixing seat.

Optionally, a sleeve movably sleeved on the fixing seat is also comprised; the sleeve is fixedly connected to the limit seat; an elastic clamping jaw is arranged on the fixing seat; a limit groove used with the clamping jaw is formed on the outer wall of the microphone; a guide inclined surface is arranged on the inner wall of the sleeve; an abutting surface used with the guide inclined surface is arranged on the outer side of the clamping jaw; when the microphone is stored in the storage groove, the bottom of the guide inclined surface abuts against the abutting surface, so that the clamping jaw is clamped into the limit groove, thereby fixing the microphone on the fixing seat.

When the fixing seat is driven to move upward so that the microphone rises along the storage groove, the abutting surface slides towards the guide inclined surface. After the abutting surface slides away from the guide inclined surface, the clamping jaw is separated from the limit groove under the action of elastic force.

Optionally, the microphone storage structure further comprises a charging assembly for charging the microphone.

The charging assembly comprises a first charging portion arranged on the microphone and a second charging portion arranged on the fixing seat; the first charging portion is electrically connected to the second charging portion to charge the microphone.

Optionally, a sealing gasket is also comprised; the sealing gasket is arranged between the sleeve and the limit seat.

The invention provides an electronic device, comprising a speaker, a screen, a control circuit board and the microphone storage structure; the speaker is installed inside the housing of the microphone storage structure, and the screen is hinged to the housing; the control circuit board is installed inside the housing, and the speaker, the screen, and the lifting assembly of the microphone storage structure are all electrically connected to the control circuit board; a communication module is also electrically connected to the control circuit board, and the microphone of the microphone storage structure is wirelessly connected to the control circuit board through the communication module.

Optionally, a placement slot for accommodating the screen is provided on the outer wall of the housing and is recessed toward the interior of the housing; when rotating to a preset angle relative to the housing, the screen is stored in the placement slot and is flush with the outer wall of the housing.

Compared with the prior art, the invention has the following beneficial effects:

In the microphone storage structure of the embodiment, when needing to use the microphone, the user controls the lifting assembly to drive the microphone to automatically extend out of the opening of the storage groove, and the user can directly take out and use the microphone; when not needing to use the microphone, the user directly inserts the microphone into the storage groove, and then the lifting assembly drives the microphone to automatically fall and be stored in the storage groove. Through the above design, the user can pick and place the microphone simply and directly, which greatly reduces the picking and placing difficulty, effectively improves the picking and placing efficiency, and brings a good user experience.

### BRIEF DESCRIPTION OF THE DRAWINGS

To more clearly describe the technical solutions in the embodiments of the invention or in the prior art, the drawings required for use in the description of the embodiments or the prior art will be briefly introduced below. Obviously, the drawings in the following description are merely embodiments of the invention. For those of ordinary skill in the art, other drawings may also be derived from these drawings without creative efforts.

FIG. 1 is an exploded view of the microphone storage assembly according to the embodiment of the invention;

FIG. 2 is a structural diagram of a part of the microphone storage assembly according to the embodiment of the invention;

FIG. 3 is a section view of the microphone storage assembly according to one embodiment of the invention;

FIG. 4 is an enlarged view of part A in FIG. 3;

FIG. 5 is a section view of the microphone storage assembly according to another embodiment of the invention;

FIG. 6 is a structural diagram of the elastic sleeve according to the embodiment of the invention;

FIG. 7 is a structural diagram of the smart speaker according to the embodiment of the invention;

FIG. 8 is a structural diagram of the smart speaker with the outer housing removed from the first perspective according to the embodiment of the invention;

FIG. 9 is a structural diagram of the smart speaker with the outer housing removed from a second perspective according to the embodiment of the invention;

FIG. 10 is a structural diagram of the circumferential side plate according to the embodiment of the invention;

FIG. 11 is a structural diagram of the smart speaker with the outer housing removed from a third perspective according to the embodiment of the invention;

FIG. 12 is a structural diagram of the microphone stored in the smart speaker with the screen opened according to the embodiment of the invention;

FIG. 13 is an enlarged view of part B in FIG. 12;

FIG. 14 is a front view of the smart speaker according to the embodiment of the invention;

FIG. 15 is a rear view of the smart speaker according to the embodiment of the invention;

FIG. 16 is a left view of the smart speaker according to the embodiment of the invention;

FIG. 17 is a right view of the smart speaker according to the embodiment of the invention;

FIG. 18 is a top view of the smart speaker according to the embodiment of the invention;

FIG. 19 is a bottom view of the smart speaker according to the embodiment of the invention;

FIG. 20 is a perspective view of the smart speaker according to the embodiment of the invention from one perspective;

FIG. 21 is a perspective view of the smart speaker according to the embodiment of the invention from another perspective;

FIG. 22 is a schematic diagram of the microphone in the first position according to the embodiment of the invention;

FIG. 23 is a schematic diagram of the microphone in the second position according to the embodiment of the invention;

FIG. 24 is a structural diagram of the automatic microphone lifting mechanism according to the embodiment of the invention;

FIG. 25 is an exploded view of the speaker body and the microphone of the automatic microphone lifting structure according to the embodiment of the invention;

FIG. 26 is a section view of the speaker body and the microphone of the automatic microphone lifting structure according to the embodiment of the invention;

FIG. 27 is a structural diagram of the speaker body and the microphone of the automatic microphone lifting structure according to the embodiment of the invention;

FIG. 28 is a structural diagram of the speaker body and the microphone of the automatic microphone lifting structure according to the embodiment of the invention;

FIG. 29 is an overall structural diagram of the microphone storage assembly according to the embodiment of the invention;

FIG. 30 is a structural diagram of the smart speaker with the microphone storage assembly according to the embodiment of the invention;

FIG. 31 is a schematic diagram of the storage abutting structure of the microphone storage assembly according to the embodiment of the invention;

FIG. 32 is a section view of the microphone storage assembly according to the embodiment of the invention;

FIG. 33 is a section view of the microphone in a released state according to the embodiment of the invention;

FIG. 34 is a section view of the microphone in a stored state according to the embodiment of the invention;

FIG. 35 is a structural diagram of the microphone storage structure according to the embodiment of the invention;

FIG. 36 is a section view of the internal structure of the microphone storage assembly according to the embodiment of the invention;

FIG. 37 is a structural diagram of the speaker body according to the embodiment of the invention;

FIG. 38 is an exploded view of the microphone storage assembly according to the embodiment of the invention;

FIG. 39 is a structural section view of the microphone storage assembly according to the embodiment of the invention;

FIG. 40 is a structural section view of the microphone storage assembly in a stored state according to the embodiment of the invention;

FIG. 41 is a structural section view of the microphone storage assembly in a non-stored state according to the embodiment of the invention;

FIG. 42 is a structural diagram of the seat body according to the embodiment of the invention;

FIG. 43 is a structural diagram of the rotating component according to the embodiment of the invention;

FIG. 44 is a structural diagram of the lifting component according to the embodiment of the invention;

FIG. 45 is a structural diagram of the microphone storage assembly according to the embodiment of the invention;

FIG. 46 is a structural diagram of the lifting assembly of the microphone storage assembly connected to the fixing seat (with the limit seat and the sleeve hidden) according to the embodiment of the invention;

FIG. 47 is a section view of the lifting assembly of the microphone storage assembly connected to the fixing seat (with the limit seat and the sleeve hidden) according to the embodiment of the invention;

FIG. 48 is a structural diagram of the fixing seat of the microphone storage assembly in the first embodiment of the charging assembly according to the invention;

FIG. 49 is a structural diagram of the microphone of the microphone storage assembly in the first embodiment of the charging assembly according to the invention;

FIG. 50 is a structural diagram of the sleeve of the microphone storage assembly provided by the invention;

FIG. 51 is a structural diagram of the fixing seat of the microphone storage assembly in the third embodiment of the charging assembly according to the invention;

FIG. 52 is a structural diagram of the microphone of the microphone storage assembly in the third embodiment of the charging assembly according to the invention;

FIG. 53 is a structural diagram of the fixing seat and the microphone of the microphone storage assembly in the second embodiment of the charging assembly according to the invention;

FIG. 54 is a state diagram of the electronic device of the invention when the screen is stored in the placement slot;

FIG. 55 is a structural diagram of the electronic device of the invention when the screen is hidden;

FIG. 56 is a structural diagram of the microphone placement mechanism and the mounting groove provided by the invention;

FIG. 57 is another structural diagram of the microphone placement mechanism and the mounting groove provided by the invention;

FIG. 58 is a structural diagram of one side of the mounting groove connected to the accommodating groove provided by the invention;

FIG. 59 is a structural diagram of the middle of the mounting groove connected to the accommodating groove provided by the invention;

FIG. 60 is a schematic diagram of the combined structure of the box, the microphone placement mechanism and the microphone provided by the invention;

FIG. 61 is a structural diagram of the smart microphone accommodating assembly and the microphone provided by the invention;

FIG. 62 is a section view of the smart microphone accommodating assembly provided by the invention;

FIG. 63 is a structural diagram of the smart microphone accommodating assembly provided by the invention, with the adjusting piece being the sliding key;

FIG. 64 is a structural diagram of the smart microphone accommodating assembly provided by the invention, with the adjusting piece being the second adjusting component of the roller;

FIG. 65 is another structural diagram of the smart microphone accommodating assembly provided by the invention, with the adjusting piece being the second adjusting component of the roller;

FIG. 66 is a structural diagram of the smart microphone accommodating assembly provided by the invention, with the adjusting piece being the second adjusting component of the knob;

FIG. 67 is another structural diagram of the smart microphone accommodating assembly provided by the invention, with the adjusting piece being the second adjusting component of the knob;

FIG. 68 is a structural diagram of the smart device and the microphone provided by the invention;

FIG. 69 is a structural diagram of the speaker provided by the invention;

FIG. 70 is a structural diagram of the speaker provided by the invention, in which the first automatic fixing assembly is applied to clamp the microphone;

FIG. 71 is a structural diagram of the speaker provided by the invention, in which the second automatic fixing assembly is applied to clamp the microphone;

FIG. 72 is a structural diagram of the speaker provided by the invention, in which the third automatic fixing assembly is applied to clamp the microphone;

FIG. 73 is a structural diagram of the speaker provided by the invention, in which the third automatic fixing assembly is applied to release the microphone;

FIG. 74 is a structural diagram of the speaker provided by the invention, in which the fourth automatic fixing assembly is applied to clamp the microphone;

FIG. 75 is a structural diagram of the speaker provided by the invention, in which the third automatic fixing assembly is applied to release the microphone;

FIG. 76 is a structural diagram of the smart device provided by the invention when the display screen is in an open state;

FIG. 77 is a structural diagram of the smart device shown in FIG. 76 with the back of the outer housing hidden;

FIG. 78 is a partially enlarged view of part A in FIG. 77;

FIG. 79 is a structural diagram of the microphone provided by the invention after being retracted downward;

FIG. 80 is an exploded view of the structure shown in FIG. 79;

FIG. 81 is a partially enlarged view of part B in FIG. 80;

FIG. 82 is a structural diagram of the structure shown in FIG. 80 from another angle;

FIG. 83 is a structural diagram of the lower fixing seat provided by the invention;

FIG. 84 is a structural diagram of the smart microphone storage assembly and the smart device provided by the invention;

FIG. 85 is a structural diagram of the smart microphone storage assembly provided by the invention;

FIG. 86 is a structural diagram of the smart microphone storage assembly shown in FIG. 85 from another perspective;

FIG. 87 is an exploded view of the smart microphone storage assembly provided by the invention;

FIG. 88 is a structural diagram of the rotating part of the smart microphone storage assembly provided by the invention shown in FIG. 87;

FIG. 89 is an exploded view of another moving assembly of the smart microphone storage assembly provided by the invention;

FIG. 90 is a structural diagram of the rotating part of the smart microphone storage assembly provided by the invention shown in FIG. 89;

FIG. 91 is a structural diagram of the cylinder of the moving assembly of the smart microphone storage assembly provided by the invention with the second accommodating groove.

FIG. 92 is a structural diagram of the microphone and the smart device provided by the invention;

FIG. 93 is a structural diagram of the cylinder, the microphone and the moving assembly provided by the invention;

FIG. 94 is a section view of the cylinder, the microphone and the moving assembly provided by the invention show in FIG. 93;

FIG. 95 is a structural diagram of the microphone storage structure in Embodiment 1 of the invention;

FIG. 96 is a section view of the microphone storage structure in Embodiment 1 of the invention;

FIG. 97 is an exploded view of a part of the microphone storage structure in Embodiment 1 of the invention;

FIG. 98 is a structural diagram of the fixing seat in Embodiment 1 of the invention;

FIG. 99 is a structural diagram of the combined structure of the jacking component and the first elastic element in Embodiment 1 of the invention;

FIG. 100 is a structural diagram of the transmission rod in Embodiment 1 of the invention;

FIG. 101 is a schematic diagram of the display screen of the smart speaker in an opened state according to Embodiment 1 of the invention;

FIG. 102 is a section view of the smart speaker in Embodiment 1 of the invention;

FIG. 103 is a structural diagram of the microphone storage structure in Embodiment 2 of the invention;

100. Microphone storage assembly; 110. Fixing seat; 111. Seat body; 1111. Mounting groove; 1112. Placement layer; 112. Guide post; 120. Bearing seat; 121. Storage groove; 1211. Opening; 1212. Damping structure; 113. Telescopic assembly; 1131. Lifting assembly; 1132. Lifting motor; 1133. Lead screw; 1134. Limit seat; 1135. Sleeve; 1136. Guide inclined surface; 114. Lifting component; 1141. Limit portion; 115. Rotating component; 1151. Reinforcing rib; 116. Magnetic layer; 117. First thread; 118. Second thread; 119. Guide portion; 122. Rack portion; 130. Drive assembly; 131. Drive motor; 132. Gear; 133. Support and guide assembly; 134. Pulley; 135. Support shell; 136. First buffer layer; 137. Second buffer layer; 138. Accommodating cavity; 140. Charging portion; 150. First magnetic attraction component; 160. Clamping jaw; 161. Abutting surface; 170. Third magnetic attraction component; 180. Elastic sleeve; 181. Limit protrusion; 190. Cable; D. Gap; 130. Receiving assembly;
200. Microphone; 210. Second magnetic attraction component; 220. Limit groove; 230. Fourth magnetic attraction component; 240. Charging interface; 241. Charging PIN; 242. Charging male connector; 243. Charging ring; 244. Charging socket; 245. Power receiving coil; 246. Charging coil; 247. Sealing gasket; 250. Magnetic induction coil; 260. Magnet;
300. Smart speaker; 310. Speaker body; 311. Housing; 3111. Circumferential side plate; 3111A. Diffusion slot; 3112. Top plate; 3113. Bottom plate; 3114. Inner housing; 3114A. Front shell plate; 3114B. Rear shell plate; 3115. Outer housing; 312. High-frequency speaker; 313. Low-frequency speaker; 314. Full-frequency speaker; 315. Screen; 3151. Sensor; 316. Placement slot; 317. First position; 318. Second position; 319. Control button; 320. Storage assembly mounting groove;
410. Box; 420. Microphone; 421. Charging piece; 430. Microphone placement mechanism; 4301. Placement groove; 4302. Accommodating groove; 431. Connecting post; 432. First limit hole; 433. Power supply contact; 440. Mounting groove; 441. Connecting hole; 442. Second limit hole; 443. Solenoid coil; 444. Electromagnet; 445. Switch; 446. Connecting piece;
510. Microphone; 5100. Cylinder; 5110. Accommodating cavity; 5120. Opening; 5130. Passage opening; 5210. Limit component; 5211. First rotating shaft; 5212. First rotating part; 5213. Limit piece; 5214. Limit end; 5220. First adjusting component; 5300. Second adjusting component; 5310. Adjusting piece; 5311. Pressing piece; 5312. Sliding key; 5313. Roller; 5314. Third rotating shaft; 5315. Knob; 5316. First abutting surface; 5320. Second rotating shaft; 5330. Second rotating part; 5340. First connecting rod; 5350. Second connecting rod; 5360. Third connecting rod; 5370. Transmission rod; 5380. Second elastic element;
610. Speaker body; 6101. Storage groove; 6102. Groove; 6103. Charging pin; 6104. Control key; 620. Microphone; 6201. Charging ring; 630. Automatic fixing assembly; 6301. Driver; 6302. Fixing piece; 6303. Driving gear; 6304. Driven gear; 6305. Elastic element; 6306. Reciprocating block; 6307. Connecting rod; 6308. Guide rail; 6309. Electric rotating shaft mechanism; 640. Sensor; 660. Display screen; 690. Storage space;
710. Speaker body; 7101. Guide rod; 7102. Lower fixing seat; 71021. First hole position; 71022. Notch; 71023. First fixing portion; 7103. Upper fixing seat; 71031. Second hole position; 71032. Second fixing portion; 7104. Groove; 7105. Storage hole; 7106. Control key; 720. Microphone; 730. Storage mechanism; 7301. Driver; 7302. Transmission structure; 73021. Rack; 73022. Gear; 7303. Bearing cylinder; 73031. Cylinder; 730311. Storage groove; 730312. First arc-shaped sliding groove; 73032. Connecting piece; 730321. Second arc-shaped sliding groove; 740. Sensor; 750. Electric drive mechanism; 7501. Motor; 7502. Driving wheel;
7503. Driven wheel; 7504. Rotating shaft; 760. Display screen;
810. Microphone; 820. Box; 830. Charging structure; 840. Screen; 850. Screen storage groove; 8100. Cylinder; 8101. First accommodating groove; 8102. Second accommodating groove; 8103. First opening; 8104. Second opening; 8110. Bump; 8120. Magnetic attraction component; 8130. Limit block; 8200. Moving assembly; 8210. Rotating part; 8211. Gear structure; 8220. Rotating column; 8221. Spiral groove; 9100. Microphone storage structure; 9110. Storage assembly; 9111. Accommodating cavity; 91111. Opening; 91112. First position; 91113. Second position; 9112. First magnetic component; 9120. Jacking assembly; 9121. Jacking component; 91211. Ejector rod; 91212. Crossbar; 91213. Vertical bar; 9122. First elastic element; 9123. Fixing seat; 91231. Sliding cavity; 91232. First through slot; 91233. Second through slot; 9124. Clamping jaw component; 91241. Clamping jaw body; 91242. Clamping jaw portion; 9125. Second elastic element; 9130. Knob assembly; 9131. Drive component; 9132. Transmission rod; 91321. Guide portion; 91321A. Upper abutting surface; 91321B. Lower abutting surface;
91321C. First abutting surface; 91321D. Second abutting surface; 91322. First stop block; 91323. Second stop block; 9140. Charging portion; 9200. Microphone; 9210. Second magnetic element; 9220. Notch; 9300. Smart speaker; 9310. Speaker body; 9311. Storage groove; 9320. Screen; 9321. Screen body; 9322. Rotating shaft.

### DETAILED DESCRIPTION

For ease of understanding the invention, a more comprehensive description of the invention will be given below with reference to the related drawings. The preferred embodiments of the invention are shown in the drawings. However, the invention may be embodied in many different forms and is not limited to the embodiments described herein. On the contrary, these embodiments are provided to make the understanding of the disclosure of the invention more thorough and comprehensive.

It should be noted that when an element is referred to as being “fixed to” another element, it can be directly positioned on the other element or intervening elements may also be present. When an element is referred to as being “connected” to another element, it can be directly connected to the other element or intervening elements may also be present. The terms “vertical”, “horizontal”, “left”, “right” and similar expressions used herein are for illustrative purposes only.

Unless otherwise defined, all technical and scientific terms used herein have the same meanings as commonly understood by one of ordinary skill in the art to which this invention belongs. The terms used in the specification of the invention are for the purpose of describing specific embodiments only and are not intended to limit the invention. The term “and/or” as used herein includes any and all combinations of one or more of the associated listed items.

A microphone is a transducer that converts sound into electrical signals. It is also known as a pickup or loudspeaker. Its basic principle is based on acoustic-electric conversion: sound travels through the air to the vibrating diaphragm of the microphone, causing the vibrating diaphragm to vibrate, which in turn drives the internal circuit to generate a corresponding electrical signal. This electrical signal is then amplified, processed, stored or transmitted. In the prior art, the microphone is connected to the speaker for signal transmission to realize karaoke or speech. When not in operation, the microphone can be stored separately from the speaker or integrally with the speaker. The microphone can be partially inserted into the speaker with the other part exposed outside the speaker, or can be completely stored inside the speaker.

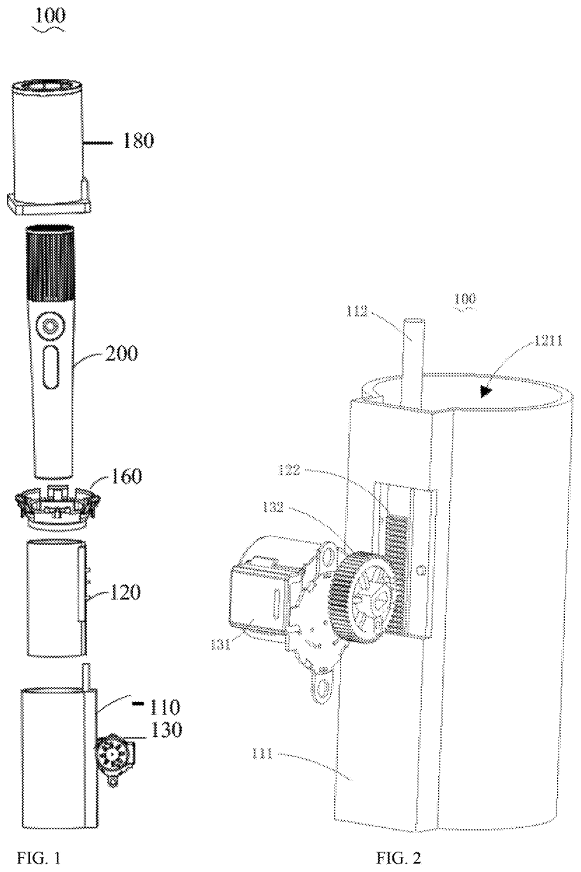

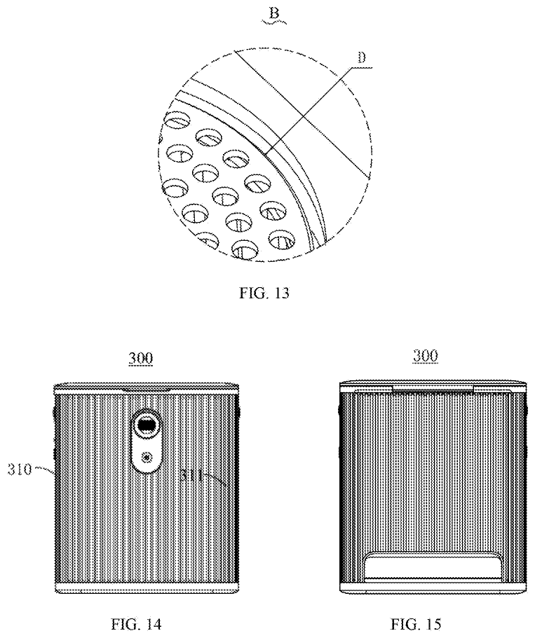

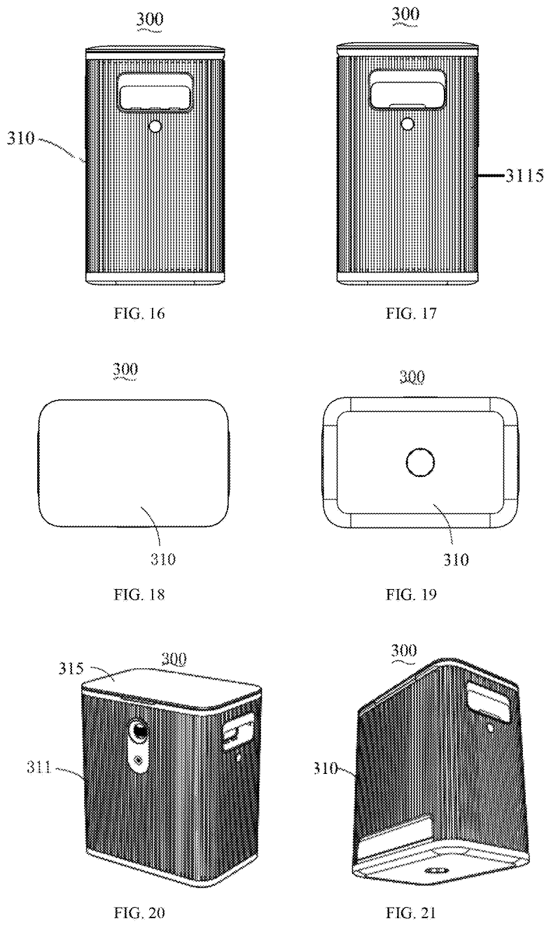

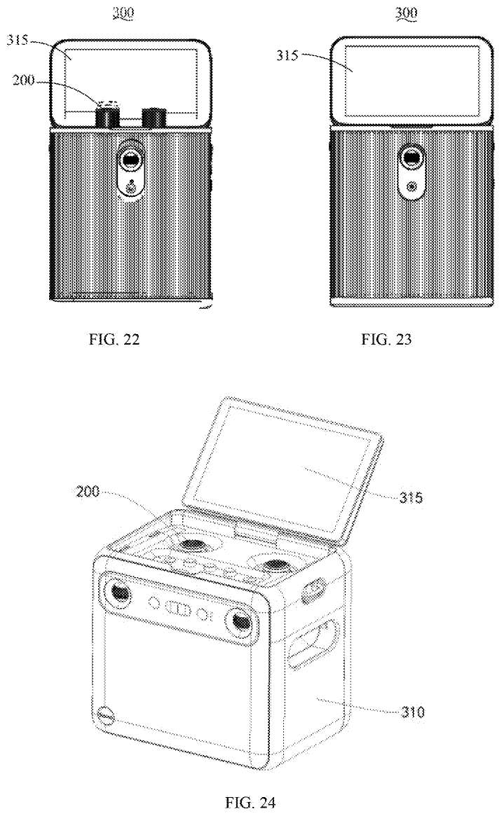

As shown in FIG. 1 to FIG. 23, the embodiment of the invention provides a smart speaker 300, comprising a speaker body 310 and a microphone storage assembly 100; the microphone storage assembly 100 is arranged inside the speaker body 310 and comprises a drive assembly 130 and a bearing seat 120 for bearing the microphone 200; the drive assembly 130 is arranged opposite to the bearing seat 120 and is connected to the bearing seat 120 to drive the bearing seat 120 to move along a first direction. Exemplarily, conventional microphone 200 storage structures are generally purely mechanical structures for realizing the storage and removal of the microphone 200. The purely mechanical structures for storing and fixing the microphone 200 (such as springs, swing arms, hook locks and other self-locking structures) realize the reciprocating storage of the microphone 200. Due to design angle deviations and durability factors, locking or unlocking failure is prone to occur, resulting in high instability of the mechanical structure and affecting user experience. Meanwhile, the prior art discloses that in order to smoothly take out the microphone 200 from the storage groove 121, the opening 1211 of the storage groove 121 is sufficiently large to allow the user to manually pull out the microphone 200. Thus, a relatively large gap is required to be reserved between the storage groove 121 and the microphone 200. Additionally, to facilitate the placement of the microphone 200, an inclined guide groove is usually provided at the opening 1211 of the storage groove 121, which further increases the gap between the microphone 200 and the storage groove 121, thereby causing dust or other foreign matter to easily enter the storage groove 121 and resulting in adverse consequences. The microphone storage assembly 100 of the application drives the microphone 200 to lift and lower in an electric manner. Such structural design helps to improve the precise lifting and lowering control of the microphone 200 and avoids the instability of the purely mechanical structure. Meanwhile, manual lifting and lowering is changed to electric lifting and lowering, so that the gap between the storage groove 121 and the microphone 200 can be reduced; the guide groove is eliminated, thereby effectively preventing dust or foreign matter from entering the storage groove 121. The connection between the drive assembly 130 and the bearing seat 120 may be a fixed connection or a movable connection. As shown in FIG. 13, when the microphone 200 is placed in the storage groove 121, the gap D between the microphone 200 and the storage groove 121 is small, which can be set to 0-1.5 mm. At this time, a clearance fit is formed between the microphone 200 and the storage groove 121, which helps prevent dust or foreign matter from entering the storage groove 121 and improves the sealing and dustproof effect. In addition, the storage groove 121 provided in the application eliminates the guide groove, further preventing dust or foreign matter from entering the storage groove 121.

In a possible embodiment, the first direction may be a vertical direction or a horizontal direction. The drive assembly 130 is designed to drive the bearing seat 120 to move. Specifically, in this embodiment, the drive assembly 130 can drive the bearing seat 120 to rise or fall. Of course, as an alternative, the drive assembly 130 may also be configured to only drive the bearing seat 120 to rise, and the downward movement of the bearing seat 120 may be realized by other means (such as manual pressing); or the drive assembly 130 may be configured to only drive the bearing seat 120 to fall, and the upward movement of the bearing seat 120 may be realized by other means (such as manual pressing).

The microphone storage assembly 100 further comprises a fixing seat 110; the fixing seat 110 is formed with a mounting groove 1111, and the bearing seat 120 is slidably mounted in the mounting groove 1111. The fixing seat 110 comprises a seat body 111 and a guide post 112; the mounting groove 1111 is formed on the seat body 111; the guide post 112 is arranged in the mounting groove 1111; the bearing seat 120 is slidably connected to the guide post 112.

As an alternative, the fixing seat 110 may also be eliminated. The guide post 112 is directly mounted on the housing 311 of the speaker; the bearing seat 120 is slidably mounted on the guide post 112; the drive assembly 130 is connected to the bearing seat 120 and drives the bearing seat 120 to lift the microphone 200 along the guide post 112. Compared with the solution provided with the fixing seat 110, the solution of this embodiment omits the fixing seat 110, reduces material, processing and assembly costs, and simplifies the assembly process.

As an alternative, an elastic element is arranged on the inner surface of the storage groove 121. The elastic element may be air bladder or made of silicone. After the microphone 200 is inserted, a part of the microphone 200 is wrapped or squeezed. When no microphone 200 is placed in the storage groove 121, the size of the accommodating cavity formed on the elastic element is smaller than that of the microphone 200. When the microphone 200 is placed into the accommodating cavity, the elastic element tightly wraps the microphone 200. It not only helps reduce the falling speed of the microphone 200, but also forms a seal when the microphone 200 is stored, preventing dust and other foreign matter from entering the storage groove 121.

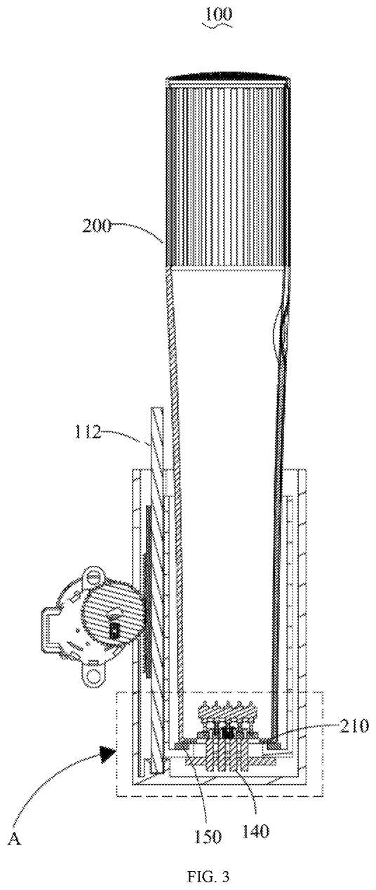

As shown in FIG. 1, FIG. 2 and FIG. 3, in the microphone storage assembly 100 of the embodiment, the storage structure is changed to motor driving, which can provide more precise control, so that the positioning of the microphone 200 during storage and pickup is more accurate. Moreover, the motor-driven structure is generally more stable, reducing the variation of the gap D caused by vibration or impact. Therefore, in the microphone storage assembly 100 of the application, the gap D between the storage groove 121 and the microphone 200 can be very small, and no guide groove is provided at the opening 1211 of the storage groove 121, which helps prevent dust or other foreign matter from entering the storage groove 121 from the guide groove, thereby improving the stability of the microphone storage assembly 100 and prolonging the service life of the microphone storage assembly 100 and the microphone 200.

As shown in FIG. 1, FIG. 2 and FIG. 3, in a possible embodiment, the drive assembly 130 comprises a drive motor 131 and a gear 132; the gear 132 is connected to a drive end of the drive motor 131, and the bearing seat 120 is formed with a rack portion 122 engaged with the gear 132. Exemplarily, the drive motor 131 is fixedly mounted on the fixing seat 110, the gear 132 is meshed with the rack portion 122, the drive motor 131 drives the gear 132 to rotate, and the gear 132 drives the bearing seat 120 to rise or fall. Understandably, the gear 132 serves as a fixing piece for the bearing seat 120 when not rotating. When the gear 132 is stationary, the bearing seat 120 is stationary, and the microphone 200 is also stationary. When the gear 132 rotates forward, the bearing seat 120 drives the microphone 200 to rise along the guide post 112, and the microphone 200 is taken out; when the gear 132 rotates reversely, the bearing seat 120 drives the microphone 200 to fall along the guide post 112, and the microphone 200 is stored. It should be noted that the trigger modes of the drive motor 131 include but are not limited to the following: In the first trigger mode, triggering is performed by button pressing. For example, a single button may be arranged. Short press the button to raise the microphone storage assembly 100, and long press the button to lower the microphone storage assembly 100. Alternatively, two buttons may be arranged, one for controlling the raising of the microphone storage assembly 100, and the other for controlling the lowering of the microphone storage assembly 100.

In the second trigger mode, triggering is performed by a knob. For example, the microphone storage assembly 100 rises when the knob is turned clockwise; the microphone storage assembly 100 falls when the knob is turned anticlockwise; the reverse arrangement is also applicable. In the third trigger mode, triggering is performed by a roller. The microphone storage assembly 100 rises when the roller is rolled forward; the microphone storage assembly 100 falls when the roller is rolled reversely; the reverse arrangement is also applicable. In the fourth trigger mode, triggering is performed by a voice command. Voice command triggering includes, but is not limited to, fixed voice content commands (e.g., trigger words may be karaoke, microphone 200, up, down, etc.) and sound commands (e.g., finger snapping, clapping), etc. In the fifth trigger mode, triggering is performed by a touch operation. For example, a pop-up command or a lifting icon is provided on the screen 315, or a sensing area is provided on the top of the microphone 200, or a sensing area is provided on the top of the storage groove 121. In the sixth trigger mode, triggering is performed by infrared induction. An infrared emitter is arranged in the storage groove 121, and the microphone 200 is lifted after the user's hand covers the storage groove 121 for a certain period of time (e.g., 5 seconds).

In a possible embodiment, the drive assembly 130 may also be arranged on the bearing seat 120, and the rack portion 122 is formed on the guide post 112. When the drive assembly 130 drives the bearing seat 120 to move up and down, the drive assembly 130 moves up and down together with the bearing seat 120.

As an alternative, the drive assembly 130 is not limited to a gear 132 rack structure to realize lifting and lowering. Other manners may also be used, including the following solutions. In the first solution, a winding and unwinding mechanism and a traction rope are used. The winding and unwinding mechanism is connected to the drive motor 131, and the traction rope is connected between the winding and unwinding mechanism and the bearing seat 120. The drive motor 131 drives the winding and unwinding mechanism to rotate and wind or unwind the traction rope, thereby realizing lifting and lowering of the bearing seat 120. In the second solution, a hydraulic lifting mechanism (i.e., a hydraulic rod) is used. The hydraulic lifting mechanism is connected to the bearing seat 120 and directly drives the bearing seat 120 to realize lifting and lowering. In the third solution, a pneumatic lifting mechanism is used. The pneumatic lifting mechanism is connected to the bearing seat 120 and directly drives the bearing seat 120 to realize lifting and lowering. In the fourth solution, an upper electromagnet, a lower electromagnet and an iron block are used. The upper electromagnet and the lower electromagnet are respectively arranged at the top and bottom ends of the mounting groove 1111, and the iron block is arranged on the bearing seat 120. The lifting and lowering of the bearing seat 120 are realized by controlling the power-on and power-off of the upper electromagnet and the lower electromagnet.

As shown in FIG. 1, FIG. 2 and FIG. 3, in a possible embodiment, the fixing seat 110 comprises a seat body 111 and a guide post 112; the mounting groove 1111 is formed on the seat body 111; the guide post 112 is arranged in the mounting groove 1111; the bearing seat 120 is slidably connected to the guide post 112. Exemplarily, the guide post 112 may be a separate component mounted on the fixing seat 110 or the housing 311. Of course, as an alternative, the guide post 112 may also be integrally formed with the housing 311 or the fixing seat 110. The bearing seat 120 is provided with a sliding groove arranged beside the storage groove 121. The bearing seat 120 is connected to the guide post 112 via the sliding groove. The sliding groove is arranged between the rack portion 122 and the storage groove 121. The sliding fit between the guide post 112 and the bearing seat 120 prevents the bearing seat 120 from shifting during sliding, which helps improve precision and avoid damage caused by collision of components such as the microphone 200 or the bearing seat 120 during sliding. Understandably, the guide post 112 is cylindrical, and the shape of the sliding groove matches that of the guide post 112. The cylindrical shape facilitates the sliding of the bearing seat 120 along the guide post 112. Of course, in the specific application, the shapes of the guide post 112 and the sliding groove are not limited thereto. For example, as an alternative, their cross-sections may also be rectangular, elliptical, trapezoidal, or other irregular shapes, which are not limited herein. In addition, it should be noted that the seat body 111 comprises a base and a storage cylinder; the storage cylinder is mounted on the base by screws, wherein the guide post 112 is arranged in the base. The seat body 111 is provided in two sections for ease of processing and installation. The storage cylinder can also limit the position of the bearing seat 120. During storage, the microphone 200 first enters through the storage cylinder, then passes through the inside of the base, so that the microphone 200 is completely received into the storage groove 121, thus completing the storage of the microphone 200.

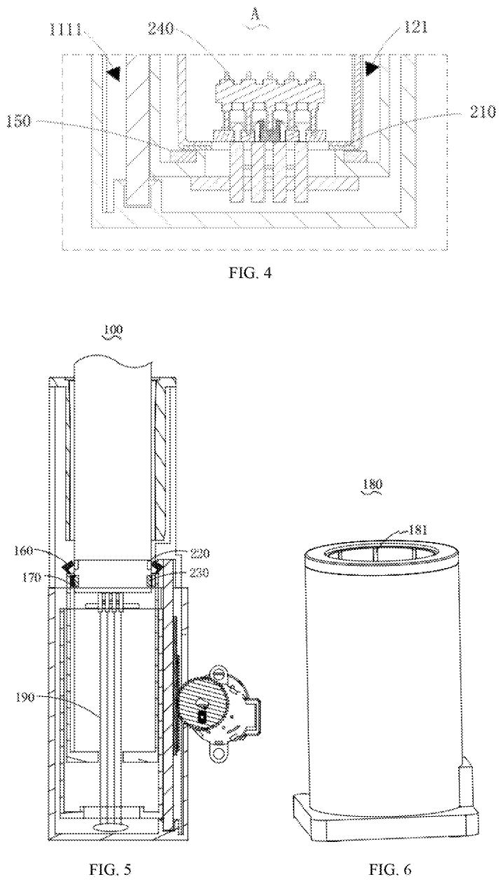

As shown in FIG. 3 and FIG. 4, in a possible embodiment, the microphone storage assembly 100 further comprises a charging portion 140; the storage groove 121 is provided with an opening 1211; the charging portion 140 is arranged at one end of the storage groove 121 remote from the opening 1211. Exemplarily, in the embodiment, specifically, the charging portion 140 is installed inside the base. The charging portion 140 is a charging pin, which may be a plug-in charging pin or a contact charging pin. The charging pin extends into the storage groove 121 through a through slot. When the microphone 200 is placed in the storage groove 121, the charging interface 240 at the bottom of the microphone 200 comes in contact with or is inserted into the charging pin, thereby realizing the function of charging the microphone 200 during storage. Of course, in the specific application, as an alternative, the charging portion 140 may also be configured in the form of wireless charging. The charging portion 140 may be integrated onto the bearing seat 120, or arranged on the bearing seat 110, or provided on other components of the smart speaker 300.

In a possible embodiment, when the microphone 200 is in the stored state, the microphone 200 is completely placed in the storage groove 121. At this time, the top of the microphone 200 is flush with or lower than the opening 1211. When the microphone 200 needs to be taken out, the microphone 200 is driven by the bearing seat 120 to move in a first direction. At this time, the top of the microphone 200 passes through the opening 1211, such that the upper half of the microphone 200 is higher than the opening 1211 for easy access by the user. In addition, it should be noted that the opening 1211 may be a fixed open structure, or an adaptive closed structure that opens only when the microphone 200 passes through.

As shown in FIG. 5, in a possible embodiment, the charging portion 140 is installed in the bearing seat 120, and the charging portion 140 is connected to the power supply via a cable 190.

Exemplarily, in this embodiment, the charging portion 140 is arranged on the bearing seat 120, i.e., the charging portion 140 moves together with the bearing seat 120. It can be understood that the length of the cable 190 should be greater than the maximum distance from the charging portion 140 to the bottom of the mounting groove 1111, so that the cable 190 can accommodate the movement of the charging portion 140. This embodiment has the advantages of low material cost and fewer assembly processes. In this embodiment, the charging portion 140 is a charging pin, which may be an insertion-type charging pin or a contact-type charging pin. When the microphone 200 is placed in the storage groove 121, the charging interface 240 at the bottom of the microphone 200 comes in contact with or is inserted into the charging pin, thereby realizing the function of charging the microphone 200 during storage. Of course, in the specific application, as an alternative, the charging portion 140 may also be configured in the form of wireless charging.

As shown in FIG. 3 and FIG. 4, in a possible embodiment, the bearing seat 120 is provided with a first magnetic attraction component 150; the microphone 200 is provided with a second magnetic attraction component 210 matched with the first magnetic attraction component 150. Exemplarily, the first magnetic attraction component 150 and the second magnetic attraction component 210 may be permanent magnets or electromagnets, and can attract each other. The second magnetic attraction component 210 is arranged at the tail of the microphone 200, and the first magnetic attraction component 150 is arranged at the bottom of the storage groove 121. The first magnetic attraction component 150 and the second magnetic attraction component 210 can fix the microphone 200 in the storage groove 121, so that the microphone 200 does not shake during storage. The storage assembly of this embodiment has the advantages that the charging portion 140 is arranged in the base, the overall height of the microphone 200 is reduced in the stored state, no lateral groove needs to be formed on the microphone 200, and the microphone 200 cannot rotate horizontally. The charging pin is fixed, resulting in good stability.

As shown in FIG. 5, in a possible embodiment, the microphone storage assembly 100 further comprises a clamping jaw 160 and a third magnetic attraction component 170; the clamping jaw 160 is connected to the fixing seat 110; the third magnetic attraction component 170 is connected to the fixing seat 110 and adjacent to the clamping jaw 160; the microphone 200 is provided with a limit groove 220 matched with the clamping jaw 160, and a fourth magnetic attraction component 230 matched with the third magnetic attraction component 170. Exemplarily, the clamping jaw 160 and the third magnetic attraction component 170 are arranged on one side of the storage cylinder away from the base, that is, the clamping jaw 160 and the third magnetic attraction component 170 are arranged near the entrance of the storage groove 121. On the one hand, the clamping jaw 160 is matched with the limit groove 220 to fix the microphone 200 in the storage groove 121. On the other hand, in the case that the microphone 200 is lifted but not taken out, the microphone 200 still needs to be fixed. However, the clamping jaw 160 has been disengaged from the limit groove 220 at this time. Therefore, the third magnetic attraction component 170 and the fourth magnetic attraction component 230 are designed to assist in fixing the microphone 200. The third magnetic attraction component 170 and the fourth magnetic attraction component 230 may be permanent magnets or electromagnets, and the third magnetic attraction component 170 and the fourth magnetic attraction component 230 can attract each other.

As shown in FIG. 5, in a possible embodiment, the drive assembly 130 is located on one side of the bearing seat 120. Exemplarily, compared with arranging the drive assembly 130 at the bottom of the carrying base 120, arranging the drive assembly 130 on one side of the bearing seat 120 has the following advantages: first, it helps reduce the overall height of the microphone storage assembly 100; second, during manual storage of the microphone 200, the downward movement of the microphone 200 may be affected by the drive assembly 130; the drive assembly 130 arranged at the bottom obstructs the movement of the microphone 200, preventing the microphone 200 from being quickly lowered and stored. By contrast, arranging the drive assembly 130 on one side of the carrying base 120 avoids this problem and facilitates rapid storage of the microphone 200.

As shown in FIG. 1 and FIG. 6, in a possible embodiment, the microphone storage assembly 100 further comprises an elastic sleeve 180 connected to the fixing seat 110; a limit protrusion 181 is arranged on one side of the elastic sleeve 180 facing away from the fixing seat 110. Exemplarily, the elastic sleeve 180 is installed in the storage cylinder. The interior of the storage cylinder cooperates with a silicone sleeve to decelerate the microphone 200 and fix and limit it in the lateral direction, preventing physical impact noise during falling and lateral shaking after storage. Understandably, the elastic sleeve 180 is made of elastically deformable material such as silicone. The limit protrusion 181 may be configured as a bump, a rib, or other shape protruding from the body of the elastic sleeve 180. The limit protrusion 181 helps further block the falling of the microphone 200, thereby reducing its falling speed. On the one hand, reducing the falling speed of the microphone 200 helps lower the impact noise between the microphone 200 and the bearing seat 120, improving the user experience. On the other hand, it helps reduce the impact force on the microphone 200, thereby protecting the microphone 200 and the structure of the storage assembly.

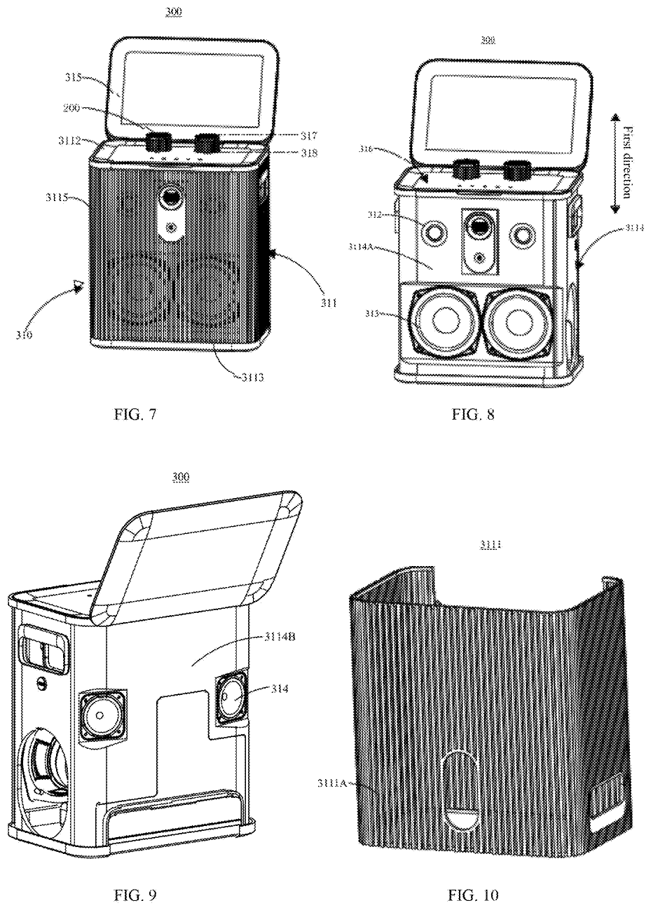

As shown in FIG. 7 to FIG. 23, the smart speaker 300 further comprises a speaker body 310 and the microphone storage assembly 100, wherein the microphone storage assembly 100 is installed inside the speaker body 310. Exemplarily, it should be noted that the circuit of the speaker body 310 and the circuit of the microphone storage assembly 100 are independent of each other. The circuit of the speaker body 310 consists of electronic components such as a speaker, a battery and a screen 315, i.e., the circuit of the microphone storage assembly 100 can exist and operate independently. Even if the circuit of the speaker body 310 fails, the user can still take out the microphone 200 through the microphone storage assembly 100. A power button is arranged on the speaker body 310. When the power button is pressed to power on the device and the screen 315 is opened, the microphone 200 can be raised; when the power button is pressed to power off the device, the microphone 200 is lowered.

The speaker can be structurally classified into three types: open, semi-closed, and closed. The semi-closed speaker is further divided into reflex type, rear horn type, drone cone enclosure type, etc. In terms of connection type, the speaker can be divided into wired speaker and wireless speaker, wherein the wireless speaker supports multiple connection modes.

The microphone 200 may be a condenser microphone 200, a dynamic microphone 200, or a ribbon microphone 200.

As shown in FIG. 7 and FIG. 10, in a possible embodiment, the speaker body 310 comprises a housing 311; the housing 311 comprising a peripheral side plate 3111, a top plate 3112 and a bottom plate 3113; the top plate 3112 and the bottom plate 3113 are respectively connected to opposite sides of the peripheral side plate 3111; diffusion slots 3111A are distributed on the peripheral side plate 3111; assume the area of the peripheral side plate 3111 to be S1, and assume the total area of all diffusion slots 3111A on the peripheral side plate 3111 to be S2, then the ratio S2/S1 is not less than 0.4. Exemplarily, the circumferential side plate 3111 is generally a square-column shaped hollow structure with a rounded rectangular cross-section. The diffusion slots 3111A serve to diffuse sound emitted from the speaker outward. The diffusion slots 3111A are in a shape of vertical rectangular strip and evenly spaced on the circumferential side plate 3111. The diffusion slots 3111A are almost distributed on the outer surface of the circumferential side plate 3111. This arrangement improves omnidirectional sound diffusion, achieves a 3D stereo surround effect, and enhances user experience. The diffusion slots 3111A effectively improve the sound diffusion performance of the speaker, enabling more uniform and extensive sound propagation. It helps improve the overall sound quality of the speaker and provides users with a better listening experience. By designing the ratio of the total area of the diffusion slots 3111A to the unfolded area of the circumferential side plate 3111, the speaker structure can be ensured to be both compact and efficient. This design not only improves space utilization and reduces material cost, but also maintains excellent acoustic performance. Meanwhile, it should be noted that the ratio of S2/S1 should not be too small, as this will deteriorate the sound diffusion effect of the speaker. The ratio should also not be too large, as this will reduce the structural strength of the housing 311. In the specific application, the ratio S2/S1 may be 0.5, 0.6, or 0.7, which is not limited herein. In addition, when the circumferential side plate 3111 is integrally formed, the perimeter of the circumferential side plate 3111 can be measured using a flexible measuring component, and then the width (height) of the circumferential side plate 3111 is measured. The area S1 of the circumferential side plate 3111 can be calculated by multiplying the perimeter by the width (height). In this embodiment, the diffusion slots 3111A are uniformly distributed. Of course, in the specific application, the diffusion slots 3111A may also be arranged non-uniformly. In such a case, the ratio S2/S1 within the orthographic projection coverage of the high-frequency speaker 312, low-frequency speaker 313, and full-frequency speaker 314 is not less than 0.4.

As shown in FIG. 7 to FIG. 9, in a possible embodiment, the guide post 112 is mounted on the peripheral side plate 3111 or the bottom plate 3113. Exemplarily, in the first embodiment, the guide post 112 is mounted on the peripheral side plate 3111, and the bearing seat 120 is slidably mounted on the guide post 112. In addition, it should be noted that the guide post 112 is mounted on the upper half of the circumferential side plate 3111. Such arrangement provides a large space between the microphone storage assembly 100 and the bottom plate 3113. Such space is more conducive to waterproofing at the bottom, or placing a larger battery to improve the battery life of the smart speaker 300. In the second embodiment, the guide post 112 is mounted on the bottom plate 3113, and the bearing seat 120 is slidably mounted on the guide post 112. The advantage of such arrangement is that the mounting structure is simplified, facilitating the installation of the microphone storage assembly 100. As shown in FIG. 7 to FIG. 9, in a possible embodiment, the housing 311 comprises an inner housing 3114 and an outer housing 3115; the inner housing 3114 is nested within the outer housing 3115; the diffusion slots 3111A are arranged on the outer housing 3115; the inner housing 3114 comprises a front shell plate 3114A and a rear shell plate 3114B arranged on opposite sides. Exemplarily, the diffusion slot 3111A is provided on the outer housing 3115. In this embodiment, the inner housing 3114 is formed by integral molding. Such a processing method provides the inner housing 3114 with stable structure and uniform dimensions, which helps improve product quality and prolong service life. Of course, in the specific application, a portion of the inner housing 3114 may also be manufactured by integral molding and then assembled. For example, the rear inner housing 3114 may be formed separately, while the remaining part of the inner housing 3114 is prepared by integral molding, and the two parts are assembled to form the inner housing 3114.

As shown in FIG. 7 to FIG. 9, in a possible embodiment, the speaker body 310 further comprises a high-frequency speaker 312, a low-frequency speaker 313 and a full-frequency speaker 314; the high-frequency speaker 312 and the low-frequency speaker 313 are mounted on the front shell plate 3114A, and the full-range speaker 314 is mounted on the rear shell plate 3114B. Exemplarily, the high-frequency speaker 312 and the low-frequency speaker 313 are mounted on the front shell plate 3114A of the inner housing 3114, and the full-frequency speaker 314 is mounted on the rear shell plate 3114B of the inner housing 3114. Understandably, the inner housing 3114, the high-frequency speaker 312, the low-frequency speaker 313, the full-frequency speaker 314 and the microphone storage assembly 100 are all arranged inside the outer housing 3115, and the outer housing 3115 provides a protective function. Understandably, a dust screen may be arranged between the outer housing 3115 and the inner housing 3114. The dust screen separates the outer housing 3115 from the high-frequency speaker 312, the low-frequency speaker 313 and the full-frequency speaker 314, preventing dust or foreign matter from entering the interior of the smart speaker 300 through the diffusion slots 3111A, which may damage components such as the high-frequency speaker 312, the low-frequency speaker 313, the full-frequency speaker 314 and the microphone storage assembly 100, thereby affecting the service life of the smart speaker 300.

As shown in FIG. 7 to FIG. 9, in a possible embodiment, the speaker body 310 further comprises a screen 315, a damping shaft and a sensor; the screen 315 is rotatably connected to the top plate 3112 via the damping shaft to close or open the storage groove 121; the sensor is used to detect the position of the screen 315.

Exemplarily, the screen 315 is generally rectangular and is used to display video information such as song information or MV. When the screen 315 is in the stored state, the display side thereof is close to the storage groove 121, i.e., in the stored state, both the storage groove 121 and the inner side of the screen 315 are located inside the smart speaker 300, which can prevent the screen 315 from being scratched and protect the microphone 200 in the storage groove 121. The sensor is arranged to obtain the opening/closing degree of the screen 315, i.e., the position angle of the screen 315. Understandably, the sensor may be a Hall element, a distance sensor or an angle sensor. The damping shaft may be a purely mechanical structure or an electric structure. During closing of the screen 315, in the first stage, the smaller the angle of the screen 315 is, the greater the resistance of the damping shaft is; in the second stage, the smaller the angle of the screen 315 is, the smaller the resistance of the damping shaft is. This design ensures a smooth transition of the screen 315 during the closing process and avoids discomfort to the user caused by sudden closing, effectively controlling the movement speed and force of the screen 315, preventing equipment damage caused by rapid or violent movement, and helping prolong the service life of the smart speaker 300. A reasonable damping design can avoid the risk of injury to users caused by the sudden closing of the screen 315. Particularly in a night or low-light environment, slowly closing the screen 315 can reduce interference to the user and improve safety. In addition, noise generated during closing of the screen 315 is correspondingly reduced. It is particularly advantageous for occasions requiring a quiet environment, such as bedrooms and libraries. Understandably, the first stage is configured when the screen 315 is far from the top plate 3112, and the second stage is configured when the screen 315 is close to the top plate 3112 and about to close.

In other embodiments, the resistance of the damping shaft is inversely proportional to the distance between the screen 315 and the microphone 200 that is not in the stored state. When the microphone 200 is not in the stored state, the smaller the distance between the screen 315 and the top surface of the microphone 200 is, the greater the resistance is, preventing collision between the screen 315 and the microphone 200. The non-stored state includes two situations: the first situation is that the microphone 200 is placed in the storage groove 121 and in an access state, where the microphone 200 is stationary; the second situation is that the microphone 200 is in the process of lifting or lowering, where the microphone 200 is in a moving state. The spacing of the microphone 200 refers to the distance between the top of the microphone 200 and the screen 315 in the first direction (vertical direction). The greater the distance of the microphone 200 from the opening 1211 is, the higher the risk of collision between the screen 315 and the microphone 200 is; conversely, the smaller the distance of the microphone 200 from the opening 1211 is, the lower the risk of collision between the screen 315 and the microphone 200 is. In addition, when the microphone 200 is completely placed in the storage groove 121, i.e., in the stored state, there is no risk of collision between the screen 315 and the microphone 200, and the resistance of the damping shaft may no longer be restricted.

As shown in FIG. 8, as one embodiment, the back surface of the screen 315 (i.e., the back side of the display surface) is configured as an arc surface. As shown in FIG. 11, as another embodiment, the back surface of the screen 315 (i.e., the back side of the display surface) is configured as a flat surface.

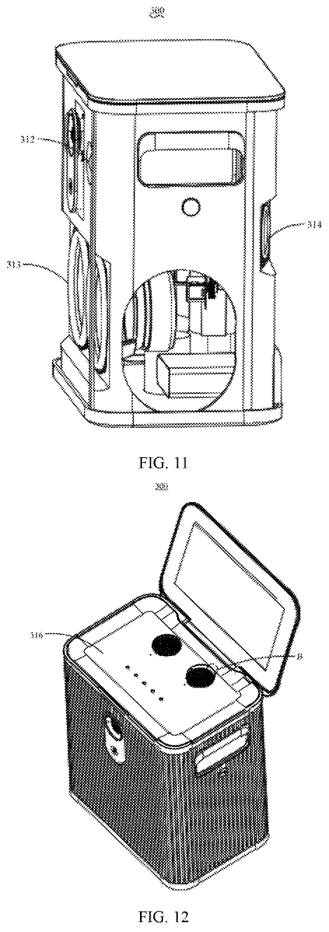

As shown in FIG. 7, FIG. 8 and FIG. 9, in a possible embodiment, the speaker body 310 is formed with a placement slot 316 for placing the screen 315, and the placement slot 316 is provided with a buffer member used with the screen 315. When the screen 315 is in the use state, the screen 315 is rotated to disengage from the placement slot 316. When the screen 315 is in the stored state, the screen 315 is completely positioned in the placement slot 316. The thickness of the screen 315 gradually decreases from the rotating end to the opposite end thereof. Understandably, the placement slot 316 has an inclined surface matched with the screen 315, such that the outer end surface of the screen 315 is substantially horizontal when the screen 315 is located in the placement slot 316. The buffer member can buffer the screen 315 when closed, helping protect the screen 315 from damage. As shown in FIG. 12, since the screen 315 of the application is a thin and light screen, the placement slot 316 has a relatively small depth, and the bottom surface of the placement slot 316 is a flat surface. An arc-shaped transition extends on the outer edge of the bottom surface, which facilitates better adaptation to the thin and light screen 315.

When the microphone 200 remains connected to the speaker and placed too close to it, howling tends to occur, producing a harsh sound that severely degrades the user experience. Particularly when the microphone 200 is stored in the speaker, the probability of howling caused by impact and friction noises between the microphone 200 and the speaker during the storage process is higher. Accordingly, the microphone 200 can be configured to automatically power off when approaching the speaker, preventing howling when the microphone 200 is close to or stored in the speaker.

In some embodiments, to prevent howling when the microphone 200 is close to or stored in the speaker, the microphone 200 can be configured to automatically power off when approaching the speaker. Specifically, sensing elements may be arranged on the microphone 200 and/or the speaker. The sensing elements are configured to sense the distance between the speaker and the microphone 200, generate a corresponding sensing signal when the distance between the speaker and the microphone 200 is less than or equal to a preset distance, and send the sensing signal to the control device of the microphone 200, or send the sensing signal to the control device of the microphone 200 via the speaker, so that the control device controls the microphone 200 to power off. More specifically, one or more sensing elements may be distributed, which may be Hall element, distance sensor, infrared sensor, any other individual electronic component capable of sensing the distance between the speaker and the microphone 200, or any combination of the electronic components.

In some specific embodiments, the sensing element may be arranged at the opening 1211 of the storage groove 121. When the microphone 200 is inserted into the storage groove 121, the sensing element may generate a corresponding sensing signal immediately upon initial insertion of the microphone 200 to turn off microphone 200. In addition, the sensing element may also be arranged at one end of the storage groove 121 away from the opening 1211. A corresponding sensing signal can also be generated to turn off the microphone 200 when the microphone 200 is inserted near the sen sing element. This design can also prevent the aging of the sensing element caused by exposure due to the opening 1211 facing outward.

In some more specific embodiments, the sensing elements are Hall element and magnetic component, which are respectively arranged at corresponding positions of the speaker and the microphone 200. For example, the magnetic component is arranged at the corresponding position of the microphone 200, and the Hall element is arranged at the corresponding position of the speaker; or the Hall element is arranged at the corresponding position of the microphone 200, and the magnetic component is arranged at the corresponding position of the speaker. The triggering condition of the Hall element may be that the detected magnetic field intensity reaches a preset value. When the detected magnetic field intensity is greater than or equal to the preset value, it indicates that the distance between the speaker and the microphone 200 is sufficient to cause howling, and the microphone 200 needs to be powered off accordingly.

The third purpose of the invention is to provide a control method for the smart speaker 300, which is used to control the smart speaker 300, wherein the method comprises:

When the first preset condition is satisfied, the microphone 200 rises to the first position 317; otherwise, the microphone 200 does not rise.

In a possible embodiment, when the first preset condition is satisfied, the method comprises the following: the smart speaker 300 is powered on and started up, and the screen 315 is opened;
detecting an included angle between the top surface of the smart speaker 300 and the screen 315, wherein the included angle is greater than or equal to a preset angle.

In a possible embodiment, when the second preset condition is satisfied, the microphone 200 falls from a second position 318 to a first position 317.

In a possible embodiment, the second preset condition comprises:
the power supply of the speaker body 310 is turned off, or the included angle is smaller than the preset angle; or
the smart speaker 300 receives a microphone 200 storage instruction.

Exemplarily, the included angle of the screen 315 specifically includes: the lifting height of the microphone 200 follows the opening/closing angle of the screen 315. The larger the opening/closing angle of the screen 315 is, the higher the microphone 200 rises; the smaller the opening/closing angle of the screen 315 is, the lower the microphone 200 rises. The user inputs instruction in two modes. In the first mode, the user selects a rising height of the microphone 200 on the screen 315. In this embodiment, the selectable range of the rising height of the microphone 200 is 20-40 mm. In the second mode, the height is determined according to the distance of the human hand: the farther the human hand is from the smart speaker 300, the higher the microphone 200 rises. In this embodiment, when the second mode is adopted, the rising height of the microphone is controlled within a range of 0-25 mm.

In a possible embodiment, when the second preset condition is satisfied, the microphone 200 falls at a first speed; when the third preset condition is satisfied, the microphone 200 falls at a second speed, and the second speed is greater than the first speed. Exemplarily, under the second preset condition (i.e., the normal state), the microphone 200 is first stored in place, and then the screen 315 is closed. Under the third storage condition, the screen 315 is closed even if the microphone 200 has not started to fall for storage or has not fallen into place yet. Under the third storage condition, in order to avoid collision between the microphone 200 and the screen 315, the falling speed of the microphone 200 needs to be increased to a second speed. Understandably, both the microphone 200 and the screen 315 move at a constant speed during normal storage. Similarly, when the microphone 200 and the screen 315 rise simultaneously, both move at a constant speed under normal conditions. When the screen 315 and the microphone 200 are about to contact each other, the rising speed of the screen 315 needs to be increased to avoid collision between the microphone 200 and the screen 315. In addition, rapid falling allows the microphone 200 to switch from the use state to the stored state within a short time, thereby improving the overall storage efficiency. This is particularly important for users who need to use the microphone 200 frequently. Rapid falling reduces user's waiting time, making the entire operation smoother and more efficient. The third storage condition is determined when the vertical distance between the top of the microphone 200 and the screen 315 is less than a preset distance.

Specifically, the preset distance may be set to 20 mm, 15 mm or 25 mm by a user or a manufacturer according to actual requirements, which is not excessively limited herein.

In a possible embodiment, when the fourth preset condition is satisfied, the microphone 200 is determined to be unnecessary for use, and the microphone 200 falls from the second position 318 to the first position 317. Exemplarily, when the retention time of the microphone 200 in the storage groove 121 after being lifted exceeds a preset retention time, the drive assembly 130 drives the microphone 200 to fall to complete storage. After the microphone 200 rise to the accessible state, if it is not picked up by the user for more than 30 seconds (i.e., the preset retention time), the microphone storage assembly 100 is automatically activated to store the microphone 200. Of course, in the specific application, the preset retention time can be set according to actual needs. For example, the preset retention time may also be set to 20 seconds, 40 seconds, 50 seconds, or 1 minute. The preset retention time can be set either by the user or by the manufacturer.

In a possible embodiment, when the fifth preset condition is satisfied, the microphone 200 is determined to need to be raised again, and the microphone 200 rises from the second position 318 to the first position 317.

When the smart speaker 300 is powered on, and the user accidentally or manually presses to store the microphone 200, the user can take out the microphone 200 again. The microphone 200 can be taken out by the following two methods: first, manually press the storage structure to lift the microphone 200 again; second, a pop-up prompt appears on the screen 315 after the microphone 200 is retracted, and the user can choose to lift the microphone 200 again; third, use the drive assembly 130 to lift the microphone 200, which can be triggered by button pressing, knob operation, roller operation, voice command, touch operation or infrared induction.

In a possible embodiment, the method further comprises: the storage modes of the microphone 200 include driving storage by the drive assembly 130 and manual pressing storage. Exemplarily, under normal conditions, the microphone storage assembly 100 is powered by the drive assembly 130 to drive the microphone 200 to rise or fall. Under special circumstances, for example, when the smart speaker 300 is powered off or not turned on, the user can take out the microphone 200 by manual pressing. Understandably, the drive motor 131 in the microphone storage assembly 100 does not self-lock when powered off, and the output shaft of the motor can rotate passively, so the drive motor 131 does not affect the lifting and lowering of the microphone 200. The motor can reversely rotate in the event of power loss or external force, allowing the user to manually store the microphone 200 by pressing it down.

In a possible embodiment, under normal circumstances, after the smart speaker 300 is powered on, the microphone 200 rises while the screen 315 is opened. However, under special conditions, for example, the user has retracted the microphone 200 while the screen 315 remains open, the subsequent use of the microphone 200 is regarded as secondary use. Since there is no obstruction from the screen 315, there is no risk of collision between the microphone 200 and the screen 315 during rising. Therefore, the microphone 200 can rise rapidly at this time to meet the user's urgent need for the microphone.

As shown in FIG. 24 to FIG. 26, the embodiment of the invention provides an automatic microphone lifting structure, which comprises a speaker body 310 and at least one microphone 200; a screen 315 is connected to the speaker body 310, and a storage groove 121 for accommodating the microphone 200 is formed on the speaker body 310; the storage groove 121 is provided with a receiving assembly 1309 electrically connected to the screen 315 or the speaker body 310; when the screen 315 is opened or closed, the receiving assembly 1309 automatically lifts or retracts the microphone 200, so that the microphone 200 is lifted or retracted into the storage groove 121. When the microphone automatic lifting structure provided by the embodiment of the invention is in use, and the screen 315 is opened and rotated to a certain angle or distance, the storage assembly lifts the microphone 200 upward so that the microphone 200 extends out of the storage groove 121. When the screen 315 is closed above the speaker body 310, the receiving assembly 1309 retracts the microphone 200 into the storage groove 121. The automatic microphone lifting structure of the invention uses the screen 315 as a signal to activate the receiving assembly 1309. The receiving assembly 1309 automatically lifts or retracts the microphone 200, thereby realizing automatic lifting or retraction of the microphone 200 into the storage groove 121. This solves the problems of lifting failure and locking failure of the microphone 200 associated with manual pressing in the prior art, thereby improving user experience.

It should be noted that the speaker body 310 in this embodiment is movably connected to the screen 315, specifically via a rotating shaft, a hinged support and a universal ball. Of course, in other embodiments of the resent invention, the speaker body 310 may also be movably connected to the screen 315 by means of magnetic attraction. It should be noted that in this embodiment, two microphones 200 are arranged. Obviously, one, three or even more microphones 200 may also be arranged. This embodiment only exemplifies a scenario where two microphones 200 are fitted to the speaker body 310. For embodiments in which one, three or even more microphones 200 are fitted to the speaker body 310, it is only necessary to correspondingly provide accommodating grooves on the speaker body 310 in a number corresponding to the microphones 200.

As shown in FIG. 24 to FIG. 26, in an embodiment of the invention, the upper surface of the speaker body 310 is concave downward to form a placement slot 316, the screen 315 is flipped and received in the placement slot 316. In this embodiment, the opening of the storage groove 121 is located at the bottom of the placement slot 316 to lift or store the microphone 200 in the storage groove 121. The placement slot 316 extends downward into the internal space of the speaker body 310. Further, a main control board, an air duct, a speaker assembly, a storage battery, etc., may be arranged in the internal space of the speaker body 310. These are not the focus of this embodiment, so they are not described in detail herein. In this embodiment, a sensor 3151 is arranged in the screen 315 or the speaker body310, is electrically connected to the receiving assembly 1309, and is used for sensing the rotation direction and angle of the screen 315 or sensing the distance between the screen 315 and the top surface of the placement slot 316 to realize automatic lifting or storage of the microphone 200 through the receiving assembly 1309. Specifically, in this embodiment, the sensor 3151 is electrically connected to the main control board in the internal space of the speaker body 310. When the sensor 3151 detects that the screen 315 rotates to a certain direction and angle, or senses the distance between the screen 315 and the top surface of the placement slot 316, the sensor 3151 sends a signal to the main control board. The main control board then controls the receiving assembly 1309, which in turn controls the automatic lifting or retraction of the microphone 200, thereby realizing automatic lifting or retraction of the microphone 200 into the storage groove 121. This solves the problems of lifting failure and locking failure of the microphone 200 associated with manual pressing in the prior art, thereby improving user experience.

It should be noted that the sensor 3151 in this embodiment may be a Hall element, a distance sensor, an infrared sensor, or the like. This embodiment does not limit the type of sensor 3151, which can be arranged according to actual application. Of course, other sensors capable of sensing the rotation direction and angle of the screen 315 or the distance between the screen 315 and the top surface of the placement slot 316 fall within the protection scope of the invention.

Further, the receiving assembly 1309 comprises a first magnetic attraction component 150 and a second magnetic attraction component 210, and the first magnetic attraction component 150 and the second magnetic attraction component 210 generate identical or opposite magnetic forces; the first magnetic attraction component 150 is arranged at the bottom of the microphone 200, and the second magnetic attraction component 210 is arranged at the bottom of the storage groove 121; or the first magnetic attraction component 150 is arranged at the bottom of the storage groove 121, and the second magnetic attraction component 210 is arranged at the bottom of the microphone 200. In this embodiment, when the screen 315 is opened and rotated to a certain angle or distance, and the sensor 3151 detects that the screen 315 rotates to a predetermined direction and angle or senses the distance between the screen 315 and the top surface of the placement slot 316, the sensor 3151 sends a signal to the main control board. The main control board then activates the receiving assembly 1309. At this time, the first magnetic attraction component 150 and the second magnetic attraction component 210 are energized and generate opposite magnetic forces, so that the microphone 200 is lifted out of the microphone storage groove. When the screen 315 is received in the placement slot 316, the first magnetic attraction component 150 and the second magnetic attraction component 210 generate identical magnetic forces, and the microphone 200 automatically falls, thereby being retracted in the microphone storage groove.

Specifically, both the first magnetic attraction component 150 and the second magnetic attraction component 210 are magnetic induction coils 250, which generate identical or opposite magnetic forces; or the first magnetic attraction component 150 is a magnetic induction coil 250, and the second magnetic attraction component 210 is a magnet 260; the magnetic induction coil 250 is used to generate a magnetic force identical or opposite to that of the magnet 260. In this embodiment, the magnetic induction coil 250 and the magnet 260 can generate identical or opposite magnetic forces when energized, thereby lift or retract the microphone 200. Moreover, the magnetic induction coil 250 and the magnet 260 in this embodiment are small in volume, facilitating their assembly at the bottom of the microphone 200 or the bottom of the accommodating groove.

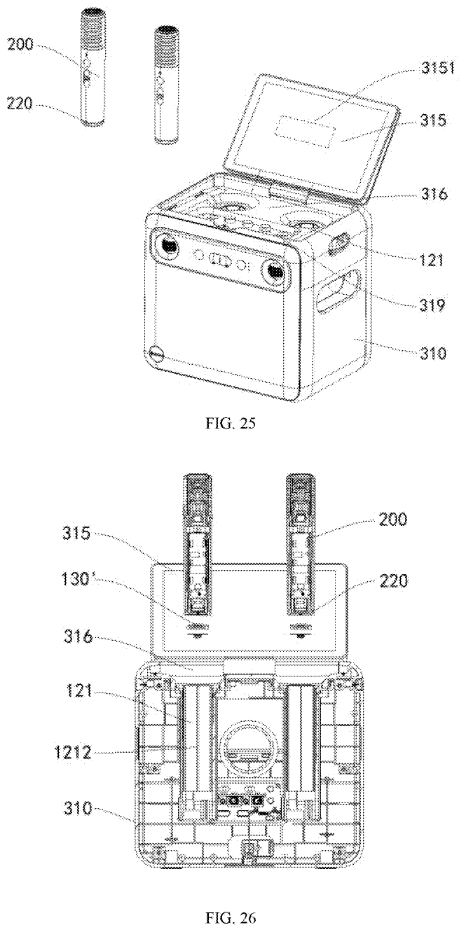

As shown in FIG. 25 to FIG. 26, in an embodiment of the invention, the number of the storage grooves 121 corresponds to the number of microphones 200 one to one; the depth of each storage groove 121 is greater than or equal to the height of the microphone 200; the microphone 200 is movably lifted or stored in the storage groove 121. Specifically, in this embodiment, two storage grooves 121 are arranged side by side. When only one microphone 200 is in use, the other microphone 200 is stored in the storage groove 121. Of course, the number of storage grooves 121 may also be one, three, or even more. This embodiment only takes two storage grooves 121 as an example. For embodiments with one, three or even more storage grooves 121, it is only necessary to provide a corresponding number of storage grooves 121 on the speaker body 310.

As shown in FIG. 25 to FIG. 27, in an embodiment of the invention, a limit groove 220 is provided on the outer circumference of the bottom of the microphone 200; a plurality of damping structures 1212 matched with the limit groove 220 are arranged on the inside wall of the storage groove 121. Through the fit between the limit groove 220 and the damping structure 1212, the limit groove 220 slides and rubs against the damping structure 1212 during the upward or downward movement of the microphone 200, thereby increasing the friction during the lifting and lowering process and preventing the microphone 200 from popping out suddenly and colliding with the screen 315. Further, the damping structures 1212 are arranged along the circumferential direction of the storage groove 121; the damping structures 1212 are silicone strips or rubber strips arranged on the inside wall of the storage groove 121. Since the silicone or rubber strip has certain elasticity, the contact friction is increased during the lifting or retracting of the microphone 200, allowing the microphone 200 to move slowly into or out of the storage groove 121 and preventing it from popping out suddenly and colliding with the screen 315.

As shown in FIG. 25, in an embodiment of the invention, a control button 319 is arranged on the speaker body 310, is electrically connected to the receiving assembly 1309 and controls the operation of the receiving assembly 1309. Specifically, the control button 319 on the speaker body 310 is electrically connected to the main control board in the internal space of the speaker body 310; the control button 319 sends a signal to the main control board, and the main control board controls the operation of the storage assembly 1309; the storage assembly 1309 then controls the automatic lifting or retracting of the microphone 200, thereby realizing automatic lifting or retracting of the microphone 200 into the storage groove 121. This solves the problems of lifting failure and locking failure of the microphone 200 associated with manual pressing in the prior art, thereby improving user experience.

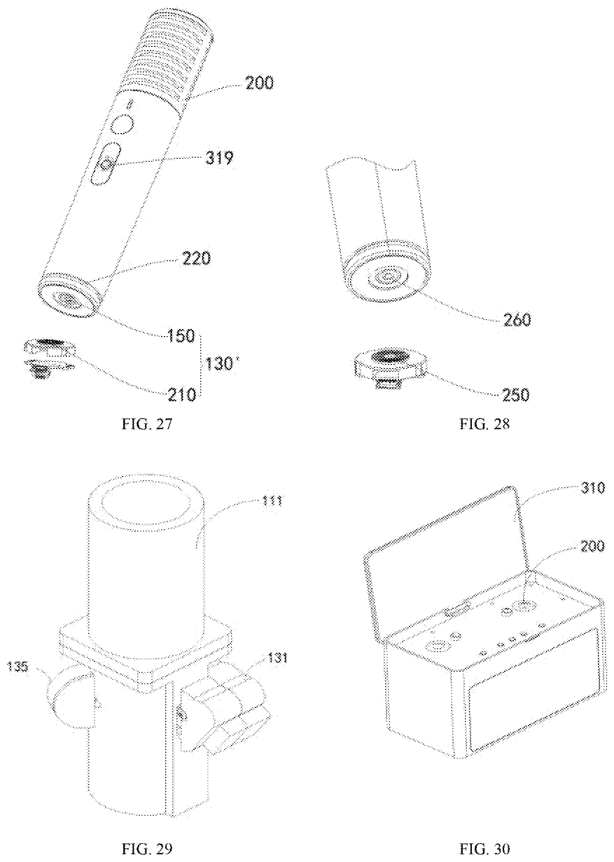

As shown in FIG. 27, in an embodiment of the invention, a control button 319 is arranged on the microphone 200, is electrically connected to the receiving assembly 1309 and controls the operation of the receiving assembly 1309. Specifically, the control button 319 on the microphone 200 is electrically connected to the main control board in the internal space of the speaker body 310; the control button 319 sends a signal to the main control board, which controls the operation of the storage assembly 1309; the storage assembly 1309 then controls the automatic lifting or retraction of the microphone 200, thereby realizing automatic lifting or retraction of the microphone 200 into the storage groove 121.

In an embodiment of the invention, a voice control module is arranged inside the speaker body 310, is electrically connected to the receiving assembly 1309 and controls the operation of the receiving assembly 1309.

Specifically, the voice control module inside the speaker body 310 is electrically connected to the main control board in the internal space of the speaker body 310; the voice control module sends a signal to the main control board, which controls the operation of the storage assembly 1309; the storage assembly 1309 then controls the automatic lifting or retraction of the microphone 200, thereby realizing automatic lifting or retraction of the microphone 200 into the storage groove 121.

To sum up, the automatic microphone lifting structure of the invention uses the screen 315 as a signal to activate the receiving assembly 1309. The receiving assembly 1309 automatically lifts or retracts the microphone 200, thereby realizing automatic lifting or retraction of the microphone 200 into the storage groove 121. This solves the problems of lifting failure and locking failure of the microphone 200 associated with manual pressing in the prior art, thereby improving user experience.

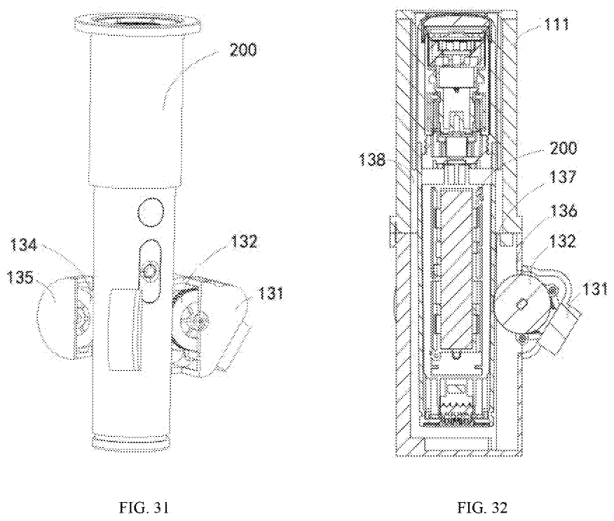

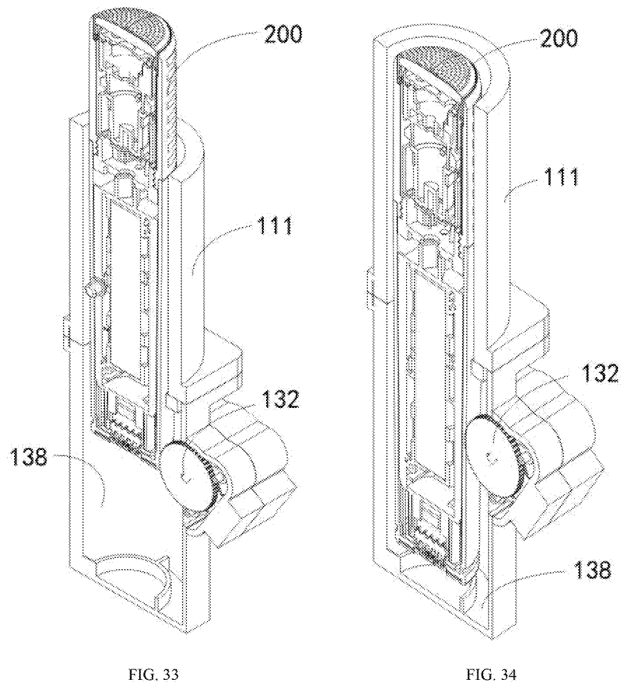

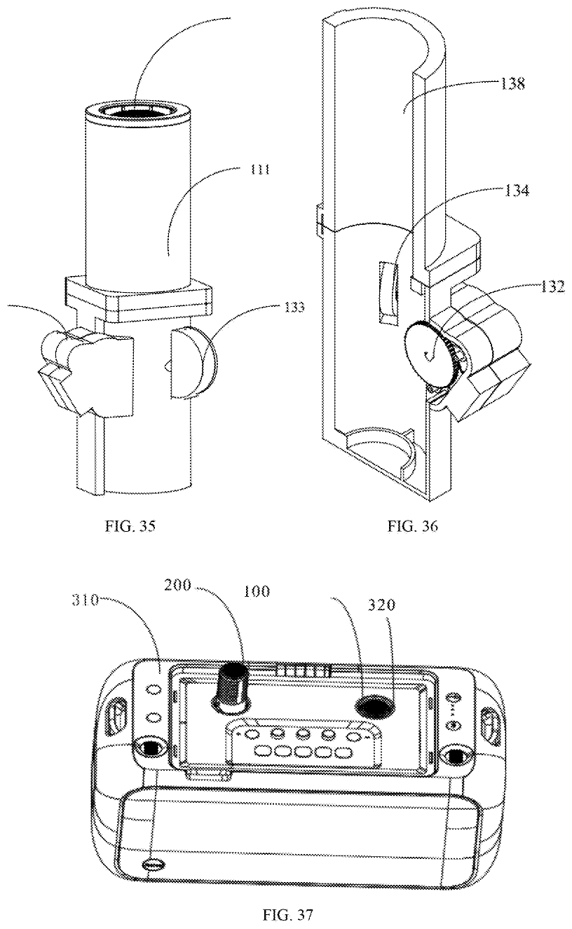

As shown in FIG. 29 to FIG. 36, in the embodiment of the invention, a microphone storage device for storing the microphone, comprising a seat body 111 with an accommodating cavity 138 open at one end; a gear 132 arranged beside the seat body 111 and extending into the accommodating cavity 138 such that the gear 132 abuts against the microphone 200 placed in the seat body 111; a drive motor 131 arranged beside the gear 132, in driving connection with the gear 132 and used for driving the gear 132 to displace the microphone 200 in the accommodating cavity 138.

In the application, the gear 132 driven by the drive motor 131 abuts against the microphone 200, and the microphone 200 is driven to fall to the bottom of the seat body 111 by the friction force between the microphone 200 and the gear 132. The seat body 111 guides the displacement direction of the microphone 200 during retraction, thereby realizing automatic retraction of the microphone 200. Specifically, the microphone storage device may be a cavity for accommodating the microphone 200, namely the accommodating cavity 138. The depth of the cavity is greater than or equal to the length of the microphone 200. The cavity is provided with an opening, through which the microphone 200 can be inserted vertically or horizontally along its length into the cavity to realize insertion-type storage. The microphone 200 fixing structure may be arranged inside or outside the opening to fix the microphone 200 after storage. Specifically, the drive motor 131 may be a DC motor, asynchronous motor, synchronous motor or other motor capable of driving the gear 132 to rotate or move.

Further, since the friction force between the gear 132 and the microphone 200 is sufficiently large, the microphone 200 can be stably clamped without an additional clamping jaw mechanism, simplifying the structure of the device. In addition, the movement speed of the gear 132 can be precisely controlled by adjusting the driving power of the drive motor 131. Specifically, the power of the drive motor 131 can be divided into several levels, each corresponding to a different operating speed. Different physical buttons arranged on the microphone storage device can be pressed to trigger different power levels, so that the falling speed and force of the microphone 200 can be stably controlled, reducing noise and vibration caused by shaking or impact of the microphone 200. Specifically, the user only needs to place the microphone 200 into the accommodating cavity 138 of the seat body 111, and the rest of the storage process is completed automatically, which improves the convenience of use. Through the friction of the gear 132, the microphone 200 can maintain a constant speed during storage, ensuring stable retraction and reducing shaking and noise. Overall, the application realizes automatic and stable storage of the microphone 200 through the drive motor 131 and the gear 132, improving user experience while reducing noise and device wear. The gear 132 comprises a gear, which is in drive connection with the rotating shaft of the drive motor 131; the gear abuts against the microphone 200. When the drive motor 131 rotates, the rotating shaft drives the gear to rotate, and the gear transmits power to the microphone 200 to move it within the seat body 111. The contact between the gear and the surface of the microphone 200 provides sufficient friction to ensure the stability of the microphone 200 during storage and prevent sliding or swinging. By precisely controlling the speed of the drive motor 131, the speed of the gear can be adjusted, thereby controlling the falling speed and force of the microphone 200 to achieve smooth storage.

Further, the gear 132 may also be a rack, a belt drive, a chain, a sprocket, or other transmission structures driven by the drive motor 131. Specifically, a belt and pulleys may be used to transmit power. The belt wraps around the pulleys on the shaft of the drive motor 131 and another or more other pulleys, and drives the movement of the microphone 200 via friction between the belt and the microphone. A worm and worm gear may also be used; the worm rotates and drives the worm gear to rotate, thereby converting rotational motion into linear motion.

The surface layer of the gear 132 is covered with a first buffer layer 136. Specifically, there are three ways to increase friction between the microphone 200 and the seat body 111 during storage. First, if the surface of the microphone 200 is made of hard material such as metal, the surface of the gear 132 adopts a soft rubber structure. Second, if the surface of the microphone 200 adopts the soft rubber structure, the surface of the gear 132 is made of hard material. Third, both the microphone 200 and the gear 132 adopt the soft rubber structure. In all three cases, the gear 132 drives the microphone 200 to fall and be retracted by increasing friction. The contact between the gear 132 and the buffer layer on the surface of the microphone 200 provides sufficient friction to prevent sliding or swinging of the microphone 200 during retraction. The buffer layer reduces scratches or damage caused by direct contact between hard materials, thereby protecting the surface of the microphone 200. With certain elasticity, the buffer layer absorbs part of the impact force when the microphone 200 is lowered and retracted, thus reducing noise and vibration resulting from impact. In other words, the buffer layer of the application can be made of material with a high coefficient of friction, such as rubber, silicone, or a specialized high-friction coating, all of which inherently provide high friction.

Furthermore, the buffer layer can be formed by increasing the surface roughness of either the microphone 200 or the gear 132, resulting in tighter contact and higher friction. This can be achieved through physical rubbing, sandblasting, chemical treatment, or other similar methods.

The microphone storage device further comprises a support and guide assembly 133, which is arranged beside the gear 132; when the microphone 200 is placed in the accommodating cavity 138, the support and guide assembly 133 is used to guide or fix the microphone 200 during storage. The support and guide assembly 133 restricts the freedom of movement of the microphone 200 during storage through physical contact, ensuring stability and reducing wobbling or vibration. The support and guide assembly 133 not only provides support but also acts as a guide, helping the user correctly position the microphone 200 in the storage device and avoiding damage or malfunction caused by improper placement. With stable support and guidance, noise and potential wear caused by the microphone 200 impacting the seat body 111 during storage are reduced.

Further, the support and guide assembly 133 may be a pulley 134, which guides and supports the movement of the microphone 200 through the groove of the pulley 134. The pulley 134 may be a bearing pulley fixed to the seat body 111 to reduce friction and provide smooth movement. The pulley 134 can also be a guide rail and a sliding block. The guide rail is fixed inside the seat body 111, and the sliding block is a matching component that can slide along the guide rail. When the microphone 200 is placed into the seat body 111, the sliding block comes in contact with the microphone 200 and moves smoothly along the linear guide rail. The pulley 134 can be also a ball bearing system, which is similar to the guide rail and sliding block design but uses balls instead of the sliding block to reduce friction and improve movement smoothness. The ball bearings can be installed in a frame so that they can surround and support the microphone 200. The support and guide assembly 133 comprises a pulley 134 and a support shell 135 fixed on the seat body 111; the pulley 134 is connected to the support shell 135 through a bearing; the gear abuts against the microphone 200. The combination of the pulley 134 and the support shell 135 provides a stable support platform for the microphone 200. When the microphone 200 is placed into the seat body 111, the pulley 134 come into contact with the microphone 200 and reduces friction through the rotation of the bearing, allowing the microphone 200 to move smoothly to the designated position. Since the pulleys 134 are connected via bearings, they can rotate freely, which reduces direct sliding friction with the surface of the microphone 200 and helps protect the surface from scratches or wear. Moreover, the pulley 134 not only provides support but also helps guide the microphone 200 into the correct storage position, preventing damage or positional deviation caused by improper placement. Two support and guide assemblies 133 are arranged inside the seat body 111; the gear 132 and the two support and guide assemblies 133 are arranged at equal intervals in the radial direction perpendicular to the central axis of the seat body. Specifically, the gear 132 and the two support and guide assemblies 133 are arranged at equal intervals along the trisection direction of the circumference of the microphone 200 and abut against the microphone 200. The three supporting points (the gear 132 and two support and guide assemblies 133) are distributed at equal intervals along the trisection direction of the circumference of the microphone 200, ensuring uniform support during retraction and preventing tilting or imbalance. Multiple supporting points are provided around the microphone 200 to enhance overall stability and reduce wobbling or vibration during movement or operation. With uniform and stable support, the microphone 200 is protected from accidental damage caused by unstable positioning, prolonging the service life of the device. Stable support also lowers noise and vibration during the movement of the microphone 200, delivering a quieter and smoother operating experience. Further, a plurality of support and guide assemblies 133 may be provided to support the microphone 200 in multiple directions. The length from the opening of the seat body 111 to the gear 132 is a first preset value, and the length from the bottom of the seat body 111 to the gear 132 is a second preset value; the first preset value is smaller than the second preset value. By adjusting the length from the opening of the seat body 111 to the gear 132 (first preset value), the entry speed of the microphone 200 at the start of storage can be controlled. A smaller first preset value means that the microphone 200 comes into contact with the gear 132 more quickly during the initial falling. The length from the bottom of the seat body 111 to the gear 132 (second preset value) is larger, providing sufficient vertical space to ensure that the microphone 200 can fully fall to the storage position. This length ratio design is used to allocate different retraction forces during the falling of the microphone 200: rapid introduction in the initial stage, and slow and stable completion in the later stage. A sensing assembly is arranged at the opening of the accommodating cavity 138. When the microphone 200 is placed into the storage groove, the sensing assembly can detect the position of the microphone 200 and trigger the subsequent storage operation, simplifying the user operation process through automatic detection. The sensor can send a signal to the control system, indicating that the microphone 200 is in place and ready for storage, facilitating intelligent control. The user only needs to simply place the microphone 200 in position without close monitoring, which greatly simplifies the operation and provides an improved user experience.

A smart speaker, comprising a microphone storage device, a speaker body and a microphone 200; the speaker body is provided with a storage groove, the microphone storage device is mounted in the storage groove, and the microphone 200 is placed in the microphone storage device. A charging structure is arranged at the bottom of the microphone 200. The charging structure at the bottom of the microphone 200 can be a plug-in charging pin, a contact charging pin, or wireless charging, which can be matched according to the smart speaker; a switch electrically connected to the drive motor 131 may be arranged on the speaker body, and the rotation direction and speed of the drive motor can be controlled via the switch to realize the storage and removal of the microphone.

The surface layer of the microphone 200 is covered with a second buffer layer 137. Specifically, the buffer layer between the microphone 200 and the gear 132 can be configured in the following ways. First, if the surface of the microphone 200 is made of hard material such as metal, the surface of the gear 132 adopts a soft rubber structure. Second, if the surface of the microphone 200 adopts the soft rubber structure, the surface of the gear 132 is made of hard material. Third, both the microphone 200 and the gear 132 adopt the soft rubber structure. When the microphone 200 is connected to the speaker body 310 and is too close to the speaker body 310, howling occurs, producing a sharp and harsh sound that seriously affects the user experience. In particular, when the microphone 200 is stored in the speaker body 310, the impact and friction noises between the microphone 200 and the speaker body 310 during storage further increase the probability of howling. In view of this, the microphone 200 can be designed to automatically power off when approaching the speaker body 310, preventing howling when the microphone 200 is close to the speaker body 310 or during the storage process.

In some embodiments, to prevent howling when the microphone 200 approaches the speaker body 310 or during storage of the microphone in the speaker, the microphone 200 can be configured to automatically power off when approaching the speaker. Specifically, sensing elements may be arranged on the microphone 200 and/or the speaker. The sensing elements are configured to sense the distance between the speaker body 310 and the microphone 200, generate a corresponding sensing signal when the distance between the speaker and the microphone 200 is less than or equal to a preset distance, and send the sensing signal to the control device of the microphone 200, or send the sensing signal to the control device of the microphone 200 via the speaker, so that the control device controls the microphone 200 to power off. More specifically, one or more sensing elements may be distributed, which may be Hall element, distance sensor, infrared sensor, any other individual electronic component capable of sensing the distance between the speaker and the microphone 200, or any combination of the electronic components.

In some specific embodiments, when the microphone 200 storage structure is a cavity (i.e., an accommodating cavity), the sensing element may be arranged at the opening of the cavity. When the microphone 200 is inserted into the 200, the sensing element may generate a corresponding sensing signal immediately upon initial insertion of the microphone 200 to turn off microphone 200. In addition, the sensing element may also be arranged at one end of the cavity away from the opening, and can likewise generate a corresponding sensing signal to turn off the microphone 200 when the microphone 200 is inserted near the sensing element. Furthermore, this arrangement prevents the sensing element from being exposed outward, thereby avoiding component aging.

In some more specific embodiments, the sensing elements are Hall element and magnetic component, which are respectively arranged at corresponding positions of the speaker body 310 and the microphone 200. For example, the magnetic component is arranged at the corresponding position of the microphone 200, and the Hall element is arranged at the corresponding position of the speaker body 310; or the Hall element is arranged at the corresponding position of the microphone 200, and the magnetic component is arranged at the corresponding position of the speaker body 310. The triggering condition of the Hall element may be that the detected magnetic field intensity reaches a preset value. When the detected magnetic field intensity is greater than or equal to the preset value, it indicates that the distance between the speaker and the microphone 200 is sufficient to cause howling, and the microphone 200 needs to be powered off accordingly.

In some preferred embodiments, the magnetic component is arranged at the corresponding position of the microphone 200, and the Hall element is arranged at the corresponding position of the speaker. Given that the user may carry the microphone 200 to move around freely during karaoke sessions, the microphone 200 may be moved to the areas with strong external magnetic fields. The Hall element arranged on the microphone 200 may trigger accidental power-off of the microphone 200, thereby adversely affecting the experience. When the microphone 200 storage structure is a cavity, i.e., when the microphone 200 is stored in an insertion manner, the Hall element may be arranged at the opening of the speaker cavity or at the end away from the opening.

In other more specific embodiments, the sensing elements are Hall element and charging element, wherein the charging element comprises a charging structure and a power receiving structure. The speaker body 310 is correspondingly provided with a charging structure, and the microphone 200 is correspondingly provided with a power receiving structure. It should be noted that a magnetic field change occurs at the moment when the charging structure and the power receiving structure abut against each other. Based on this, the triggering condition for the Hall element can be set to detect a magnetic field change. When the Hall element detects a magnetic field change, it indicates that the charging structure of the speaker is in contact with the power receiving structure of the microphone 200. At this point, the distance between the speaker and the microphone 200 is sufficient to cause howling, so the microphone 200 needs to be powered off. Specifically, the charging structure may be arranged on the surface of the speaker or corresponding to the storage structure. When the microphone 200 storage structure is a cavity, i.e., when the microphone 200 is stored in an insertion manner, the charging structure is arranged at the end of the speaker cavity away from the opening, and the power receiving structure is correspondingly arranged at the bottom or end surface of the microphone 200. The Hall element may be arranged near the charging structure, so that it can sense the magnetic field change caused at the moment of power-on. In addition, the Hall element can also be arranged near the power receiving structure, where the Hall element can likewise sense the magnetic field change caused at the moment of power-on.

In other more specific embodiments, the sensing elements are Hall element and charging element, wherein the charging element comprises a charging structure and a power receiving structure; the speaker is correspondingly provided with a charging structure, and the microphone 200 is correspondingly provided with a power receiving structure. In addition, the magnetic components may also be arranged on the speaker and the microphone 200 and arranged outside the sensing trigger range of the Hall element. The magnetic components are used to fix the microphone 200 rather than trigger the Hall element.

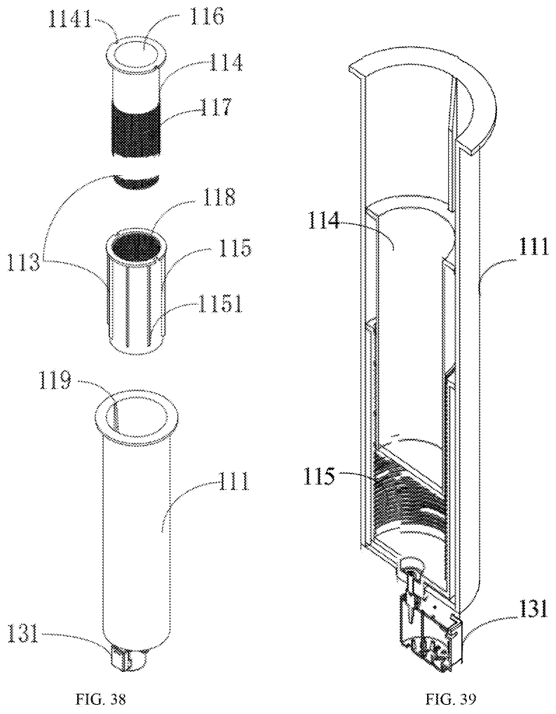

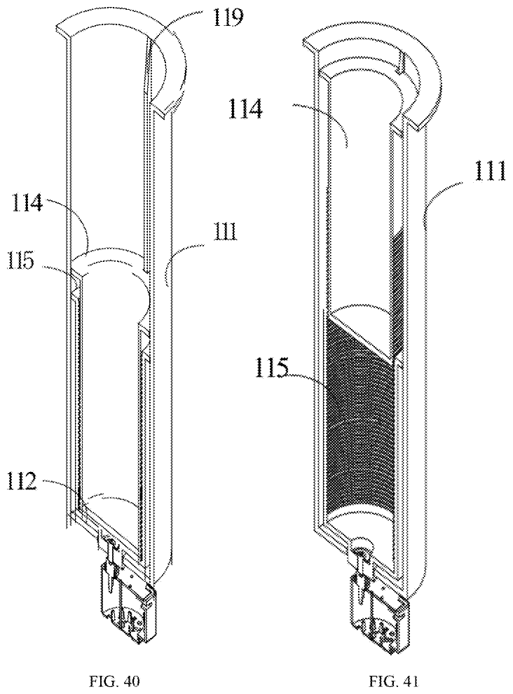

As shown in FIG. 37 to FIG. 44, a smart speaker, comprising a speaker body 310, a telescopic assembly 113 and a drive motor 131, wherein the speaker body 310 is provided with a mounting groove 320; a microphone storage assembly 100 is mounted in the mounting groove 320; the microphone storage assembly 100 comprises a base 111 located inside the speaker body 310; the telescopic assembly 113 is located inside the base 111 and is telescopic along the base 111; the drive motor 131 is arranged on the base 111, is in driving connection with the telescopic assembly 113 and drives the telescopic assembly 113 to extend and retract.

Further, the speaker body 310 is provided with the microphone storage assembly 100 for storing the microphone 200. The storage structure of the seat body 111 may be a cavity for accommodating the microphone 200, and the depth of the cavity is greater than or equal to the length of the microphone 200. The cavity comprises an opening, through which the microphone 200 can be inserted vertically or horizontally into the cavity along its length direction to realize insertion storage. The microphone fixing structure may be arranged inside or outside the opening to secure the microphone 200 after storage. The opening may be arranged at any position of the speaker, including the top, side and bottom surfaces of the speaker body 310. Specifically, the seat body 111 is located inside the speaker body 310 and provides an accurate movement path for the telescopic assembly 113. This ensures that the telescopic assembly 113 can move smoothly and precisely along the predetermined path, thereby avoiding offset or swinging and reducing wear and noise.

The telescopic assembly 113 is located inside the seat body 111 and is directly responsible for the storage and removal of the microphone 200. When the microphone 200 needs to be used, the telescopic assembly 113 rises from the storage assembly mounting groove 320 to push out the microphone 200. When not in use, the telescopic assembly 113 retracts into the storage assembly mounting groove 320 to safely store the microphone 200. The drive motor 131 is the core drive mechanism of the entire microphone storage assembly 100 and is in driving connection with the telescopic assembly 113 and can drive the telescopic assembly 113 to extend and retract by receiving signals from the control system. For example, when the user issues a command of “use the microphone”, the drive motor 131 drives the telescopic assembly 113 to rise upward and push out the microphone 200. When the user issues a command of “store the microphone”, the drive motor 131 drives the telescopic assembly 113 to retract, safely storing the microphone 200 into the storage assembly mounting groove 320. More specifically, in the smart speaker, the user issues a command via voice or other control methods. After receiving the command, the control system of the speaker parses and converts the command into a corresponding control signal, which is sent to the drive motor 131 to trigger its operation. The drive motor 131 drives the telescopic assembly 113 to perform the corresponding extension or retraction action according to the command. The telescopic assembly 113 moves smoothly along the seat body 111 to complete the removal or storage of the microphone 200. After the whole process, the system returns to the standby state and waits for the next command.

Specifically, the telescopic assembly 113 may be a spiral lifting structure, which realizes vertical movement through spiral threads; the telescopic assembly 113 may also be a gear and rack structure, where the meshing of the gear and the rack can convert rotational motion into linear motion to realize the telescopic function; it may also be a sliding block and guide rail structure, which realizes expansion and contraction through a sliding block sliding on a fixed guide rail, and is usually used with the seat body 111 to ensure linearity of motion; the telescopic assembly 113 may also be a ball screw structure, where the ball screw converts rotational motion into linear motion, and precise telescopic displacement is realized by driving the rotation of the ball screw via the drive motor 131. The drive motor 131 comprises a rotary drive mechanism; the telescopic assembly 113 comprises a lifting component 114 and a rotating component 115, and the rotating component 115 is in driving connection with the drive end of the rotary drive mechanism; the lifting component 114 and the rotating component 115 are connected through a transmission structure, which is used for converting the rotary motion of the rotating component 115 into the lifting motion of the lifting component 114. Specifically, the rotation driving structure is the core of the drive motor 131, typically a motor that provides rotating force, and the rotation of the motor can be output through its rotating shaft. The rotating component 115 is in direct driving connection with the drive end of the rotation drive mechanism, and rotates synchronously with the motor. The lifting component 114 is part of the telescopic assembly 113 and is responsible for the actual lifting movement. The lifting component 114 is connected to the rotating component 115 via a transmission structure, which is used to convert the rotational motion of the rotating component 115 into linear lifting motion of the lifting component 114. The transmission structure comprises threads, gears, belts, and the like. More specifically, when receiving an operation instruction (e.g., a user request to use the microphone 200), the control system activates the rotation drive mechanism (motor). The drive end of the motor starts to rotate, and this rotational motion is transmitted to the rotating component 115 through its connection therewith. The rotational motion of the rotating component 115 is converted into linear motion of the lifting component 114 via the transmission structure. If threads are used, the rotation of the rotating component 115 causes the threads to push the lifting component 114 to move up or down. As the lifting component 114 moves up or down, the microphone 200 connected thereto is pushed out or stored back inside the speaker body 310. Once the microphone 200 reaches the predetermined position, the control system stops the motor to ensure the microphone 200 is in the correct position.

Further, the rotating component 115 may be a threaded screw or lead screw; the lifting component 114 comprises a nut matched with the screw; the nut is fixed to the lifting cylinder or other lifting components. When the screw rotates, the nut moves up and down along the screw, thereby driving the lifting component 114 to rise or fall. The rotating component 115 may be a rotating shaft with a gear; and the lifting component 114 comprises a rack meshed with the gear; the rack is fixed to the lifting cylinder or other lifting components. When the gear rotates, the rack is driven to move up and down, thereby driving the lifting component 114 to rise or fall. The rotating component 115 may be a crankshaft, with one end connected to the rotating shaft of the drive motor 131. The lifting component 114 comprises a connecting rod connected to the other end of the crankshaft, and the other end of the connecting rod is connected to the lifting cylinder. When the crankshaft rotates, the slider is driven to move up and down through the movement of the connecting rod, and the lifting cylinder moves accordingly.

In this embodiment, the transmission structure comprises a first thread 117 provided on the lifting component 114 and a second thread 118 provided on the rotating component 115, and the first thread 117 and the second thread 118 are fittingly connected with each other. A guide portion 119 is arranged inside the seat body 111; the lifting component 114 is provided with a limit portion 1141 matched with the guide portion 119. The fit cooperation between the guide portion 119 and the limit portion 1141 ensures that the lifting component 114 rises or falls, such that the lifting cylinder or other moving parts move smoothly along a predetermined path. This design can prevent offset or swinging, thereby reducing wear, noise and operational errors. The fit between the limit portion 1141 and the guide portion 119 can also define the starting point and end point of the movement of the lifting component 114, ensuring that the lifting component 114 only moves within the allowable range, and helping protect the device from damage caused by over-extension or over-compression.

Further, the guide portion 119 may be a slide rail, and the limit portion 1141 may be a sliding block slidably connected to the slide rail; the guide portion 119 may also be a protruding post, and the limit portion 1141 may be a groove matched with the protruding post; the guide portion 119 may also be a baffle, and the limit portion 1141 may be a bump; the baffle abuts against the bump to restrict its displacement. Specifically, when the drive motor 131 drives the rotating component 115 to rotate, the rotational motion of the rotating component 115 is converted into linear motion of the lifting cylinder through thread engagement due to the matching between the two threads. The threaded connection allows very precise control of the position of the lifting component 114, because the lifting component 114 rises or falls by a fixed pitch distance for each rotation angle. Thread engagement provides a smooth transmission mechanism that reduces vibration and noise, especially in slow or fine motion control. Moreover, the threads can be trapezoidal threads, and the trapezoidal thread design has a self-locking property, which means that the threads will not loosen without external force, maintaining the stability of the lifting component 114. To sum up, the design of the first thread 117 and the second thread 118 enables the microphone storage assembly 100 for the smart microphone 200 to realize automatic storage and removal of the microphone 200 in a simple, efficient and precise manner.

Further, the first thread 117 may be arranged inside or outside the lifting component 114. When the first thread 117 is arranged outside the lifting component 114, a worm gear transmission may be adopted. The rotating component 115 comprises a worm gear and a worm; the motor drives the worm gear, which in turn drives the worm to rotate, and the worm is in driving connection with the lifting component 114 via the thread on the outer side thereof to drive the lifting component 114 to rise or fall. The rotating component 115 may also be cylindrical, and threads are arranged inside the rotating component 115; the lifting component 114 is placed inside the rotating component 115, and the threads on the outer side of the lifting component 114 are engaged with the threads inside the rotating component 115, such that the lifting component 114 is driven to rise or fall by rotating the rotating component 115.

The rotating component 115 comprises a rotating cylinder, and the second thread 118 is arranged inside the rotating cylinder; the lifting component 114 comprises a lifting cylinder, and the first thread 117 is arranged on the outer side of the lifting cylinder. Specifically, the rotating component 115 is cylindrical, and the lifting component 114 is also cylindrical. The lifting cylinder is arranged inside the rotating cylinder, and the lifting cylinder and the rotating cylinder are connected by threads. Through precise fit between the internal threads and the external threads, the rotation of the rotating cylinder can be directly converted into vertical movement of the lifting cylinder. This conversion mechanism reduces additional moving parts, thereby lowering the risk of mechanical failure and ensuring continuous and smooth movement. Moreover, since both the rotating component 115 and the lifting component 114 are cylindrical, and the lifting cylinder can be completely embedded into the rotating cylinder, the whole device occupies a small space and is convenient to be integrated into space-constrained environments. Further, support plates extending outward are arranged on the upper sides of the rotating cylinder and the lifting cylinder. The diameter of the support plates is adapted to the inner diameter of the seat body 111 to prevent the rotating component 115 from offset or swinging caused by external forces during extension and retraction, and reduce wear and noise.

The guide portion 119 comprises a guide protrusion, and the limit portion 1141 comprises a limit groove. Through the fit between the guide protrusion and the limit groove, precise positioning of the telescopic assembly 113 (such as the lifting cylinder) can be realized. The guide protrusion is embedded into the limit groove and is slidably connected therewith. Specifically, the guide protrusion may be in a shape such as a long strip. This design ensures that the telescopic assembly 113 can accurately reach a predetermined position during movement, that is, the lifting component 114 rises and falls along the direction of the guide protrusion, thereby ensuring correct placement or removal of the microphone 200. Meanwhile, the structure of the guide protrusion and the limit groove provides additional supporting points, increasing the contact area, enhancing the stability of the overall system, helping reduce offset or shaking caused by vibration or other external forces, and improving the reliability of the device.

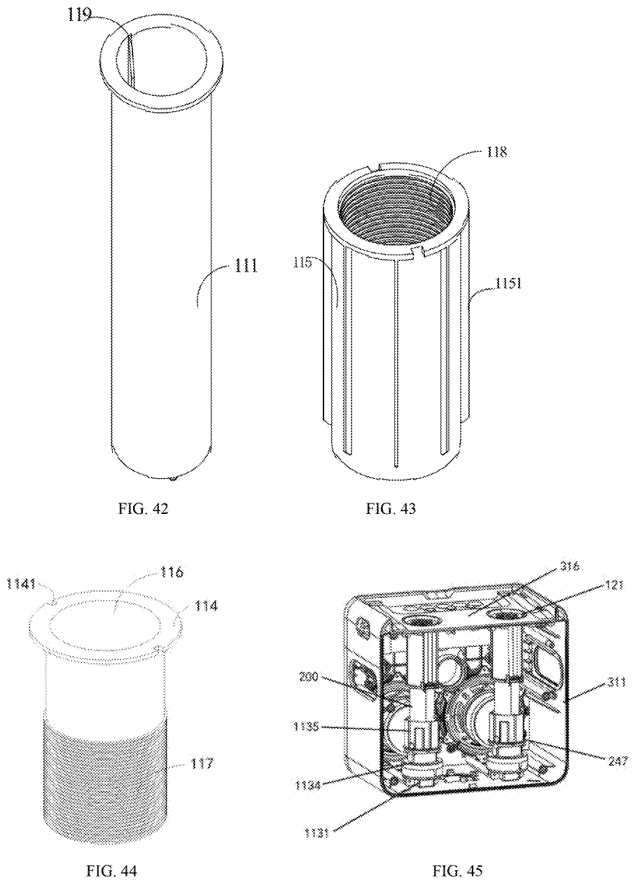

Further, as shown in FIG. 42, the guide protrusion is provided with an inclined surface near the opening of the seat body 111. The closer to the opening, the closer the inclined surface is to the inner wall of the seat body 111. This guide shape prevents the microphone 200 from being bumped due to sharp edges when being inserted into the microphone storage assembly 100.

A magnetic layer 116 is arranged inside the lifting component 114. Specifically, the lifting component 114 may be provided with a magnetic attraction layer 116 at the bottom, side surface, or other positions thereof. The magnetic attraction layer 116 provides additional adsorption force to help keep the microphone 200 stable during lifting, reducing shaking or noise caused by vibration or movement. Moreover, when the user places the microphone 200, precise alignment with the placement slot is not required, as the magnetic attraction layer 116 can automatically adsorb the microphone 200 to the correct position. Specifically, the magnetic attraction layer 116 may be NdFeB magnet, AlNiCo magnet or flexible magnetic material. A flexible magnetic adsorption layer is formed on the surface of the lifting component 114, not only providing adsorption force but also adapting to microphones 200 of different shapes. Alternatively, a thin magnetic adsorption layer may be formed on the surface of the lifting component 114 through a special process, providing adsorption force and maintaining the lightweight property of the lifting component 114.

When the microphone 200 remains connected to the speaker body 310, howling occurs if it is too close to the speaker body 310, producing harsh sound that severely affects user experience. Especially when the microphone 200 is stored into the speaker body 310, the probability of howling triggered by impact and friction noises between the microphone 200 and the speaker body 310 is even higher.

Based on this, the microphone 200 can be configured to automatically power off when approaching the speaker body 310, preventing howling when the microphone 200 approaches the speaker body 310 or during the storage of the microphone 200 into the speaker body 310. Specifically, a sensing assembly is arranged inside the seat body 111. Specifically, a sensing assembly is arranged inside the seat body 111. When the microphone 200 just extends into the seat body 111, the sensing assembly transmits a signal to control the microphone 200 to power off, preventing friction noise and impact noise generated when the microphone 200 extends into the seat body 111 from being amplified to produce loud noise. More specifically, the sensing assembly of the seat body 111 may be arranged at the opening or the bottom of the seat body 111. The sensing assembly is arranged at the opening of the seat body 111. When the microphone is inserted into the seat body, the sensing assembly can generate a corresponding sensing signal immediately upon initial insertion of the microphone 200 to turn off microphone 200. In addition, the sensing assembly may also be arranged at one end of the seat body 111 away from the opening, and can likewise generate a corresponding sensing signal to turn off the microphone 200 when the microphone 200 is inserted near the sensing assembly. Furthermore, this arrangement prevents the sensing assembly from being exposed outward, thereby avoiding component aging.

In some embodiments, the speaker body 310 may be provided with a screen, and may also be provided with a movable structure and a screen storage groove. The screen can be closed via the movable structure so that the screen is stored in the screen storage groove. The microphone storage assembly 100 may be arranged under the screen. After the screen is closed, the microphone 200 is completely covered by the screen and fully housed inside the speaker body 310.

In some embodiments, in order to avoid howling when the microphone 200 approaches the speaker body 310 or the speaker body 310 receives the microphone 200, the microphone 200 can be automatically powered off when approaching the speaker body 310. Specifically, a sensing assembly may be arranged on the microphone 200 and/or the speaker body 310. The sensing assembly may be configured to detect the distance between the speaker body 310 and the microphone 200, generate a corresponding sensing signal when the distance between the speaker body 310 and the microphone 200 is less than or equal to a preset distance, and send the sensing signal to the control device of the microphone 200 directly, or send the sensing signal to the control device of the microphone 200 via the speaker body 310, so that the control device controls the microphone 200 to power off. More specifically, one or more sensing assemblies may be distributed, which may be Hall element, distance sensor, infrared sensor, any other individual electronic component capable of sensing the distance between the speaker and the microphone 200, or any combination of the electronic components.

In some more specific embodiments, the sensing elements are Hall element and a magnetic component, which are respectively arranged at corresponding positions of the speaker and the microphone 200. For example, the magnetic component is arranged at the corresponding position of the microphone 200, and the Hall element is arranged at the corresponding position of the speaker body 310; or the Hall element is arranged at the corresponding position of the microphone 200, and the magnetic component is arranged at the corresponding position of the speaker body 310. The triggering condition of the Hall element may be that the detected magnetic field intensity reaches a preset value. When the detected magnetic field intensity is greater than or equal to the preset value, it indicates that the distance between the speaker and the microphone 200 is sufficient to cause howling, and the microphone 200 needs to be powered off accordingly.

In some preferred embodiments, the magnetic component is arranged at the corresponding position of the microphone 200, and the Hall element is arranged at the corresponding position of the speaker. Given that the user may carry the microphone 200 to move around freely during karaoke sessions, the microphone 200 may be moved to the areas with strong external magnetic fields. The Hall element arranged on the microphone 200 may trigger accidental power-off of the microphone 200, thereby adversely affecting the experience. When the microphone storage assembly of the microphone 200 is a cavity, i.e., when the microphone 200 is stored in an insertion manner, the Hall element may be arranged at the opening of the speaker cavity or at an end away from the opening.

In other more specific embodiments, the sensing assembly is a Hall element and a charging element, and the charging element comprises a charging structure and a power receiving structure. The speaker body 310 is correspondingly provided with a charging structure, and the microphone 200 is correspondingly provided with a power receiving structure. It should be noted that a magnetic field change occurs at the moment when the charging structure and the power receiving structure abut against each other. Based on this, the triggering condition for the Hall element can be set to detect a magnetic field change. When the Hall element detects a magnetic field change, it indicates that the charging structure of the speaker is in contact with the power receiving structure of the microphone 200. At this point, the distance between the speaker and the microphone 200 is sufficient to cause howling, so the microphone 200 needs to be powered off. Specifically, the charging structure may be arranged on the surface of the speaker or corresponding to the storage structure. When the microphone storage assembly for the microphone 200 is a cavity, i.e., when the microphone 200 is stored in an insertable manner, the charging structure is arranged at the end of the speaker cavity away from the opening. The power receiving structure is correspondingly arranged at the bottom or the bottom end surface of the microphone 200. The Hall element may be arranged near the charging structure, so that it can sense the magnetic field change caused at the moment of power-on. In other more specific embodiments, the sensing elements are Hall element and charging element, wherein the charging element comprises a charging structure and a power receiving structure; the speaker body 310 is correspondingly provided with a charging structure, and the microphone 200 is correspondingly provided with a power receiving structure. In addition, the magnetic components may be arranged on the speaker body 310 and the microphone 200.

The magnetic components are arranged outside the sensing trigger range of the Hall element and are used to fix the microphone 200 rather than trigger the Hall element. A hollow placement layer 1112 is formed between the bottom of the rotating component 115 and the bottom of the seat body 111 and is designed to place electronic components. A hollow placement layer 1112 is formed between the bottom of the rotating component 115 and the bottom of the seat body 111. A first wireless charging assembly is laid in the placement layer 1112, and a second wireless charging assembly matched with the first wireless charging assembly is arranged at the bottom of the microphone 200. By arranging the first wireless charging assembly in the placement layer 1112 formed between the bottom of the rotating component 115 and the bottom of the seat body 111, and matching the second wireless charging assembly at the bottom of the microphone 200, the wireless charging function of the microphone 200 is realized. Such design enables automatic charging of the microphone 200 in the storage state without requiring the user to manually connect a charging cable, providing great convenience. Since the microphone 200 can be charged while being stored, the user does not need to worry about insufficient battery power of the microphone 200, ensuring sufficient power each time the microphone 200 is taken out for immediate use, thereby improving the ease of use. Furthermore, the wireless charging assembly is integrated into the microphone storage assembly 100 of the smart microphone 200, making the overall design of the smart speaker more compact and integrated, and enhancing the overall aesthetic appearance of the product and the user experience.

Reinforcing ribs 1151 are arranged on the rotating component 115. As shown in FIG. 43, the rotating component 115 is provided with elongated protruding reinforcing ribs 1151. When the motor drives the rotating component 115, a torque is applied to the rotating component 115. For example, if the motor applies a clockwise torque to the lower end of the rotating component 115, the lifting component 114 will apply a counterclockwise torque to the upper end of the rotating component 115. Under the combined action of the two torques, the rotating component 115 is prone to damage if its strength is insufficient. The design of the reinforcing ribs 1151 can significantly improve the overall strength and rigidity of the rotating component 115. By adding additional textures or concave-convex structures on the material surface, the torque generated by the motor can be effectively dispersed and borne, thereby reducing the risk of damage caused by stress concentration. Specifically, the reinforcing ribs 1151 can also be spiral, grid-like, wavy, and so on.

As shown in FIG. 45 to FIG. 53, the embodiment of the invention provides a microphone storage structure, comprising a housing 311, a lifting assembly 1131, a microphone 200 and at least one storage groove 121 for accommodating the microphone 200; an opening connected to the outer wall of the housing 311 is arranged at one end of the storage groove 121; the lifting assembly 1131 is arranged at the end of the storage groove 121 away from the opening; the lifting assembly 1131 is connected to the microphone 200 to drive the microphone 200 to reciprocate between a first position and a second position in the storage groove 121. It should be noted that the lifting assembly 1131 can be arranged inside or outside the storage groove 121, as long as the microphone body 4 can be driven to reciprocate. Furthermore, the storage groove 121 can be integrated with the housing 311, or the storage groove 121 can be integrated with the lifting assembly 1131 to reduce installation difficulty.

In addition, the first position of the storage groove 121 in this embodiment may specifically be the opening, and the second position may be any position inside the storage groove 121. When the microphone 200 is at the first position, one end of the microphone 200 extends 20-25 mm beyond the opening, allowing the user to take out the microphone more conveniently.

When the microphone 200 is at the second position, the microphone 200 is stored inside the storage groove 121.

In the microphone storage structure of this embodiment, when the user needs to use the microphone, the lifting assembly 1131 can be controlled to drive the microphone 200 to automatically extend out of the opening of the storage groove 121, and the user can directly take out and use the microphone 200. When not needing to use the microphone, the user directly inserts the microphone into the storage groove 121, and then the lifting assembly 1131 drives the microphone 200 to automatically fall and be stored in the storage groove 121. Through the above design, the user can pick and place the microphone 200 simply and directly, which greatly reduces the picking and placing difficulty, effectively improves the picking and placing efficiency, and brings a good user experience.

Further, as shown in FIG. 45, in this embodiment, a plurality of storage grooves 121 are provided, and the lifting assembly 1131 is arranged at the end of each storage groove 121 away from the opening. It should be noted that the numbers of the storage grooves 121, microphones 200 and lifting assemblies 1131 in this embodiment corresponds one to one, and the lifting of each microphone 200 can be independently controlled, thereby improving the use flexibility of the microphone body 4. In some cases, when multiple microphones 200 are raised and one of them is removed, the lifting assembly 1131 of the removed microphone 200 remains in the raised position to wait for the microphone to be put back. The other microphones 200 that have not been removed are lowered to prevent the raised microphones 200 from protruding externally and causing an unsightly appearance. In the case of a screen-equipped speaker, such protrusion may also interfere with the user's viewing of the screen. In addition, the number of storage grooves 121 is not limited in this embodiment. The designer can design a corresponding number of storage grooves 121 according to the number of microphones 200 of the electronic device.

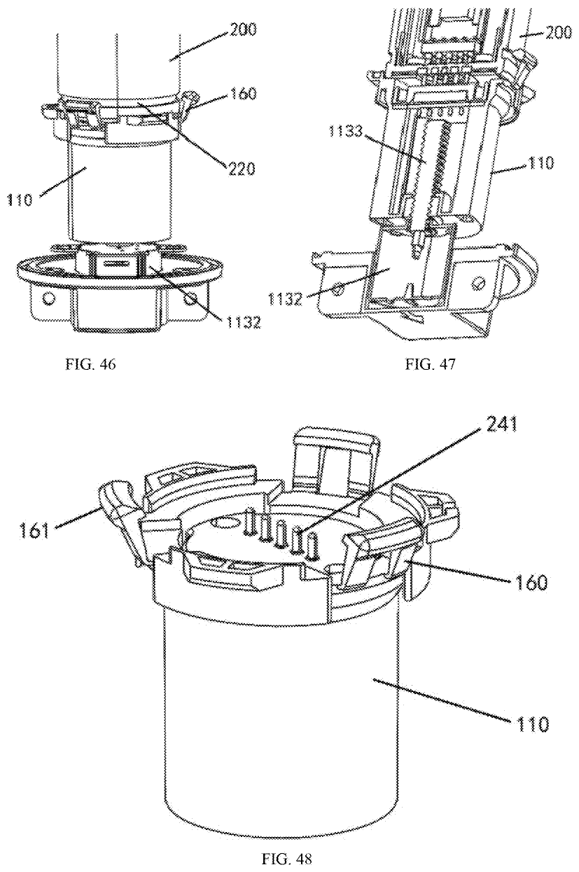

Further, as shown in FIG. 46 and FIG. 47, in this embodiment, the lifting assembly 1131 is installed inside the housing 311; the lifting assembly 1131 comprises a lifting motor 1132, a fixing seat 110 and a lead screw 1133 connected with the output shaft of the lifting motor 1132; a threaded hole is formed at the bottom of the fixing seat 110, and the lead screw 1133 is in threaded connection with the threaded hole; when the lifting motor 1132 drives the lead screw 1133 to rotate, the lead screw 1133 drives the fixing seat 110 to move; the microphone 200 is detachably connected to the fixing seat 110. It should be noted that when the fixing seat 110 is driven to move, it drives the microphone 200 to reciprocate between the first position and the second position of the storage groove 121.

Further, as shown in FIG. 45, in this embodiment, the microphone storage structure further comprises a limit seat 1134; the limit seat 1134 is arranged inside the housing 311, the fixing seat 110 is movably arranged in the limit seat 1134, and the lead screw passes through the limit seat 1134 and is in threaded connection with the threaded hole of the fixing seat 110. It should be noted that the limit seat 1134 in this embodiment mainly provides guidance for the fixing seat 110 and restricts its movement direction, preventing it from being displaced in other directions under external forces, which otherwise affects the movement direction of the microphone 200.

Further, as shown in FIG. 45, FIG. 48 and FIG. 50, in this embodiment, the microphone storage structure further comprises a sleeve 1135 movably sleeved on the fixing seat 110; the sleeve 1135 is fixedly connected to the limit seat 1134; an elastic clamping jaw 160 is arranged on the fixing seat 110; a limit groove 220 used with the clamping jaw 160 is formed on the outer wall of the microphone 200; a guide inclined surface 1136 is arranged on the inner wall of the sleeve 1135; an abutting surface 161 used with the guide inclined surface 1136 is arranged on the outer side of the clamping jaw 160. It should be noted that when the microphone 200 is stored in the storage groove 121, the bottom of the guide inclined surface 1136 abuts against the abutting surface 161, so that the clamping jaw 160 is clamped into the limit groove 220, thereby fixing the microphone 200 on the fixing seat 110. Through the above design, the microphone 200 can be prevented from being separated from the fixing seat 110 when stored in the storage groove 121, which otherwise cause the microphone 200 to fail to lift. When the fixing seat 110 is driven to move upward so that the microphone 200 rises along the storage groove 121, the abutting surface 161 slides towards the guide inclined surface 1136. After the abutting surface 161 slides away from the guide inclined surface 1136, the clamping jaw 160 is separated from the limit groove 220 under the action of elastic force. It should be noted that in the above design, when the microphone 200 rises to expose the opening of the storage groove 121, the clamping jaw 160 is disengaged from the limit groove 220, and the microphone 200 is in a detachable state relative to the fixing seat 110, allowing the user to directly take the microphone 200 away. In addition, it should be noted that a plurality of clamping jaws 160 may be arranged in this embodiment. In this embodiment, the number of clamping jaws 160 is specifically three. The clamping jaws 160 in this embodiment are specifically elastic clamping jaws. The limit grooves 220 of the microphone 200 in this embodiment may be annular limit grooves 220 arranged around the microphone 200 or single limit grooves 220 corresponding to the positions of the elastic clamping jaws.

This embodiment imposes no restrictions thereon, and the designers may select limit grooves 220 of an appropriate structure according to actual requirements.

Further, in one specific embodiment, on the basis that the clamping jaws 160 are engaged with the limit grooves 220, a first magnetic attraction portion may be arranged on the outer wall of the microphone 200 in this embodiment, and a second magnetic attraction portion matched with the first magnetic attraction portion may be arranged on the fixing seat 110. The first magnetic attraction portion and the second magnetic attraction portion attract each other to fix the microphone 200 on the fixing seat 110.

It should be noted that the above design enables the microphone 200 to be more firmly fixed on the fixing seat 110.

In addition, in another specific embodiment, to reduce structural complexity, the clamping jaws 160 and the limit grooves 220 may be eliminated. In this embodiment, the microphone 200 and the fixing seat 110 are directly fixed by attraction between the first magnetic attraction portion and the second magnetic attraction portion.

Further, in order to realize the charging function when the microphone is stored in the storage groove, the microphone storage structure in this embodiment further comprises a charging assembly for charging the microphone 200; the charging assembly comprises a first charging portion arranged on the microphone 200 and a second charging portion arranged on the fixing seat 110; the first charging portion is electrically connected to the second charging portion to charge the microphone 200.

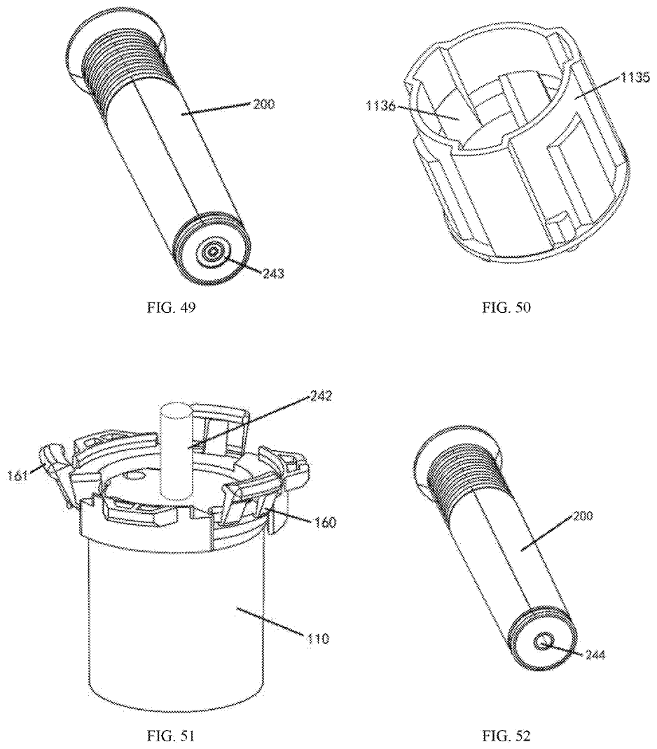

As shown in FIG. 48 and FIG. 49, in the first specific embodiment, the first charging portion is embodied as a charging ring 243 at the bottom of the microphone 200, and the second charging portion is embodied as a charging pin 241 on the fixing seat 110. The charging pin 241 abuts against the charging ring 243 to charge the microphone 200. It should be noted that, in this specific embodiment, to achieve more stable abutment between the charging pin 241 and the charging ring 243, the charging assembly needs to be used in conjunction with the clamping jaws 160 and the limit grooves 220.

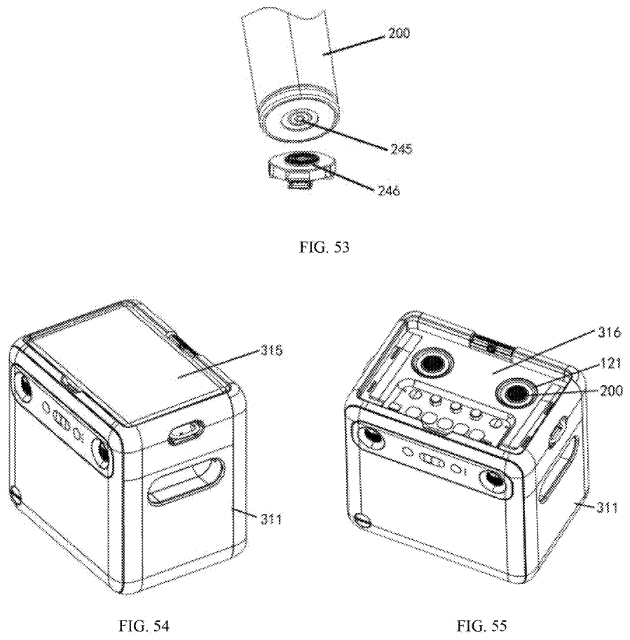

In the second specific embodiment, as shown in FIG. 53, the first charging portion is embodied as a power receiving coil 245 at the bottom of the microphone 200, and the second charging portion is embodied as a charging coil 246 on the fixing seat 110.

The charging coil 246 is arranged opposite to the power receiving coil 245 to charge the microphone 200. It should be noted that, in this specific embodiment, to ensure a more stable relative position between the charging coil 246 and the power receiving coil 245, the charging assembly needs to be used with the clamping jaws 160 and the limit grooves 220.

In the third specific embodiment, as shown in FIG. 51 and FIG. 52, the first charging portion is embodied as a charging socket 244 at the bottom of the microphone body, and the second charging portion is embodied as a charging male connector 242 on the fixing seat 110; the charging male connector 242 is inserted into the charging socket 244 to charge the microphone 200.

It should be noted that, in this specific embodiment, since the charging male connector 242 and the charging female connector inherently provide a locking function to fix the microphone 200 to the fixing seat 110, the charging assembly does not need to be used with the clamping jaws 160 and the limit grooves 220.

Further, the microphone storage structure in this embodiment further comprises a sealing gasket 247; the sealing gasket 247 is arranged between the sleeve 1135 and the limit seat 1134. It should be noted that a certain assembly gap will be formed between the sleeve 1135 and the limit seat 1134 after assembly. Therefore, with the above design, the sealing gasket 247 can fill the assembly gap, making the connection between the sleeve 1135 and the limit seat 1134 tighter, and effectively preventing dust, water vapor, etc. from entering the assembly gap and affecting the performance of components.

As shown in FIG. 45 to FIG. 55, the embodiment of the invention provides an electronic device comprises a speaker, a screen 315, a control circuit board and the microphone storage structure; the speaker is installed inside the housing 311 of the microphone storage structure, and the screen 315 is hinged to the housing 311; a placement slot 316 for accommodating the screen 315 is provided on the outer wall of the housing 311 and is recessed toward the interior of the housing 311; when rotating to a preset angle relative to the housing 311, the screen 315 is stored in the placement slot 316 and is flush with the outer wall of the housing 311; the control circuit board is installed inside the housing 311, and the speaker, the screen 315 and the lifting assembly 1131 of the microphone storage structure are all electrically connected to the control circuit board; a communication module is also electrically connected to the control circuit board, and the microphone 200 of the microphone storage structure is wirelessly connected to the control circuit board through the communication module. It should be noted that the electronic device in this embodiment is specifically a speaker. The microphone 200 is communicatively connected to the control circuit board via a communication module, so that the user's voice signal can be processed by the control circuit board and then output through the loudspeaker.

In addition, in the electronic device of this embodiment, when two or more microphones 200 are arranged, the user can control the synchronous lifting or individual lifting of the two or more microphones 200 according to selection. The above process can be realized mainly by programming the control circuit board, which is achievable for a person skilled in the art, and thus will not be described in detail in this embodiment.

Further, the screen 315 in this embodiment can be opened either electrically or manually, which is not limited in this embodiment, and the designers can design it according to actual needs. In addition, the screen 315 can be linked with the lifting assembly 1131 via the control circuit board. In other words, when the screen 315 is opened, the lifting assembly 1131 synchronously drives the microphone 200 to rise. The above implementation is also achievable for a person skilled in the art and will not be described in detail in this embodiment. Further, the speaker may be provided with the microphone storage structure as described in the foregoing embodiments. The microphone storage structure may be a cavity for accommodating and storing the microphone 200, such as the storage groove 121 in this embodiment, wherein the microphone 200 is stored in an insertion manner. The depth of the storage groove 121 is greater than or equal to the length of the microphone 200. The microphone 200 is inserted into the storage groove 121 vertically or horizontally along its length through the opening of the storage groove 121 to achieve storage. A microphone fixing structure may be arranged inside or outside the opening to fix the microphone after storage, such as the fixing seat 110 in this embodiment. The opening of the storage groove 121 may be arranged at any position of the speaker, including the outer wall surfaces of the speaker housing 311, such as the upper, lower, left, and right outer wall surfaces.

In some embodiments, the speaker housing 311 may be connected to the screen 315 via a movable structure, such as the hinged manner mentioned in this embodiment. In addition, the speaker housing 311 may be provided with a screen placement slot 316, in which the screen 315 is stored when closed. The placement slot 316 may be arranged below the screen 315, and the opening of the storage groove 121 may be arranged on the top surface of the placement slot 316. With such a design, when the screen 315 is closed, the microphone 200 is completely covered by the screen 315 and fully stored inside the speaker housing 311. Further, when the microphone 200 remains connected to the electronic device such as the speaker, howling occurs if it is too close to the speaker, producing harsh sound that severely affects user experience. Especially when the microphone 200 is stored into the speaker, the probability of howling triggered by impact and friction noises between the microphone 200 and the speaker is even higher. The microphone 200 can be automatically powered off when stored into the storage groove 121, preventing howling when the microphone 200 approaches the speaker or during the storage of the microphone 200 into the speaker.

In some embodiments, the microphone 200 is automatically turned off by detecting the distance between the speaker and the microphone 200 via the sensing element. When the detected distance between the speaker and the microphone 200 is less than or equal to a preset distance, the microphone 200 is automatically powered off. One or more sensing elements may be distributed, which may be Hall element, distance sensor, infrared sensor, any other individual electronic component capable of sensing the distance between the speaker and the microphone 200, or any combination of the electronic components. The sensing element may be arranged on the speaker and/or the microphone 200. Specifically, when the microphone 200 is inserted into the storage groove 121, the sensing element may be arranged at the opening of the storage groove 121, so that the microphone 200 is powered off immediately upon being inserted into the opening.

The sensing element may also be arranged at one end of the storage groove 121 away from the opening to prevent aging of the sensing element caused by exposure to the outside due to the opening facing outward.

In one specific embodiment, the sensing element is a Hall element; the speaker storage structure and the microphone 200 have corresponding positions; the magnetic component is arranged at the corresponding position of the microphone 200, and the Hall element is arranged at the corresponding position of the speaker; alternatively, the Hall element is arranged at the corresponding position of the microphone 200, and the magnetic component is arranged at the corresponding position of the speaker. In some embodiments, the triggering condition of the Hall element may be that the detected magnetic field intensity reaches a preset value. When the detected magnetic field intensity is greater than or equal to the preset value, it indicates that the distance between the speaker and the microphone 200 may trigger howling, and the microphone 200 needs to be powered off. Preferably, the magnetic component is arranged at the corresponding position of the microphone 200, and the Hall element is arranged at the corresponding position of the speaker. Given that the microphone 200 is moved around freely during karaoke sessions, the microphone 200 may be moved to the areas with strong external magnetic fields. The Hall element arranged on the microphone 200 may trigger accidental power-off of the microphone 200, thereby adversely affecting the experience. When the microphone 200 is inserted into the storage groove 121, the Hall element is arranged at the opening of the storage groove 121 of the speaker housing 311 or at one end away from the opening.

In another specific embodiment, the sensing element is a Hall element; the speaker is correspondingly provided with a charging structure, and the microphone 200 is correspondingly provided with a power receiving structure. The triggering condition of the Hall element may be a magnetic field change caused at the moment of power-on when the microphone 200 is charged. When a magnetic field change is detected, it indicates that the distance between the speaker and the microphone 200 is sufficient to cause howling, and the microphone 200 needs to be powered off. The charging structure may be arranged on the surface of the speaker or corresponding to the storage groove 121. The microphone 200 may be stored in an insertion manner. The charging structure is arranged at one end of the storage groove 121 of the speaker housing 311 that is away from the opening, and a power receiving structure is correspondingly arranged at the bottom or one end bottom surface of the microphone 200. The Hall element is arranged near the charging structure, and the Hall element can sense the magnetic field change caused at the moment of power-on.

In the microphone storage structure of the electronic device according to this embodiment, when the user needs to use the microphone, the lifting assembly 1131 can be controlled to drive the microphone 200 to automatically extend out of the opening of the storage groove 121, allowing the user to directly take out and use the microphone 200. When not needing to use the microphone, the user directly inserts the microphone into the storage groove 121, and then the lifting assembly 1131 drives the microphone 200 to automatically fall and be stored in the storage groove 121. Through the above design, the user can pick and place the microphone 200 simply and directly, which greatly reduces the picking and placing difficulty, effectively improves the picking and placing efficiency, and brings a good user experience.

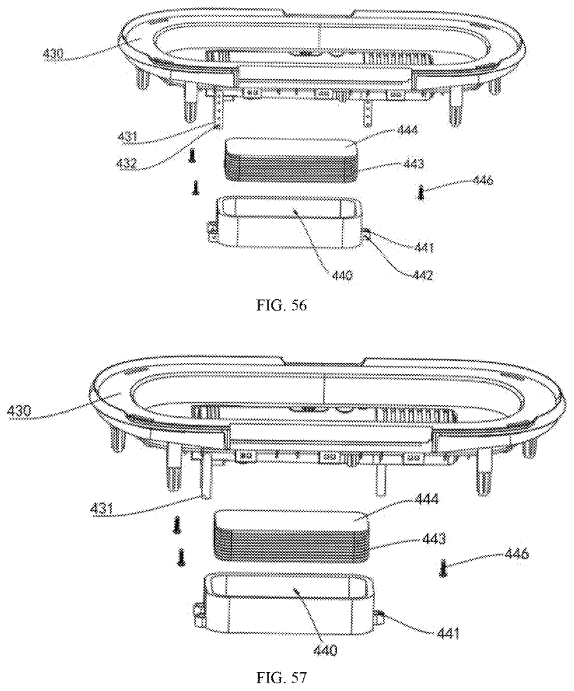

As shown in FIG. 56 and FIG. 57, a smart acoustic device comprises a box 410, a microphone placement mechanism 430, an electromagnet 444 and a solenoid coil 443; the microphone placement mechanism 430 is arranged in the box 410; the electromagnet 444 is arranged on the microphone placement mechanism 430, and the solenoid coil 443 is wound around the electromagnet 444; the microphone placement mechanism 430 comprises a placement groove 4301; the placement groove 4301 extends toward the bottom of the box 410 to form an accommodating groove 4302 for accommodating the microphone 420; the microphone 420 is provided with a first magnet (not shown). When the microphone 420 is limited in the accommodating groove 4302, the electromagnet 444 and the first magnet are fixed by magnetic attraction; when the solenoid coil 443 is energized, the solenoid coil 443 and the electromagnet 444 generate a magnetic force that drives the microphone 420 to move away from the electromagnet, so that the microphone 420 is partially disengaged from the accommodating groove 4302 or completely separated from the accommodating groove 4302 and enters the placement groove 4301.

It should be noted that the microphone 420 is placed in the accommodating groove 4302 of the microphone placement mechanism 430 when not in use. At this time, the first magnet on the microphone 420 and the electromagnet 444 in the microphone placement mechanism 430 magnetically attract each other to achieve stable fixation of the microphone 420. When the microphone 420 needs to be used, the solenoid coil 443 is energized. The energized solenoid coil 443 generates a magnetic field around the electromagnet 444, which interacts with the inherent magnetic field of the electromagnet 444 to produce a force pushing the microphone 420 away from the electromagnet 444. Under the action of the magnetic force, the microphone 420 is gradually disengaged partially or completely from the accommodating groove 4302 and finally enters the placement groove 4301, allowing the user to conveniently take out the microphone 420 for use. Compared with the prior art, the user does not need to manually overcome the attractive force between the first magnetic attraction component and the second magnetic attraction component when taking the microphone 420, which greatly improves the convenience of taking the microphone 420.

Specifically, the microphone 420 fits fully with the accommodating groove 4302 when stored in the accommodating groove 4302, which is in a fully retracted state. When the microphone 420 does not fit fully with the accommodating groove 4302, it is in an incompletely retracted state. It should be understood that partial disengagement of the microphone 420 from the accommodating groove 4302 constitutes an incompletely retracted state.

Specifically, when the solenoid coil 443 is energized and jointly generates a magnetic force with the electromagnet 444 to push the microphone 420, the microphone 420 moves upward along the side wall of the accommodating groove 4302 under the magnetic force. At this time, a gap is formed between the microphone 420 and the accommodating groove 4302, indicating partial disengagement. In the partially disengaged state, the microphone 420 partially enters the placement groove 4301, allowing the user to conveniently take the microphone 420.

Further, sufficiently strong magnetic force can push the microphone 420 to disengage completely from the accommodating groove 4302 and enter the placement groove 4301, which is defined as the fully disengaged state. At this time, the large space of the placement groove 4301 provides ample room for the user to take the microphone 420 conveniently. Therefore, whether the microphone 420 is partially or completely disengaged from the accommodating groove 4302, the effect of convenient access for the user can be achieved.

Specifically, as shown in FIG. 56, the smart acoustic device further comprises a mounting groove 440 detachably connected to the microphone placement mechanism 430. The electromagnet 444 and the solenoid coil 443 are both arranged in the mounting groove 440. To limit the electromagnet 444 and the solenoid coil 443 to the microphone placement mechanism 430, it is only necessary to place the electromagnet 444 and the solenoid coil 443 into the mounting groove 440, and then lock the mounting groove 440 onto the microphone placement mechanism 430. To replace the electromagnet 444 and the solenoid coil 443, it is only necessary to detach the mounting groove 440 from the microphone placement mechanism 430. Of course, it should be noted that in practical applications, the mounting groove 440 may also be integrally formed with the microphone placement mechanism 430. In such a case, the connection between the mounting groove 440 and the microphone placement mechanism 430 is firmer, which enhances the structural stability of the entire smart acoustic device.

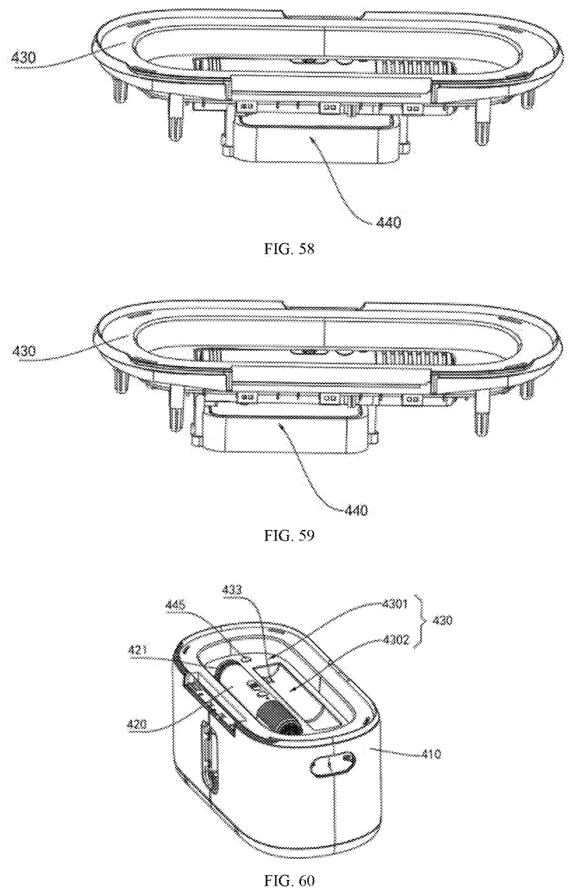

Specifically, as shown in FIG. 58 and FIG. 59, the mounting groove 440 is connected to the middle or one side of the accommodating groove 4302. When the mounting groove 440 is located at the middle of the accommodating groove 4302, the electromagnet 444 and the solenoid coil 443 can push the microphone 420 upward uniformly. Once the microphone 420 enters the placement groove 4301, the user can take out the microphone 420. When the mounting groove 440 is located at one side of the accommodating groove 4302, the microphone 420 is pushed upward in a single side manner. The microphone 420 tilts slightly during rising, and the user can take out the microphone 420 as soon as one end of the microphone 420 enters the placement groove 4301, bringing great convenience for the user to access the microphone 420.

Specifically, as shown in FIG. 57, the smart intelligent acoustic device further comprises a connecting post 431 and a connecting piece 446; the connecting post 431 is connected to the microphone placement mechanism 430; the mounting groove 440 is provided with a connecting hole 441, and the connecting post 431 passes through the connecting hole 441; a first end of the connecting piece 446 is threadedly connected to the connecting post 431, and the mounting groove 440 is arranged between the microphone placement mechanism 430 and a second end of the connecting piece 446. It should be noted that the connecting piece 446 in this invention is a bolt, and a threaded hole is formed on the connecting post 431. The cross-sectional area of the second end of the connecting piece 446 is larger than the diameter of the connecting hole 441. To lock the mounting groove 440 to the microphone placement mechanism 430, the connecting post 431 is inserted through the connecting hole 441 of the mounting groove 440, and then the connecting piece 446 is fastened to the threaded hole of the connecting post 431. To replace the electromagnet 444 or the solenoid coil 443, the connecting piece 446 only needs to be detached from the connecting post 431, which is very convenient. Of course, as shown in FIG. 56, in practical applications, in order to adjust the distance between the mounting groove 440 and the microphone placement mechanism 430, the smart acoustic device may also be configured to comprise a connecting post 431 and a connecting piece 446; the connecting post 431 is provided with a plurality of first limit holes 432; the mounting groove 440 is provided with a connecting hole 441 and a second limit hole 442 connected with the connecting hole 441. During installation, the mounting groove 440 can slide along the connecting post 431.

After the user slides the mounting groove 440 to a proper height, the connecting piece 446 (such as a screw, a pin, etc.) can pass through the second limit hole 442 and the corresponding first limit hole 432 to lock the mounting groove 440 at a specific height of the connecting post 431, which is very convenient.

Specifically, the smart acoustic device further comprises an elastic layer (not shown), which is connected to the wall of the accommodating groove 4302. In other words, the elastic layer is arranged on the wall of the accommodating groove 4302 by means of adhesive bonding, clamping, insertion, or the like. The elastic layer may fully cover the accommodating groove 4302, or partially cover the interior of the accommodating groove 4302. The elastic layer of the invention is made of rubber, silicone or sponge. When the smart acoustic device is subjected to external impact or vibration, the elastic layer can absorb such impacts and reduce damage to the microphone 420.

Specifically, the microphone 420 is a square microphone 420. The first side wall of the microphone 420 abuts against the bottom of the accommodating groove 4302 and is connected to the first magnet. When the solenoid coil 443 is not energized, the first side wall of the square microphone 420 abuts the bottom of the accommodating groove 4302. The first magnet connected to the first side wall attracts the electromagnet 444, providing excellent stability and ensuring that the microphone 420 remains fixed inside the smart acoustic device without shifting or rotating under external vibration or impact. When the solenoid coil 443 is energized, the square microphone 420 is less likely to rotate under the magnetic force, thereby maintaining sound quality stability. It should be noted that in practical applications, the microphone 420 may also be a circular microphone 420.

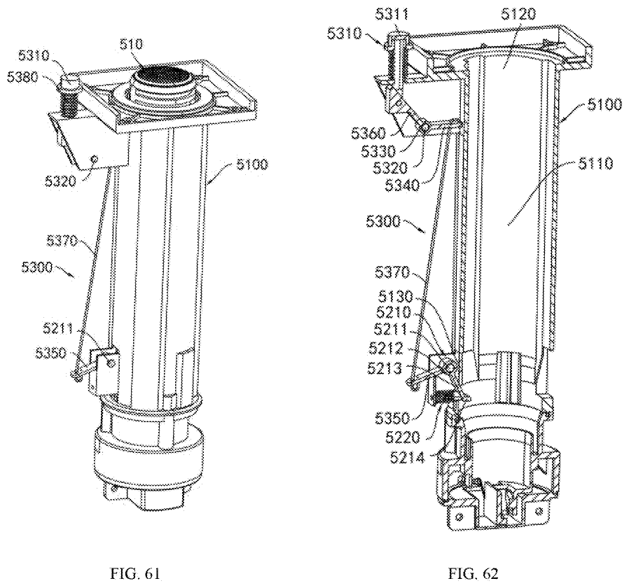

Specifically, as shown in FIG. 60, the smart acoustic device further comprises a circuit assembly arranged inside the box 410. The circuit assembly is electrically connected to the solenoid coil 443 and configured to switch the solenoid coil 443 between a power-up state and a power-off state, or vice versa. Specifically, the circuit assembly comprises a power supply and a switch 445; the power supply is connected to the solenoid coil 443, and the switch 445 is used to control the on/off state of the connection between the power supply and the solenoid coil 443. The power supply is arranged in the smart acoustic device as needed in actual use. It should be noted that the circuit assembly belongs to the prior art, and a person skilled in the art should understand how to switch the solenoid coil 443 between the power-up state and the power-off state via the circuit assembly. For example, how to configure a power supply capable of providing appropriate power to drive the solenoid coil 443 to disengage the microphone 420 from the accommodating groove 4302. The application imposes no specific limitation or elaboration thereon. The power supply is designed to provide the required electric energy to the solenoid coil 443; the switch 445 serves as a connection between the power supply and the solenoid coil 443. By controlling the on/off state of the switch 445, the power-on or power-off of the solenoid coil 443 can be regulated. When the switch 445 is in a closed state, the power supply and the solenoid coil 443 form a closed circuit, and the solenoid coil 443 is powered on. When the switch 445 is open, the circuit is disconnected, and the solenoid coil 443 is powered off.

Specifically, the smart acoustic device further comprises a power supply contact 433. The microphone 420 is provided with a charging piece 421, and the power supply contact 433 is electrically connected to the power supply and the charging piece 421. Specifically, the power supply contact 433 is electrically connected to the power supply. When the microphone 420 is limited in the accommodating groove 4302, the power supply contact 433 is electrically connected to the charging piece 421 on the microphone 420. The current can be transmitted from the power supply to the charging piece 421 through the power supply contact 433. The charging piece 421 on the microphone 420 receives electric energy from the power supply and converts it into chemical energy to be stored in the battery of the microphone 420. Users can charge the microphone 420 without additional chargers or cables, which not only simplifies the charging process but also reduces inconvenience during use.

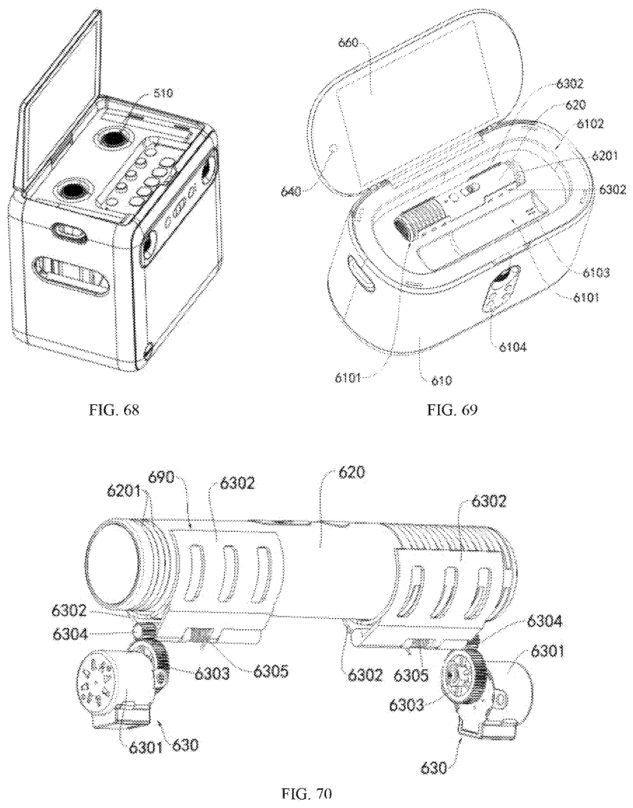

The smart microphone accommodating assembly and the smart device according to the invention will be described below with reference to FIG. 61 to FIG. 68.

According to the embodiment of the utility model in the first aspect, the smart microphone accommodating assembly comprises a cylinder 5100, a limit component 5210, a first adjusting component 5220, and a second adjusting component 5300; the cylinder 5100 is provided with an accommodating cavity 5110 and an opening 5120; the opening 5120 is arranged at one end of the cylinder 5100 and connected with the accommodating cavity 5110; the limit component 5210 has a limit end 5214; the limit end 5214 of the limit component 5210 has a first state and a second state; when the limit end 5214 of the limit member 5210 is in the first state, the limit end 5214 of the limit component 5210 can be engaged with and lock the microphone 510 in the accommodating cavity 5110; when the limit end 5214 of the limit component 5210 is in the second state, the limit end 5214 of the limit component 5210 can be disengaged from and unlock the microphone 510 in the accommodating cavity 5110; the first adjusting component 5220 is connected to the limit component 5210 and can switch the limit end 5214 of the limit component 5210 from the second state to the first state; the second adjusting component 5300 is connected to the limit component 5210 and can switch the limit end 5214 of the limit component 5210 from the first state to the second state.

In an embodiment of the invention, the microphone 510 can be inserted into the accommodating cavity 5110 through the opening 5120. After the microphone 510 is placed into the accommodating cavity 5110, the first adjusting component 5220 can switch the limit end 5214 of the limit component 5210 from the second state to the first state, so that the limit end 5214 of the limit component 5210 can be engaged with and lock the microphone 510 in the accommodating cavity 5110, thereby limiting the position of the microphone 510 in the accommodating cavity 5110, improving the stability of the microphone 510 in the accommodating cavity 5110, and reducing the vertical bouncing of the microphone 510 in the accommodating cavity 5110. When the microphone 510 needs to be taken out, the second adjusting component 5300 can switch the limit end 5214 of the limit component 5210 from the first state to the second state, so that the limit end 5214 of the limit component 5210 can be disengaged from and unlock the microphone 510 in the accommodating cavity 5110, facilitating the user to take out the microphone 510 from the cylinder 5100.

As shown in FIG. 61 to FIG. 63, it can be understood that the cylinder 5100 is provided with a passage opening 5130; the first adjusting component 5220 is connected to the limit component 5210 and can drive the limit end 5214 of the limit component 5210 to extend into the accommodating cavity 5110 from the passage opening 5130 to be engaged with the microphone 510; after being driven, the second adjusting component 5300 can drive the limit end 5214 of the limit component 5210 to extend out of the accommodating cavity 5110 from the passage opening 5130. In an embodiment of the invention, after being driven, the second adjusting component 5300 can drive the limit component 5210 to extend out of the accommodating cavity 5110 from the passage opening 5130. The microphone 510 can be inserted into the accommodating cavity 5110 through the opening 5120. After stopping driving the second adjusting component 5300, the first adjusting component 5220 can drive the limit end 5214 of the limit component 5210 to extend into the accommodating cavity 5110 from the passage opening 5130, so that the limit end 5214 of the limit component 5210 can be engaged with the microphone 510, thereby limiting the position of the microphone 510 in the accommodating cavity 5110. When the microphone 510 needs to be taken out from the accommodating cavity 5110, the second adjusting component 5300 can be driven to drive the limit component 5210 to extend out of the accommodating cavity 5110 from the passage opening 5130, so that the limit end 5214 of the limit component 5210 is disengaged from the microphone 510.

The smart microphone accommodating assembly can drive the limit end 5214 of the limit component 5210 to extend into the accommodating cavity 5110 from the through opening 5130 via the first adjusting component 5220, so that the limit end 5214 of the limit component 5210 can be continuously engaged with the microphone 510, thereby limiting the position of the microphone 510 in the accommodating cavity 5110, improving the stability of the microphone 510 in the accommodating cavity 5110, and reducing the vertical bouncing of the microphone 510 in the accommodating cavity 5110.

Specifically, after the first adjusting component 5220 drives the limit end 5214 of the limit component 5210 to extend into the accommodating cavity 5110 through the passage opening 5130, the limit end 5214 of the limit component 5210 is in the first state. After the second adjusting component 5300 drives the limit end 5214 of the limit component 5210 to extend out of the accommodating cavity 5110 through the passage opening 5130, the limit end 5214 of the limit component 5210 is in the second state.

Specifically, the first adjusting component 5220 may be a motor structure. The motor structure is connected to the limit end 5214 of the limit component 5210 and can drive the limit end 5214 of the limit component 5210 to switch back and forth between the first state and the second state.

Specifically, the limit component 5210 may be fixedly connected or detachably connected to the cylinder 5100, or may be detachably connected and fixed in the speaker structure. When the limit end 5214 of the limit component 5210 is in the first state or the second state, the limit end 5214 of the limit component 5210 may be located inside or outside the cylinder 5100. When the microphone 510 needs to be locked, it is sufficient that the limit end 5214 of the limit component 5210 partially extends into the cylinder 5100.

As shown in FIG. 61 to FIG. 63, it can be understood that the limit component 5210 comprises a first rotating shaft 5211, a first rotating part 5212 and a limit piece 5213; the first rotating shaft 5211 is connected to the cylinder 5100, and the first rotating part 5212 is rotatably sleeved over the first rotating shaft 5211; the limit piece 5213 is connected to the first rotating part 5212, and the other end of the limit piece 5213 is the limit end 5214 of the limit component 5210; the second adjusting component 5300 is connected to the first rotating part 5212 and is capable of driving the first rotating part 5212 to rotate; rotation of the first rotating member 5212 enables the other end of the limit piece 5213 to extend into or out of the accommodating cavity 5110. The first rotating shaft 5211 can limit the rotation direction of the first rotating part 5212. One end of the limit piece 5213 is connected to a portion of the first rotating part 5212 away from the rotation axis, so that the limit piece 5213 can also rotate along with the first rotating part 5212 after the first rotating part 5212 rotates. The other end of the limit piece 5213 is the limit end 5214 of the limit component 5210. Rotation of the first rotating part 5212 can drive the limit end 5214 of the limit component 5210 to rotate accordingly. The first rotating part 5212 is rotated to make the other end of the limit piece 5213 extend into the accommodating cavity 5110, so that the other end of the limit piece 5213 is engaged with the microphone 510. The first rotating part 5212 is rotated to make the other end of the limit piece 5213 extend out of the accommodating cavity 5110, so that the other end of the limit piece 5213 disengages from the microphone 510. The second adjusting component 5300 controls the position of the limit piece 5213 by driving the first rotating part 5212 to rotate.

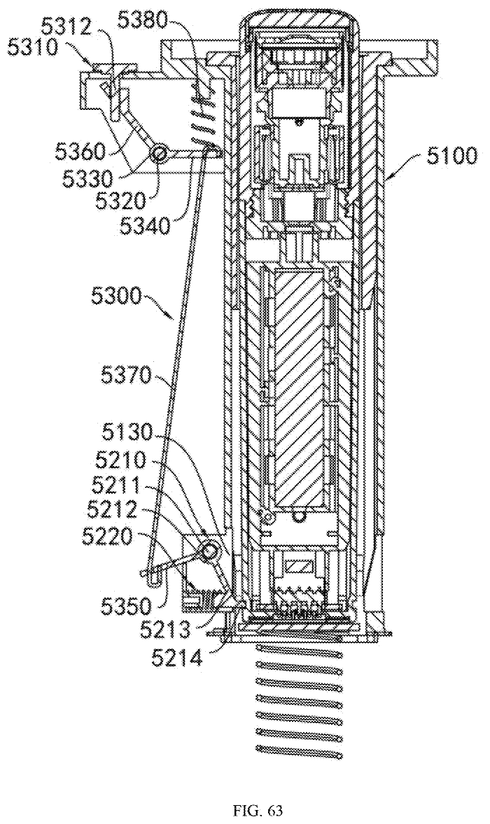

As shown in FIG. 63, it can be understood that the first adjusting component 5220 is a first elastic element; two ends of the first elastic element are respectively connected to the cylinder 5100 and the limit piece 5213; the first elastic element provides an elastic restoring force that pushes the limit end 5214 of the limit piece 5213 to move toward and extend into the accommodating cavity 5110. The first adjusting component 5220 is configured to continuously push the limit end 5214 of the limit piece 5213 to extend into the accommodating cavity 5110, so that the limit piece 5213 can be constantly engaged with the microphone 510. When the second adjusting component 5300 is driven to move the limit piece 5213 out of the accommodating cavity 5110 through the passage opening 5130, the first elastic element is compressed. After the actuation of the second adjusting component 5300 is stopped, the first adjusting component 5220 can push the limit piece 5213 to extend into the accommodating cavity 5110 through the passage opening 5130.

As shown in FIG. 62 and FIG. 63, it can be understood that the second adjusting component 5300 comprises an adjusting piece 5310, a second rotating shaft 5320, a second rotating part 5330, a first connecting rod 5340, a second connecting rod 5350, a third connecting rod 5360 and a transmission rod 5370; the second rotating shaft 5320 is connected to the cylinder 5100, and the second rotating part 5330 is rotatably sleeved over the second rotating shaft 5320; the rotation axis of the second rotating part 5330 is arranged parallel to the rotation axis of the first rotating part 5212; the first connecting rod 5340 is connected to the first rotating part 5212, and the second connecting rod 5350 is connected to the second rotating part 5330; two ends of the transmission rod 5370 are respectively connected to the first connecting rod 5340 and the second connecting rod 5350; two ends of the third connecting rod 5360 are respectively connected to the adjusting piece 5310 and the second rotating part 5330; the adjusting piece 5310 is moved to rotate the second rotating part 5330 and the first rotating part 5212. The rotation axis of the second rotating part 5330 is arranged parallel to the rotation axis of the first rotating part 5212, such that movement of the adjusting piece 5310 can rotate the second rotating part 5330 to drive the first connecting rod 5340, the second connecting rod 5350 and the transmission rod 5370 to move, thereby rotating the first rotating part 5212.

Specifically, the first connecting rod 5340 rotates about the first rotating shaft 5211, and the second connecting rod 5350 rotates about the second rotating shaft 5320; two ends of the transmission rod 5370 are connected to the first connecting rod 5340 and the second connecting rod 5350 respectively to form a rocker mechanism; the transmission rod 5370 is elastic to achieve a better transmission effect.

As shown in FIG. 61 and FIG. 62, it can be understood that the adjusting piece 5310 is a pressing piece 5311; one end of the pressing piece 5311 is connected to the end of the third connecting rod 5360 away from the second rotating part 5330, and the other end of the pressing piece 5311 extends out of the cylinder 5100; by pressing the pressing piece 5311, the second rotating part 5330 and the first rotating part 5212 rotate. After being pressed downward, the pressing piece 5311 pushes the third connecting rod 5360 to move, so that the second rotating part 5330 rotates, thereby driving the first rotating part 5212 to rotate. By moving the pressing piece 5311 up and down, the second rotating part 5330 and the first rotating part 5212 rotate clockwise and counterclockwise.

Specifically, the pressing piece 5311 may be a key structure. A motor is started by pressing the key to drive the key structure to move reciprocally, thereby improving convenience of use. Specifically, the cylinder 5100 is provided with a through hole. The lower end of the pressing piece 5311 passes through the through hole and is movably connected to the end of the third connecting rod 5360 away from the second rotating part 5330. The upper end of the pressing piece 5311 is located outside the cylinder 5100 for the user to press the pressing piece 5311. Specifically, an elastic structure is provided and connected to the pressing piece 5311 and the cylinder 5100 respectively. The elastic structure can push the pressing piece 5311 to move upward, so that after the user presses the elastic element downward, the elastic element can drive the pressing piece 5311 to return to the initial position.

As shown in FIG. 63, it can be understood that the adjusting piece 5310 is a sliding key 5312; one end of the sliding key 5312 is connected to the end of the third connecting rod 5360 away from the second rotating part 5330, and the other end of the sliding key 5312 extends out of the barrel 5100; by sliding the sliding key 5312, the second rotating part 5330 and the first rotating part 5212 rotate. After sliding, the sliding key 5312 drives the third connecting rod 5360 to rotate about the axis of the second rotating shaft, thereby rotating the second rotating part 5330 and further driving the first rotating part 5212 to rotate. By sliding the sliding key 5312 forward and backward, the second rotating part 5330 and the first rotating part 5212 respectively rotate clockwise and counterclockwise.

Specifically, the cylinder 5100 is provided with a first through slot structure. A sliding key 5312 is located at the first through slot structure, with at least an upper portion thereof arranged outside the cylinder 5100 for facilitating manual movement of the sliding key 5312. At least a lower portion of the sliding key 5312 is movably connected to one end of the third connecting rod 5360 away from the second rotating component 5330. Specifically, an elastic structure is connected to the first connecting rod 5340 and the cylinder 5100 respectively. The elastic structure can push the first connecting rod 5340 to move, so that after the user slides the elastic element downward, the elastic structure can drive the first connecting rod 5340 to move and return the sliding key 5312 to its initial position.

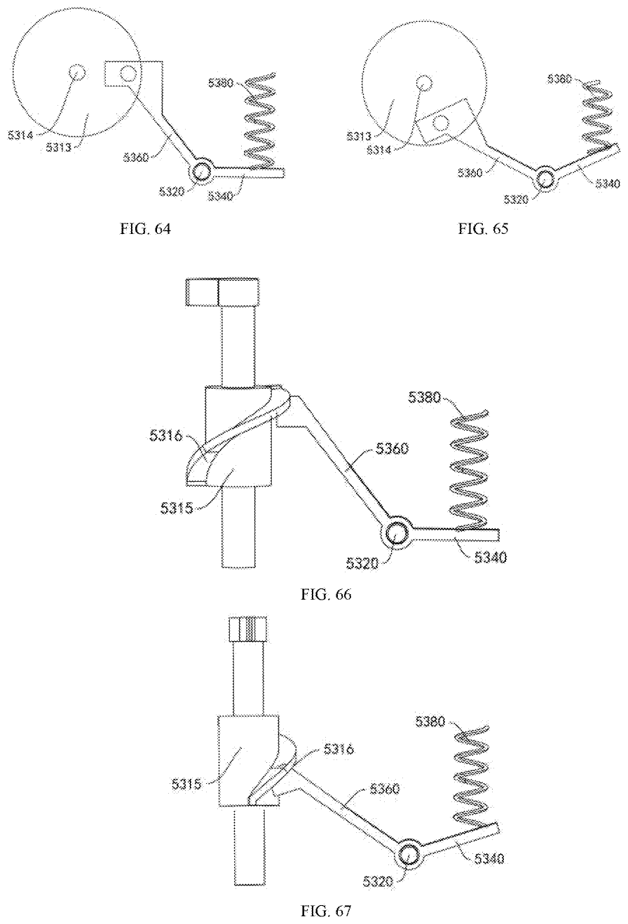

As shown in FIG. 64 and FIG. 65, the adjusting piece 5310 comprises a roller 5313 and a third rotating shaft 5314; the third rotating shaft 5314 is connected to the cylinder 5100, and the roller 5313 is rotatably sleeved over the third rotating shaft 5314; the roller 5313 is rotatably connected to one end of the third connecting rod 5360 away from the second rotating part 5330 and is at least partially located outside the cylinder 5100; by rotating the roller 5313, the second rotating part 5330 and the first rotating part 5212 can rotate. After rolling, the roller 5313 drives the third connecting rod 5360 to rotate about the axis of the second rotating shaft, thereby rotating the second rotating part 5330 and further driving the first rotating part 5212 to rotate. By sliding the sliding key 5312 forward and backward, the second rotating part 5330 and the first rotating part 5212 respectively rotate clockwise and counterclockwise.

Specifically, the cylinder 5100 is provided with a second through slot structure. The roller 5313 is located at the second through slot structure, with at least an upper portion thereof arranged outside the cylinder 5100 for facilitating rotation of the roller 5313 by the user. At least a lower portion of the roller 5313 is rotatably connected to one end of the third connecting rod 5360 away from the second rotating component 5330. Specifically, an elastic structure is connected to the first connecting rod 5340 and the cylinder 5100 respectively. The elastic structure can push the first connecting rod 5340 to move, so that after the user rolls the roller 5313, the elastic structure can drive the first connecting rod 5340 to move and return the roller 5313 to its initial position.

As shown in FIG. 66 and FIG. 67, the adjusting piece 5310 is a knob 5315; the rotation direction of the knob 5315 is perpendicular to the rotation direction of the second rotating part 5330; the knob 5315 is provided with a first abutting surface 5316, which extends spirally around the rotation direction of the knob 5315; a second abutting surface is arranged at one end of the third connecting rod away from the second rotating part 5330; the first abutting surface 5316 and the second abutting surface abut against each other; by rotating the knob piece 5315, the second rotating part 5330 and the first rotating part 5212 can rotate. After the knob 5315 is rotated, the second abutting surface is arranged at one end of the third connecting rod away from the second rotating part 5330 and can move along the first abutting surface 5316 of the knob 5315. Since the first abutting surface 5316 extends spirally around the rotation direction of the knob 5315, the third connecting rod is driven to move along the extension direction of the knob 5315, so that the knob 5315 can drive the third connecting rod 5360 to rotate about the axis of the second rotating shaft, thereby rotating the second rotating part 5330 and further driving the first rotating part 5212 to rotate. By rotating the knob 5315 clockwise and counterclockwise, the second rotating part 5330 and the first rotating part 5212 can respectively rotate clockwise and counterclockwise. Specifically, the cylinder 5100 is provided with a second through slot structure. The roller 5313 is located at the second through slot structure, with at least an upper portion thereof arranged outside the cylinder 5100 for facilitating rotation of the roller 5313 by the user. At least a lower portion of the roller 5313 is rotatably connected to one end of the third connecting rod 5360 away from the second rotating component 5330. Specifically, an elastic structure is connected to the first connecting rod 5340 and the cylinder 5100 respectively. The elastic structure can push the first connecting rod 5340 to move, so that after the user turns the knob 5315, the elastic structure can drive the first connecting rod 5340 to move and return the knob 5315 to its initial position.

As shown in FIG. 63 to FIG. 67, it can be understood that the second adjusting component 5300 further comprises a second elastic element 5380; two ends of the second elastic element 5380 are respectively connected to one end of the first connecting rod 5340 away from the second rotating part 5330 and the cylinder 5100. The second elastic element 5380 is arranged to drive the first connecting rod 5340 to move, so that after the user moves the adjusting piece 5310, the second elastic element 5380 can push the first connecting rod 5340 to move and return the adjusting piece 5310 to its initial position. Specifically, the second elastic element 5380 may be the elastic structure described above.

As shown in FIG. 61 to FIG. 68, a smart device according to the second aspect of the utility model comprises the smart microphone accommodating assembly of the embodiment in the first aspect. When the microphone 510 remains connected to the electronic device such as the speaker, howling occurs if it is too close to the speaker, producing harsh sound that severely affects user experience. Especially when the microphone 510 is stored into the speaker, the probability of howling triggered by impact and friction noises between the microphone 510 and the speaker is even higher. The microphone 510 can be automatically powered off, preventing howling when the microphone 510 approaches the speaker or during the storage of the microphone 510 into the speaker.

In some embodiments, the smart device of the invention may be a smart speaker. The smart speaker of the invention is provided with a smart microphone accommodating assembly. The storage structure may be an accommodating cavity 5110 for accommodating the microphone 510 in an insertion manner. The depth of the cavity is greater than or equal to the length of the microphone 510. The accommodating cavity 5110 comprises an opening 5120, through which the microphone 510 is inserted vertically or horizontally into the cavity along its length direction to achieve storage. A fixing structure for the microphone 510 may be arranged inside or outside the opening 5120 to fix the microphone 510 after storage. The opening 5120 may be arranged at any position of the smart speaker, including the top surface, side surface and bottom surface of the smart speaker. The storage structure may also be a groove, into which the microphone 510 is inserted and stored in a placement manner. A fixing structure for the microphone 510 may be arranged inside or outside the groove to fix the microphone 510 after storage. The microphone 510 is placed vertically or horizontally into the groove along a direction perpendicular to its length to achieve storage. The groove may be arranged at any position of the smart speaker, including the top surface, side surface and bottom surface of the smart speaker.

In some embodiments, the smart speaker can also be connected to a screen via a movable structure, and can further be provided with a screen storage groove, wherein the screen is stored in the screen storage groove after being closed. The storage structure may be arranged under the screen. After the screen is closed, the microphone 510 is completely covered by the screen and fully stored inside the smart speaker.

In some embodiments, the microphone 510 is automatically turned off in such a manner that the sensing element senses a distance between the smart speaker and the microphone 510, and the microphone 510 is automatically turned off when the sensed distance between the smart speaker and the microphone 510 is less than or equal to a preset distance. One or more sensing elements may be distributed, which may be Hall element, distance sensor, infrared sensor, any other individual electronic component capable of sensing the distance between the speaker and the microphone 510, or any combination of the electronic components. The sensing element can be arranged on the smart speaker and/or the microphone 510. Specifically, when the microphone 510 is inserted into the cavity, the sensing element can be arranged at the cavity opening 5120, so that the microphone 510 is powered off immediately when it is just inserted into the opening 5120. The sensing element can also be arranged at one end of the cavity away from the opening 5120 to prevent aging of the sensing element caused by exposure to the outside due to the opening 5120 facing outward. When the microphone 510 is inserted into the groove, the sensing element may be disposed at one end, the middle, or both ends of the groove.

In some specific embodiments, the sensing element is a Hall element; the smart speaker storage structure and the microphone 510 have corresponding positions; the magnetic component is arranged at the corresponding position of the microphone 510, and the Hall element is arranged at the corresponding position of the smart speaker; alternatively, the Hall element is arranged at the corresponding position of the microphone 510, and the magnetic component is arranged at the corresponding position of the smart speaker. In some embodiments, the triggering condition of the Hall element may be that the detected magnetic field intensity reaches a preset value. When the detected magnetic field intensity is greater than or equal to the preset value, it indicates that the distance between the smart speaker and the microphone 510 may trigger howling, and the microphone 510 needs to be powered off. Preferably, the magnetic component is arranged at the corresponding position of the microphone 510, and the Hall element is arranged at the corresponding position of the smart speaker. Given that the microphone 510 is moved around freely during karaoke sessions, the microphone 510 may be moved to the areas with strong external magnetic fields. The Hall element arranged on the microphone 510 may trigger accidental power-off of the microphone 510, thereby adversely affecting the experience. The microphone 510 can be stored in an insertion manner, and the Hall element is arranged at the opening 5120 of the smart speaker cavity or at one end away from the opening 5120. The microphone 510 can also be stored in a placement manner, and the Hall element is arranged at one end, the middle or both ends of the groove.

In some specific embodiments, the sensing element is a Hall element; the speaker is correspondingly provided with a charging structure, and the microphone 510 is correspondingly provided with a power receiving structure. The triggering condition of the Hall element may be a magnetic field change caused at the moment of power-on when the microphone 510 is charged. When a magnetic field change is detected, it indicates that the distance between the speaker and the microphone 510 is sufficient to cause howling, and the microphone 510 needs to be powered off. The charging structure can be arranged on the surface of the smart speaker or corresponding to the storage structure. The microphone 510 can be stored in an insertion manner; the charging structure is arranged at one end of the cavity of the smart speaker away from the opening 5120; a power receiving structure is correspondingly arranged at the bottom or the end bottom surface of the microphone 510; the Hall element is arranged near the charging structure to sense a magnetic field change caused at the moment of power-on. The microphone 510 can be stored in a placement manner; the charging structure is arranged at one end, the middle or both ends of the groove of the smart speaker; a power receiving structure is correspondingly arranged on the microphone 510; the Hall element is arranged near the charging structure to sense a magnetic field change caused at the moment of power-on.

In some specific embodiments, the sensing element is a Hall element; the smart speaker is correspondingly provided with a charging structure, and both the storage structure and the microphone 510 are respectively provided with magnetic components, which are designed to fix the microphone 510 and are arranged outside the sensing trigger range of the Hall element.

The microphone 510 can also be stored in a placement manner, and the charging structure is arranged at one end, the middle or both ends of the groove for the smart speaker. The microphone 510 is correspondingly provided with a power receiving structure, and the Hall element is arranged near the charging structure. The Hall element can sense a magnetic field change caused at the moment of power-on. Preferably, the charging structure is arranged at one end of the groove of the smart speaker, and the magnetic component is arranged at the other end or the middle of the groove of the smart speaker. When the microphone 510 is cylindrical, a button is arranged on the surface of the microphone 510, the magnetic component is arranged on the opposite side of the button, so that the button of the microphone 510 faces the outside of the groove.

As shown in FIG. 69 and FIG. 70, the embodiment of the invention provides a speaker, which comprises a speaker body 610 and a microphone 620, wherein the microphone 620 and the speaker body 610 are in signal connection via a wired or wireless manner, so that the sound information collected by the microphone 620 can be transmitted to the speaker body 610, and the speaker body 610 can play the user's singing voice. In addition, the speaker body 610 can also be used to play background music, allowing the user to sing with the background music. The speaker further comprises at least one automatic fixing assembly 630 connected to the speaker body 610; the automatic fixing assembly 630 specifically comprises a driver 6301 and at least one fixing component 6302; the driver 6301 is fixed on the speaker body 610; a storage space 690 for placing the microphone 620 is formed between one fixing piece 6302 and another fixing piece 6302, or a storage space 690 for placing the microphone 620 is formed between the fixing piece 6302 and the speaker body 610; the fixing piece 6302 is connected to the driver 6301, and the driver 6301 is configured to drive the fixing piece 6302 to automatically fix or release the microphone 620, i.e., after receiving an instruction signal to fix or release the microphone 620, the driver 6301 automatically drives the fixing piece 6302 to perform a corresponding action to fix or release the microphone 620.

Specifically, in this solution, the automatic fixing assembly 630 is arranged on the speaker body 610; the driver 6301 in the automatic fixing assembly 630 automatically controls the fixing piece 6302 to clamp, fix or automatically release the microphone 620. On the one hand, this can improve the firmness of the microphone 620 after storage to prevent the microphone 620 from being unstable and causing damage to the display screen 660. On the other hand, the automatically movable fixing piece 6302 presents dynamic changes visually, so that the pickup and storage of the microphone 620 are more technological, thereby improving the user experience. It should be additionally noted that the automatic fixing assembly 630 may comprise a combination of one driver 6301 and one fixing piece 6302. The automatic fixing assembly 630 may also be a combination of one driver 6301 and a plurality of fixing pieces 6302.

The automatic fixing assembly 630 may further be a combination of a plurality of drivers 6301 and a plurality of fixing pieces 6302. The automatic fixing assembly 630 may also be a combination of a driver 6301 and a vacuum absorption device for adsorbing the microphone 620.

As shown in FIG. 69 and FIG. 7, the automatic fixing assembly 630 specifically comprises a driver 6301 and two fixing pieces 6302; the storage space 690 is formed between the two fixing pieces 6302; at least one of the two fixing pieces 6302 is connected to the driver 6301, i.e., the driver 6301 may drive only one fixing piece 6302 to move, or the driver 6301 may drive both fixing pieces 6302 to move simultaneously; the driver 6301 may be a motor; the driver 6301 is specifically configured to drive the two fixing pieces 6302 to move toward or away from each other; the two fixing pieces 6302 move toward each other to clamp the microphone 620 together, and move away from each other to release the microphone 620. As shown in FIG. 69, the speaker of this embodiment preferably comprises two microphones 620. Correspondingly, at least two automatic fixing assemblies 630 are arranged in the speaker; each automatic fixing assembly 630 clamps a corresponding microphone 620 to reliably clamp both microphones 620 automatically. Preferably, one automatic fixing assembly 630 is arranged at one end of each microphone 620, i.e., two automatic fixing assemblies 630 respectively clamp the ends of one microphone 620 to improve the stability of the microphone 620 after storage, and also prevent the fixing piece 6302 from touching the buttons in the middle of the microphone 620 when clamping the microphone 620. In addition, the fixing pieces 6302 may be arranged at the top, side or bottom of the speaker body 610, so that the microphone 620 can be clamped and stored at the top, side, or bottom of the speaker body 610.

As shown in FIG. 70, in one specific embodiment, the automatic fixing assembly 630 may further comprise a driving gear 6303 and a driven gear 6304 meshed with each other; the driving gear 6303 is fixedly connected to the driver 6301, and the driven gear 6304 is fixedly connected to one of the fixing pieces 6302 in the automatic fixing assembly 630. During storage, the microphone 620 is placed between the two fixing pieces 6302, and then the driver 6301 is activated. The driver 6301 drives the driving gear 6303 to rotate, which in turn drives the driven gear 6304 to rotate. The driven gear 6304 drives the fixing pieces 6302 to move, allowing the two fixing pieces 6302 to move toward or away from each other, thereby realizing automatic clamping or releasing of the microphone 620.

Such a gear-driven automatic fixing assembly 630 can effectively utilize the lateral space. More specifically, in this technical solution, preferably, the two fixing pieces 6302 are rotatably connected, and the automatic fixing assembly 630 further comprises an elastic element 6305 connected between the two fixing pieces 6302. The elastic element 6305 is preferably a torsion spring. One end of the elastic element 6305 elastically abuts against one fixed fixing piece 6302, and the other end elastically abuts against the other fixing piece 6302 connected with the driven gear 6304. When the fixing piece 6302 connected with the driven gear 6304 rotates, the other fixing piece 6302 also rotates under the elastic force of the elastic element 6305, and the two fixing pieces 6302 tend to move toward each other under the elastic force of the elastic element 6305. In other words, the elastic element 6305 is used to provide the clamping force between the two fixing pieces 6302, and the driver 6301 only provides the rotational force to open the two fixing pieces 6302. After the microphone 620 is removed, the fixing pieces 6302 can automatically return to the clamping position under the elastic force of the elastic element 6305. Even if the driver 6301 is powered off or damaged, the microphone 620 can still be clamped under the elastic force of the elastic element 6305 and can be manually pulled out.

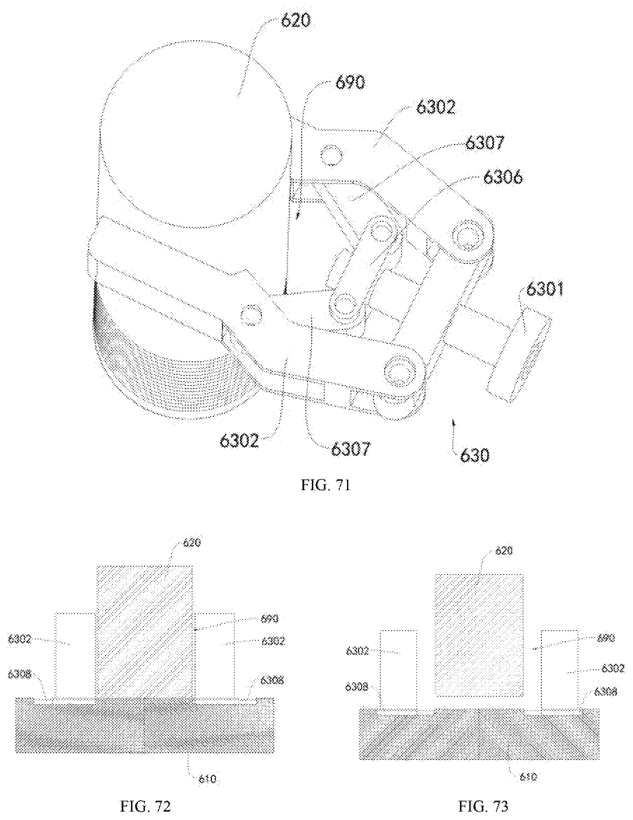

As shown in FIG. 71, in one specific embodiment, the automatic fixing assembly 630 may also be configured to comprise a reciprocating block 6306 and a connecting rod 6307; the driver 6301 is connected to the reciprocating block 6306 and is designed to drive the reciprocating block 6306 to move linearly in the vertical direction; the two fixing pieces 6302 are respectively connected to the reciprocating block 6306 via one connecting rod 6307; one end of the connecting rod 6307 is hinged to the reciprocating block 6306, and the other end of the connecting rod 6307 is hinged to the corresponding fixing piece 6302. When being actuated, the driver 6301 drives the reciprocating block 6306 to move up and down, thereby driving the two fixing pieces 6302 to move toward or away from each other, thereby realizing automatic clamping or releasing of the microphone 620. This type of automatic fixing assembly 630 can effectively utilize the vertical space.

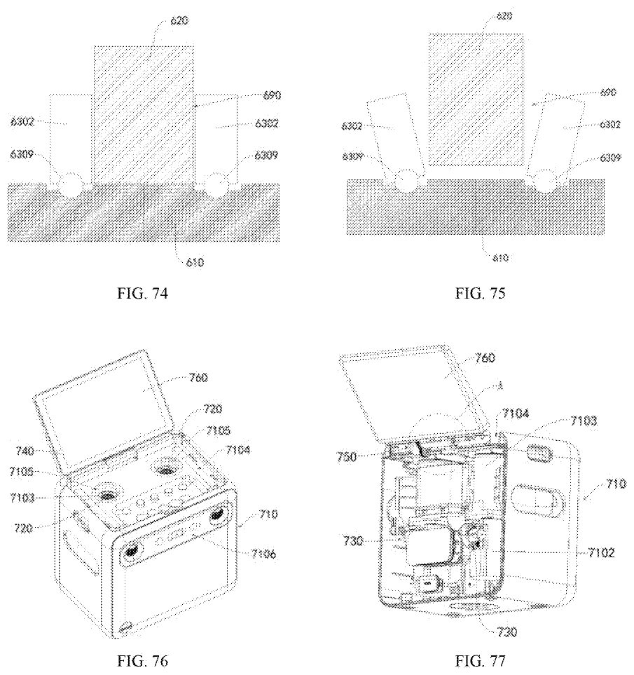

As shown in FIG. 72 and FIG. 73, in one specific embodiment, a guide rail 6308 may be connected between the fixing piece 6302 and the speaker body 610; the driver 6301 is designed to drive at least one fixing piece 6302 to slide along the guide rail 6308, so that the two fixing pieces 6302 move away from or toward each other along the guiding direction of the guide rail 6308. At this point, the two fixing pieces 6302 can also automatically clamp or release the microphone 620.

As shown in FIG. 74 and FIG. 75, in one specific embodiment, an electric rotating shaft mechanism 6309 is connected between each of the two fixing pieces 6302 and the speaker body 610. The electric rotating shaft mechanisms 6309 drive the corresponding fixing pieces 6302 to rotate relative to the speaker body 610, so that the two fixing pieces 6302 can also automatically clamp or release the microphone 620. In this solution, the electric rotating shaft mechanism 6309 equivalently comprises the aforementioned driver 6301.

As shown in FIG. 69, in this solution, the microphone 620 is preferably designed to be stored in the storage space 690 in a horizontal lying posture. Preferably, the two fixing pieces 6302 are only used to clamp the lower half of the microphone 620 without clamping the upper half, so that the user can still take the microphone 620 out of the storage space 690 when the speaker is powered off. As shown in FIG. 69, in this solution, at least one storage groove 6101 for placing the microphone 620 is preferably arranged on the top of the speaker body 610. In fact, the two fixing pieces 6302 in the automatic fixing assembly 630 are arranged on two opposite sides of the storage groove 6101, preferably on two opposite sides of the storage groove 6101 in the width direction, so that the two fixing pieces 6302 can clamp the microphone 620 located in the storage groove 6101. Specifically, the microphone 620 and the speaker body 610 are in wireless communication connection. To facilitate charging of the microphone 620, a charging pin 6103 is arranged in the storage groove 6101, and a charging ring 6201 is arranged on the outer surface of the microphone 620. When the microphone 620 is stored into the storage groove 6101, the charging ring 6201 and the charging pin 6103 form a conductive circuit, so that the microphone 620 can be automatically charged in the stored state. More specifically, the speaker in this embodiment may further comprise a detector (not shown) for detecting whether the microphone 620 is placed into the storage groove 6101. The detector is in signal connection with the driver 6301, and the driver 6301 is designed to control the two fixing pieces 6302 in the automatic fixing assembly 630 to move toward or away from each other according to the detection result of the detector. After the detector detects that the microphone 620 is stored into the storage groove 6101, the driver 6301 in the automatic fixing assembly 630 automatically controls the two fixing pieces 6302 to move toward each other to automatically clamp the microphone. The detector may be an infrared sensor, which directly determines whether the microphone 620 is stored in the storage groove 6101 by detecting the distance between the microphone 620 and itself via infrared rays. The detector may also be an electronic component in signal connection with the charging pin 6103. When the detector detects that the charging pin 6103 are charging the microphone 620, the detector indirectly determines that the microphone 620 has been stored in the storage groove 6101. In addition, magnetic positioning assemblies may be arranged in the storage groove 6101 and the microphone 620 to ensure that the buttons on the microphone 620 face upward after the microphone 620 is stored in the storage groove 6101.

As shown in FIG. 69, the speaker in this embodiment further comprises a display screen 660, which is movably and electrically connected to the speaker body 610. The display screen 660 can be used to search for designated music and control the speaker body 610 to play the designated music. The display screen 660 can also display lyrics corresponding to the timbre to be played, so that the user can sing along with the lyrics displayed on the display screen 660. Additionally, the display screen 660 and the speaker body 610 can be movably connected in a rotational manner via a rotating shaft, or the display screen 660 can also rotate in multiple directions relative to the speaker body 610 through magnetic attraction, etc. Preferably, a groove 6102 for accommodating the display screen 660 is arranged on the top surface of the speaker body 610; the storage groove 6101 is arranged at the bottom of the groove 6102. When being closed, the display screen 660 covers the opening of the storage groove 6101, thereby shielding the microphone 620, preventing external dust from falling onto the microphone 620, and prolonging the service life of the microphone 620.

As shown in FIG. 69, the speaker may comprise a sensor 640 connected to the display screen 660 or the speaker body 610. The sensor 640 is configured to obtain the rotation direction and angle information of the display screen 660, or sense the distance information between the display screen 660 and the bottom of the groove 6102. The sensor 640 is in signal connection with the driver 6301, i.e., the driver 6301 is designed to control the two fixing pieces 6302 to clamp or release the microphone 620 according to the information obtained by the sensor 640. Specifically, when the sensor 640 detects that the display screen 660 is flipped open to a certain angle, the driver 6301 automatically controls the two fixing pieces 6302 to move away from each other to release the microphone 620. When the sensor 640 detects that the display screen 660 is being closed, the driver 6301 automatically controls the two fixing pieces 6302 to move toward each other to clamp the microphone 620 automatically. This improves the degree of automation of automatic clamping and releasing of the microphone 620, thereby further optimizing the user experience.

As shown in FIG. 69, a control key 6104 may also be arranged on the speaker body 610 or the microphone 620. The control key 6104 is also in signal connection with the driver 6301 and is designed to control the operation of the driver 6301. In other words, the control key 6104 can be pressed to control the two fixing piece 6302 to move toward or away from each other. This also improves the degree of automation of automatic clamping and releasing of the microphone 620, thereby further optimizing the user experience. In addition to being a push button, the control key 6104 may also be a knob, a roller button, or a virtual button. In one embodiment, a voice control module may also be arranged in the speaker body 610. The voice control module is also in signal connection with the driver 6301 and controls the operation of the driver 6301. In other words, automatic clamping or releasing of the microphone 620 can be controlled via voice commands. For example, a power-on voice command controls the display screen 660 to automatically lift up and the two fixing pieces 6302 to automatically move away from each other. A power-off voice command controls the two fixing pieces 6302 to automatically move toward each other and the display screen 660 to be automatically retracted into the groove 6102.

Further, when the microphone 620 remains connected to the speaker body 610, if the distance between the microphone 620 and the speaker body 610 is too close, the speaker body 610 will produce harsh howling, which seriously affects the user experience. In particular, the probability of howling caused by impact and friction between the microphone 620 and the speaker body 610 during storage is even higher. Therefore, the microphone 620 can be automatically powered off during storage in the speaker body 610, which solves the problem of howling that occurs when the microphone 620 approaches or rubs against the speaker body 610. Specifically, the microphone 620 is automatically powered off in the following manner: a sensing element detects the distance between the speaker body 610 and the microphone 620. After the detected distance is less than or equal to a preset distance, the microphone 620 is automatically powered off. One or more sensing elements may be distributed, which may be Hall element, distance sensor, infrared sensor, any other individual electronic component capable of sensing the distance between the speaker body 610 and the microphone 620, or any combination of the electronic components. The sensing element may be arranged on the speaker body 610 and/or the microphone 620.

In some specific embodiments, the sensing element is preferably a Hall element. Actually, the magnetic component is arranged on the microphone 620, and the Hall element is arranged at a corresponding position on the speaker body 610; or the Hall element is arranged on the microphone 620, and the magnetic component is arranged at a corresponding position on the speaker body 610. In some embodiments, the triggering condition of the Hall element may be that the detected magnetic field intensity reaches a preset value. When the detected magnetic field intensity is greater than or equal to the preset value, it indicates that the distance between the speaker body 610 and the microphone 620 may trigger howling, and the microphone 620 needs to be powered off. Given that the microphone 620 is moved around freely during karaoke sessions, the microphone 620 may be moved to the areas with strong external magnetic fields. The Hall element arranged on the microphone 620 may trigger accidental power-off of the microphone 620, thereby adversely affecting the experience. In this solution, a magnetic component is preferably arranged on the microphone 620, and a Hall element is arranged at a corresponding position on the speaker body 610.

In some specific embodiments, the sensing element is a Hall element, and a charging structure is arranged in the storage space 690. After being stored, the microphone 620 is automatically charged via the charging structure. The Hall element may be arranged near the charging structure, so that the triggering condition of the Hall element may be that an instantaneous magnetic field change is generated upon power-on when the microphone 620 is fully stored and charging starts. When the magnetic field change is detected, it indicates that the distance between the speaker body 610 and the microphone 620 is sufficient to cause howling, and the microphone 620 needs to be powered off.

In some specific embodiments, the sensing element is a Hall element, and a charging structure is arranged in the storage space 690. Magnetic components are arranged in the storage space 690 and the microphone 620 respectively for fixing the microphone 620. The magnetic components are arranged outside the sensing trigger range of the Hall element to prevent from interfering with the Hall element in detecting the surrounding magnetic field intensity. The Hall element is arranged near the charging structure and can sense the magnetic field change caused at the moment of power-on. When the Hall element detects the magnetic field change, it indicates that the distance between the speaker body 610 and the microphone 620 is sufficient to cause howling, and the microphone 620 needs to be powered off.

As shown in FIG. 76 and FIG. 77, the embodiment of the invention provides a smart device, which comprises a speaker body 710 and at least one microphone 720, wherein the microphone 720 and the speaker body 710 are in signal connection via a wired or wireless manner, so that the sound information collected by the microphone 720 can be transmitted to the speaker body 710, and the speaker body 710 can play the user's singing voice. In addition, the speaker body 710 can also be used to play background music, allowing the user to sing with the background music. The smart device further comprises a storage mechanism 730 connected to the speaker body 710. The storage mechanism 730 is configured to electrically control the microphone 720 to perform reciprocating linear movement (preferably to control the microphone 720 to move up or down). When the microphone 720 moves down, it facilitates storage of the microphone 720. When the microphone 720 moves up, it allows the user to directly hold the microphone 720.

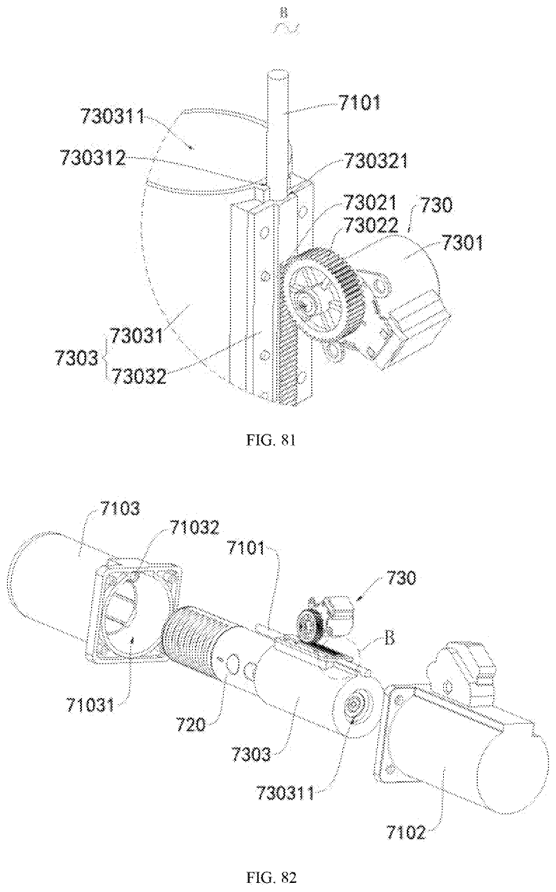

As shown in FIG. 76, FIG. 77 and FIG. 79 to FIG. 82, the storage mechanism 730 specifically comprises a driver 7301, a transmission structure 7302 and a bearing cylinder 7303. The driver 7301 is fixed in the speaker body 710. An upwardly open storage groove 730311 is provided in the bearing cylinder 7303 for the microphone 720 to be inserted therein. The bearing cylinder 7303 is slidably connected with the speaker body 710 in a vertical direction. The driver 7301 drives the bearing cylinder 7303 to move up or down through the transmission structure 7302. When the microphone 720 falls to the lowest position together with the bearing cylinder 7303, the storage of the microphone 720 is completed. When the microphone 720 rises to the highest position together with the bearing cylinder 7303, the microphone 720 is in a lifted state, and the user can easily hold the microphone 720. The driver 7301 is a motor. The transmission structure 7302 preferably comprises a rack 73021 and a gear 73022 meshed with each other. The gear 73022 is fixedly connected to the output shaft of the driver 7301, and the rack 73021 is fixedly connected to the bearing cylinder 7303. When the output shaft of the driver 7301 rotates forward or reversely, the bearing cylinder 7303 and the microphone 720 can be driven to rise or fall together.

Specifically, the smart device in this solution is provided with the bearing cylinder 7303 with the storage groove 730311 and the electric driver 7301. In use, the driver 7301 in the storage mechanism 730 controls the lifting or lowering of the bearing cylinder 7303 through the transmission of the gear 73022 and the rack 73021, thereby electrically controlling the lifting or lowering of the microphone 720 stored in the bearing cylinder 7303. Compared with the traditional manual pressing storage structure, the electric storage mechanism 730 of this solution obviously has a stronger sense of technology and simpler operation. The driving of the microphone 720 to rise or fall is also more reliable, without problems such as failure of the microphone 720 to lift or storage locking failure.

In other embodiments, the notch of the storage groove 730311 on the bearing cylinder 7303 may not face upward, but may also face sideways. In other words, the microphone 720 can be inserted from the side of the speaker body 710 and stored in the bearing cylinder 7303.

Preferably, the smart device in this embodiment comprises two microphones 720. Correspondingly, two storage mechanisms 730 are arranged in the smart device and correspond to the two microphones 720, so that both microphones 720 can be automatically stored downward or lifted upward.

As shown in FIG. 79 to FIG. 82, the bearing cylinder 7303 specifically comprises a cylinder 73031 and a connecting piece 73032 that are fixedly connected. The storage groove 730311 is arranged on the cylinder 73031, and the rack 73021 is arranged on the connecting piece 73032. The speaker body 710 comprises a guide rod 7101 extending in a vertical direction. The connecting piece 73032 can slide along the guide rod 7101, and the guide rod 7101 can improve the moving precision of the bearing cylinder 7303 in the vertical direction. More specifically, a first arc-shaped sliding groove 730312 extending in a vertical direction is further arranged on the cylinder 73031, and a second arc-shaped sliding groove 730321 extending in a vertical direction is arranged on the connecting piece 73032. The first arc-shaped sliding groove 730312 and the second arc-shaped sliding groove 730321 are connected and jointly form a guide groove. The guide rod 7101 is inserted into the guide groove. The rack 73021 is arranged on the surface of the connecting piece 73032 facing away from the second arc-shaped sliding groove 730321. Such a design facilitates reliable fixation between the cylinder 73031 and the connecting piece 73032, and enables the guide rod 7101 to be arranged closer to the rack 73021, thereby solving the problem that the bearing cylinder 7303 is prone to jamming when the rack 73021 is driven to move up and down by the gear 73022, and ensuring that the bearing cylinder 7303 can smoothly slide along the guide rod 7101 in the vertical direction.

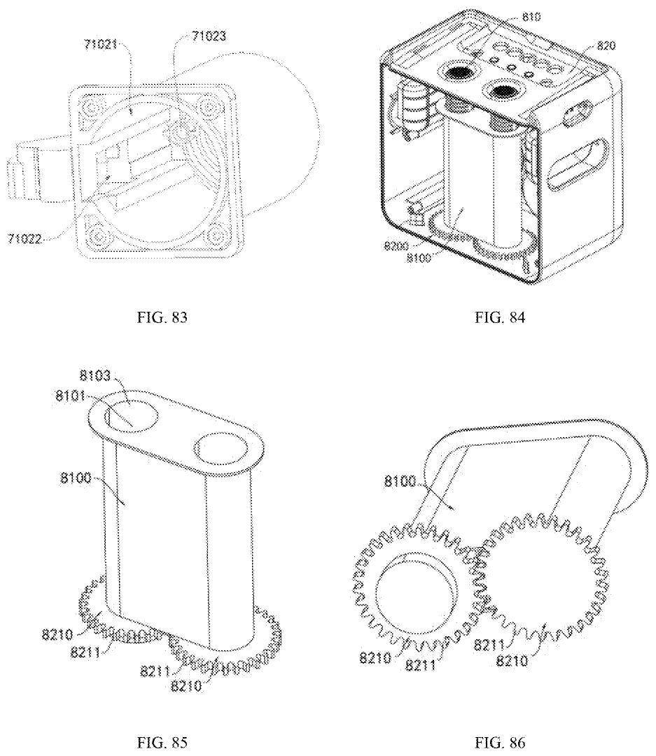

As shown in FIG. 79 to FIG. 83, the speaker body 710 further comprises a lower fixing seat 7102 and an upper fixing seat base 7103, wherein the upper fixing seat 7103 is fixed on the top of the lower fixing seat 7102; the driver 7301 is fixed on the lower fixing seat 7102; the lower fixing seat 7102 is provided with a first hole 71021 opening upward, and the bearing cylinder 7303 is received in the first hole 71021; a notch 71022 connected to the first hole 71021 is provided on the outer side wall of the upper fixing seat 7103; the rack 73021 is exposed through the notch 71022, so that the gear 73022 can be meshed with the rack 73021; the bottom end of the guide rod 7101 is fixedly connected to the lower fixing seat 7102, and the top end of the guide rod 7101 is fixedly connected to the upper fixing seat 7103. It can be seen from the above that the lower fixing seat 7102 facilitates the fixation of the driver 7301 and the guide rod 7101, making the structure more compact and reasonable. In addition, a second hole 71031 penetrating in the vertical direction is provided on the upper fixing seat 7103 and is downwardly connected with the first hole 71021, so that the second hole 71031 can also be used to accommodate the microphone 720. In other words, after the microphone 720 is inserted along the second hole 71031 and finally inserted into the storage groove 730311 of the bearing cylinder 7303, and the bearing cylinder 7303 moves downward to a preset position, the upper fixing seat 7103 can cover the upper half of the microphone 720. Thus, the upper fixing seat 7103 can restrict the position of the upper half of the microphone 720, preventing the microphone 720 from separating from the storage groove 730311 when the smart device vibrates or is placed obliquely. Meanwhile, the upper fixing seat 7103 also provides a dustproof effect for the microphone 720, preventing dust inside the smart device from falling onto the microphone 720. In addition, the wall of the second hole 71031 may further be provided with a damping structure for sliding friction with the microphone 720, so that the microphone 720 is more stable and reliable when being lowered for storage or lifted upward along with the bearing cylinder 7303.

As shown in FIG. 79 to FIG. 83, the lower fixing seat 7102 is provided with a first fixing portion 71023 in the first hole 71021, and the upper fixing seat 7103 is provided with a second fixing portion 71032 in the second hole 71031. The bottom end of the guide rod 7101 is fixedly connected to the first fixing portion 71023, and the top end of the guide rod 7101 is fixedly connected to the second fixing portion 71032. Thus, a part of the guide rod 7101 can be received in the first hole 71021, and another part of the guide rod 7101 can be received in the second hole 71031. In this way, the guide rod 7101 can be hidden inside, preventing a large amount of dust from falling onto the guide rod 7101 and improving the reliability that the bearing cylinder 7303 can slide along the guide rod 7101 for a long time. In addition, the first fixing portion 71023 is arranged on the downward movement path of the bearing cylinder 7303 to limit the lowest position of the bearing cylinder 7303 moving downward, and the second fixing portion 71032 is arranged on the upward movement path of the bearing cylinder 7303 to limit the highest position of the bearing cylinder 7303 moving upward. It can be seen from the above that by hiding the guide rod 7101 inside, the problem that the bearing cylinder 7303 is prone to jamming due to excessive dust entering the guide rod 7101 is solved, and the purpose of limiting the moving stroke of the bearing cylinder 7303 is also achieved, making the overall structure more compact and reasonable.

As shown in FIG. 76 and FIG. 7, the smart device in this embodiment further comprises a display screen 760, which is movably connected and electrically connected to the speaker body 710. The display screen 760 can be used to search for designated music and control the speaker body 710 to play the designated music. The display screen 760 can also display lyrics corresponding to the timbre to be played, so that the user can sing along with the lyrics displayed on the display screen 760. Additionally, the display screen 760 and the speaker body 710 can be movably connected in a rotational manner via a rotating shaft, or the display screen 760 can also rotate in multiple directions relative to the speaker body 710 through magnetic attraction, etc. Preferably, a groove 7104 for accommodating the display screen 760 is provided on the top surface of the speaker body 710; at least one storage hole 7105 is formed at the bottom of the groove 7104 and is downwardly connected with a storage groove 730311 of a corresponding bearing cylinder 7303. Specifically, during storage, the microphone 720 needs to be inserted into the bearing cylinder 7303 through the storage hole 7105. Driven by the driver 7301, the microphone 720 has a first position exposed upward relative to the storage hole 7105 and a second position received inside the storage hole 7105. When the display screen 760 is in the open state and the microphone 720 is in the first position, the user can easily hold the microphone 720 as it is exposed. When being in the second position, the microphone 720 does not interfere with the display screen 760 stored in the groove 7104 since the microphone 720 is stored in the storage hole 7105, thereby preventing the display screen 760 from being damaged by pressing against when stored in the groove 7104. With such a design, after the microphone 720 is completely stored, the display screen 760 can cover the microphone 720, preventing external dust from falling onto the microphone 720 and prolonging the service life of the microphone 720.

In one embodiment, the smart device may further comprise a sensor 740 connected to the display screen 760 or the speaker body 710. The sensor 740 is configured to obtain the rotation direction and angle information of the display screen 760, or detect the distance information between the display screen 760 and the bottom of the groove 7104. The sensor 740 is in signal connection with the driver 7301, i.e., the driver 7301 is configured to control the microphone 720 to move up or down according to the information acquired by the sensor 740. Specifically, when the sensor 740 detects that the display screen 760 is flipped open to a certain angle, the driver 7301 automatically controls the microphone 720 to rise; when the sensor 740 detects that the display screen 760 is being closed, the driver 7301 automatically controls the microphone 720 to fall. This improves the degree of automation of automatic downward storage and upward lifting of the microphone 720, thereby further optimizing the user experience.

In one embodiment, a control key 7106 may further be arranged on the speaker body 710 or the microphone 720. The control key 7106 is also in signal connection with the driver 7301 and configured to control the operation of the driver 7301, i.e., the microphone 720 can be controlled to retract downward or lift upward by pressing the control key 7106. This also improves the degree of automation of automatic downward storage and upward lifting of the microphone 720, thereby further optimizing the user experience. In addition to being a push button, the control key 7106 may also be a knob, a roller button, or a virtual button.

In one embodiment, a voice control module may also be arranged in the speaker body 710. The voice control module is also in signal connection with the driver 7301 and controls the operation of the driver 7301. In other words, automatic clamping or releasing of the microphone 720 can be controlled via voice commands. For example, a power-on voice command controls the display screen 760 to automatically lift up and the microphone 720 to automatically lift. A power-off voice command controls the microphone 720 to be automatically stored and the display screen 760 to be automatically retracted into the groove 7104.

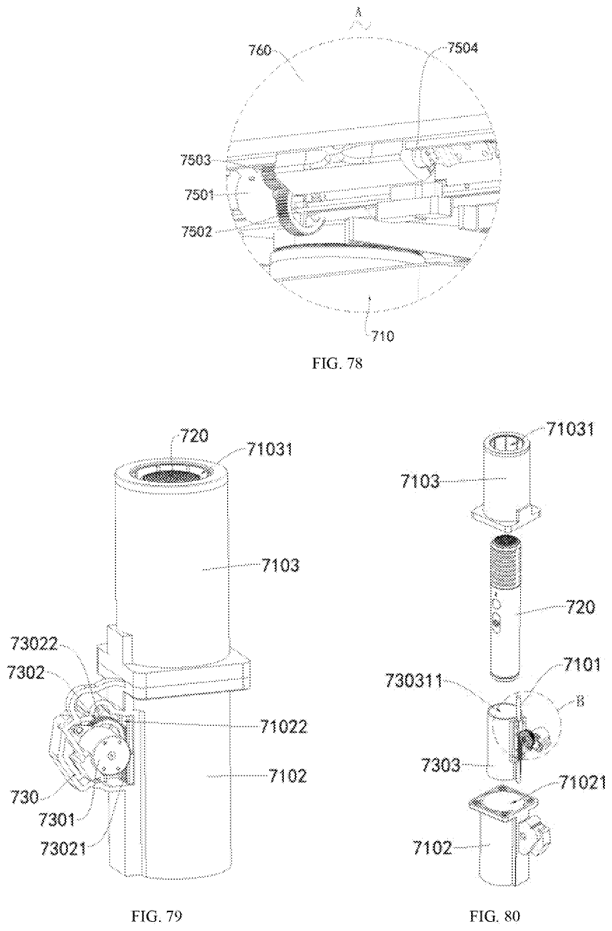

As shown in FIG. 77 and FIG. 78, in this embodiment, an electric drive mechanism 750 is preferably connected between the display screen 760 and the speaker body 710. The electric drive mechanism 750 is configured to drive the display screen 760 to automatically flip open or close relative to the speaker body 710. The storage mechanism 730 is configured to automatically control the microphone 720 to extend or retract according to the action of the display screen 760 driven by the electric drive mechanism 750. It can be specifically understood that when the electric drive mechanism 750 drives the display screen 760 to automatically flip open, the storage mechanism 730 drives the microphone 720 to automatically extend; and/or when the electric drive mechanism 750 drives the display screen 760 to automatically close, the storage mechanism 730 drives the microphone 720 to automatically retract. Specifically, in this solution, the display screen 760 is automatically driven to open or close in an electric manner, thereby solving the laborious problem caused by manual screen opening or closing, and the automatic manner provides a stronger sense of technology.

In addition, this solution further designs the electric drive mechanism 750 to be linked with the storage mechanism 730, so that the storage mechanism 730 can automatically control the microphone 720 to extend or retract according to the opening or closing of the display screen 760, thereby further enhancing the sense of technology and improving the user experience.

As shown in FIG. 77 and FIG. 78, the electric drive mechanism 750 specifically comprises a motor 7501, a driving wheel 7502, a driven wheel 7503 and a rotating shaft 7504; the motor 7501 is fixedly connected to the speaker body 710; the rotating shaft 7504 is fixedly connected to the display screen 760, one end of the rotating shaft 7504 is rotatably connected to the speaker body 710, and the other end of the rotating shaft 7504 is sleeved with the driven wheel 7503; the driving wheel 7502 is connected to the output shaft of the motor 7501, and the driving wheel 7502 is in meshing transmission with the driven wheel 7503. The electric drive mechanism 750 adopting gear transmission can realize automatic opening and closing of the display screen 760, reduce the difficulty of manually opening the display screen 760, and improve user experience. In addition, the motor 7501 has no braking function to support the function of manually opening or closing the display screen 760.

Further, when the microphone 720 remains connected to the speaker body 710, if the distance between the microphone 720 and the speaker body 710 is too close, the speaker body 710 will produce harsh howling, which seriously affects the user experience. In particular, the probability of howling caused by impact and friction between the microphone 720 and the speaker body 710 during storage is even higher. Therefore, the microphone 720 can be automatically powered off during storage in the speaker body 710, which solves the problem of howling that occurs when the microphone 720 approaches or rubs against the speaker body 710. Specifically, the microphone 720 is automatically powered off in the following manner: a sensing element detects the distance between the speaker body 710 and the microphone 720. After the detected distance is less than or equal to a preset distance, the microphone 720 is automatically powered off. One or more sensing elements may be distributed, which may be Hall element, distance sensor, infrared sensor, any other individual electronic component capable of sensing the distance between the speaker body 710 and the microphone 720, or any combination of the electronic components. The sensing element may be arranged on the speaker body 710 and/or the microphone 720.

In some specific embodiments, the sensing element is preferably a Hall element. Actually, the magnetic component is arranged on the microphone 720, and the Hall element is arranged at a corresponding position on the speaker body 710; or the Hall element is arranged on the microphone 720, and the magnetic component is arranged at a corresponding position on the speaker body 710. In some embodiments, the triggering condition of the Hall element may be that the detected magnetic field intensity reaches a preset value. When the detected magnetic field intensity is greater than or equal to the preset value, it indicates that the distance between the speaker body 710 and the microphone 720 may trigger howling, and the microphone 720 needs to be powered off. Given that the microphone 720 is moved around freely during karaoke sessions, the microphone 720 may be moved to the areas with strong external magnetic fields. The Hall element arranged on the microphone 720 may trigger accidental power-off of the microphone 720, thereby adversely affecting the experience. In this solution, a magnetic component is preferably arranged on the microphone 720, and a Hall element is arranged at a corresponding position on the speaker body 710.

In some specific embodiments, the sensing element is a Hall element, and a charging structure is arranged in the storage mechanism 730. After being stored, the microphone 720 is automatically charged via the charging structure. The Hall element may be arranged near the charging structure, so that the triggering condition of the Hall element may be that an instantaneous magnetic field change is generated upon power-on when the microphone 720 is fully stored and charging starts. When the magnetic field change is detected, it indicates that the distance between the speaker body 710 and the microphone 720 is sufficient to cause howling, and the microphone 720 needs to be powered off.

In some specific embodiments, the sensing element is a Hall element, and a charging structure is arranged in the storage mechanism 730. Magnetic components are arranged in the storage mechanism 730 and the microphone 720 respectively for fixing the microphone 620. The magnetic components are arranged outside the sensing trigger range of the Hall element to prevent from interfering with the Hall element in detecting the surrounding magnetic field intensity. The Hall element is arranged near the charging structure and can sense the magnetic field change caused at the moment of power-on. When the Hall element detects the magnetic field change, it indicates that the distance between the speaker body 710 and the microphone 720 is sufficient to cause howling, and the microphone 720 needs to be powered off.

The smart microphone 810 storage assembly according to the embodiment of the first aspect of the invention will be described below with reference to FIG. 84 to FIG. 94.

According to the smart microphone 810 storage assembly of the embodiment of the invention, the smart microphone 810 storage assembly comprises a cylinder 8100 and a moving assembly 8200; the cylinder 8100 comprises at least one first accommodating groove 8101 for storing the microphone 810; one end of the first accommodating groove 8101 extends in the first direction to the outer wall of the cylinder 8100 to form a first opening 8103. The moving assembly 8200 is connected to the cylinder 8100 and is capable of driving the cylinder 8100 to move in the first direction and reciprocate between a first position and a second position.

In the embodiment of the invention, the microphone 810 may be inserted into the first accommodating groove 8101 from the first opening 8103. The moving assembly 8200 is connected to the cylinder 8100. When the microphone 810 needs to be stored, the moving assembly 8200 may drive the cylinder 8100 to move in the first direction to a first position to store the cylinder 8100 and the microphone 810, and realize storage of the microphone 810 into the smart speaker. When the microphone 810 needs to be taken out, the moving assembly 8200 may drive the cylinder 8100 to move in the first direction to a second position to push the cylinder 8100 and the microphone 810, reducing difficulty for the user to take the microphone 810. Moreover, compared with the conventional storage manner using a torsion spring and a swing arm with a fixing seat, the smart microphone 810 storage assembly controls the position of the cylinder 8100 through the moving assembly 8200, thereby controlling the position of the microphone 810 in the cylinder 8100.

It is easy to use and generates low noise, which can ensure user experience. Specifically, the moving assembly 8200 is arranged at one end of the cylinder 8100 away from the first opening 8103 to achieve limiting and supporting effects on the cylinder 8100 via the driving part, and reduce the possibility of accidental falling of the cylinder 8100 caused by misoperation. Specifically, the first direction is the axial direction of the cylinder 8100.

As shown in FIG. 85 to FIG. 90, it can be understood that the moving assembly 8200 comprises a driving part and a rotating part 8210; the rotating part 8210 is provided with a protrusion 8110, and the cylinder 8100 is provided with a spiral groove 8221; or the rotating part 8210 is provided with a spiral groove 8221, and the cylinder 8100 is provided with a protrusion 8110; the spiral groove 8221 is arranged spirally around the first direction, and the protrusion 8110 is movably arranged in the spiral groove 8221; the driving part is connected to the rotating part 8210, and is configured to drive the rotating part 8210 to rotate relative to the cylinder 8100, so that the cylinder 8100 drives the microphone 810 to move along the first direction and reciprocate between the first position and the second position.

Conventional storage structures using torsion springs and swing arms with fixed seats generate relatively loud noise during operation. In the application, by providing the driving part and the rotating part 8210, the protrusion 8110 moves inside the spiral groove 8221 while the rotating part 8210 rotates around the first direction. Since the spiral groove 8221 is arranged spirally around the first direction, the cylinder 8100 can be driven to move back and forth along the first direction. The protrusion 8110 rarely collides with the groove, thereby reducing noise. The driving piece may be a rotary driving motor or other rotary driving structure. Specifically, when no microphone 810 is placed in the first accommodating groove 8101, the driving part drives the rotating part 8210 to rotate, so that the cylinder 8100 moves upward to a raised position, facilitating placement of the microphone 810 into the first accommodating groove 8101. After the microphone 810 is placed into the first accommodating groove 8101, the driving part drives the rotating part 8210 to rotate, so that the cylinder 8100 moves downward to realize storage of the microphone 810.

Specifically, the first direction is arranged in the same direction as the axial direction of the first accommodating groove 8101. Specifically, in the first direction, the height of the cylinder 8100 at the first position is lower than that at the second position. The microphone 810 can be placed into the first accommodating groove 8101. The moving assembly 8200 is connected to the cylinder 8100. When the microphone 810 needs to be stored, the moving assembly 8200 drives the rotating part 8210 to rotate relative to the cylinder 8100 via the driving part, so that the cylinder 8100 drives the microphone 8100 to move linearly downward to the first position, thereby storing the cylinder 8100 and the microphone 810, and realizing storage of the microphone 810 into the smart device. When the microphone 810 needs to be taken out, the moving assembly 8200 drives the rotating part 8210 to rotate relative to the cylinder 8100 via the driving part, so that the cylinder 8100 drives the microphone 810 to move linearly upward to the second position, thereby pushing the cylinder 8100 and the microphone 810 and reducing difficulty for the user to take the microphone 810. Moreover, compared with the conventional storage manner using a torsion spring and a swing arm with a fixing seat, the smart microphone 810 storage assembly controls the position of the cylinder 8100 through the moving assembly 8200, thereby controlling the position of the microphone 810 in the cylinder 8100. It is easy to use and generates low noise, which can ensure user experience.

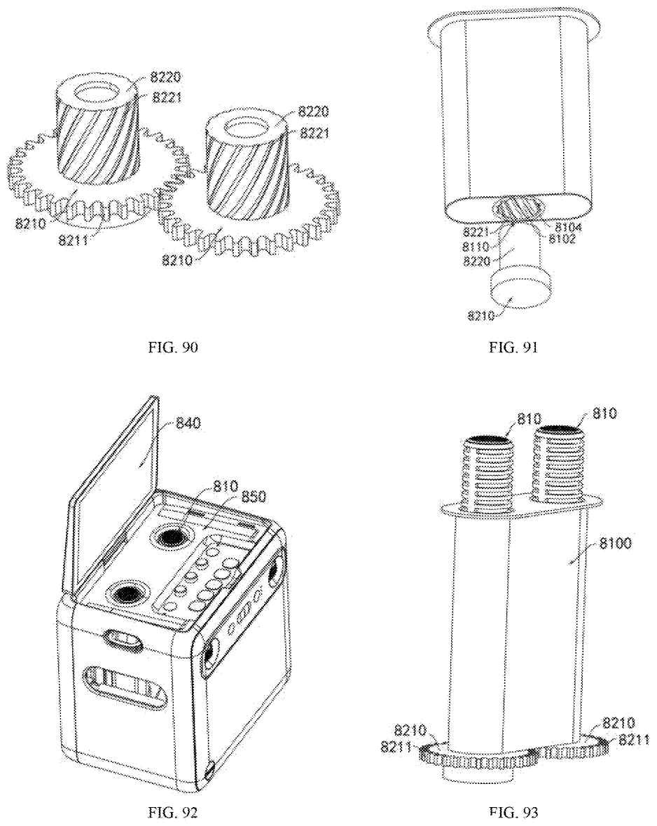

As shown in FIG. 90, it can be understood that a plurality of spiral grooves 8221 and a plurality of bumps 8110 are arranged, and the plurality of bumps 8110 are respectively arranged in the plurality of spiral grooves 8221 one by one. To address the tilting issue during the movement of the cylinder 8100, the plurality of bumps 8110 and the plurality of spiral grooves 8221 enhance the stability of the moving assembly 8200 in driving the cylinder 8100 to move along the first direction via the rotation of the rotating component 8210. Specifically, the plurality of protrusions 8110 may be respectively arranged in the plurality of spiral grooves 8221 one by one, wherein the plurality of spiral grooves 8221 are arranged at intervals around the first direction, and the plurality of protrusions 8110 are also arranged at intervals in sequence around the first direction. Of course, according to actual conditions, the plurality of protrusions 8110 may be arranged in the same spiral groove 8221 at the same time.

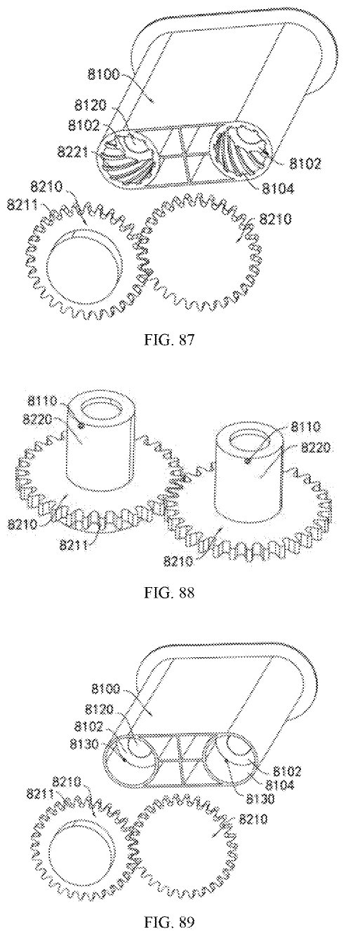

As shown in FIG. 87 to FIG. 90, it can be understood that the rotating part 8210 includes a rotating column 8220; at least one second accommodating groove 8102 is arranged at one end of the cylinder 8100 away from the first opening 8103, and one end of the second accommodating groove 8102 extends in the first direction to the outer wall of the cylinder 8100 to form a second opening 8104; the cylinder 8100 is movably sleeved on the rotating column 8220 via the second accommodating groove 8102 in the first direction; the spiral groove 8221 is spirally arranged around the first direction on the outer peripheral side of the rotating column 8220, and the protrusion 8110 is arranged on the inner wall of the second accommodating groove 8102; or, the spiral groove 8221 is spirally arranged around the first direction on the peripheral wall of the second accommodating groove 8102, and the protrusion 8110 is arranged on the side portion of the rotating column 8220. A first accommodating groove 8101 and a second accommodating groove 8102 are respectively arranged at the two ends of the cylinder 8100 along the first direction. The rotating column 8220 can extend into the second accommodating groove 8102 from the second opening 8104. The cylinder 8100 is sleeved outside the rotating column 8220 via the second accommodating groove 8102, so that the cylinder 8100 can move back and forth relative to the rotating column 8220 along the first direction. Specifically, the driving part is connected to the rotating column 8220 and can drive the rotating column 8220 to rotate. The rotating column 8220 is located below the cylinder 8100, so that the position of the rotating part 8210 can be defined by the driving part, thereby achieving a limiting and supporting effect on the cylinder 8100 and reducing the possibility of accidental falling of the cylinder 8100 caused by misoperation. In addition, the rotating column 8220 can support the cylinder 8100.

Specifically, the first opening 8103 and the second opening 8104 are respectively arranged at two ends of the cylinder 8100 along the first direction, and the first direction is parallel to the axial direction of the cylinder 8100.

In the embodiment of the invention, the microphone 810 may be inserted into the first accommodating groove 8101 through the first opening 8103. The moving assembly 8200 is connected to the cylinder 8100. When the microphone 810 needs to be stored, the moving assembly 8200 may drive the cylinder 8100 to move in the first direction to store the cylinder 8100 and the microphone 810, and realize storage of the microphone 810 into the smart device. When the microphone 810 needs to be taken out, the moving assembly 8200 may drive the cylinder 8100 to move in the first direction to push the cylinder 8100 and the microphone 810, reducing the difficulty for the user to take the microphone 810. Moreover, compared with the conventional storage manner using a torsion spring and a swing arm with a fixing seat, the smart microphone 810 storage assembly controls the position of the cylinder 8100 through the moving assembly 8200, thereby controlling the position of the microphone 810 in the cylinder 8100. It is easy to use and generates low noise, which can ensure user experience.

As shown in FIG. 91, in the embodiment of the invention, only one second accommodating groove 8102 may be provided. The rotating column 8220 can extend into the second accommodating groove 8102 through the second opening 8104, and the driving part drives the rotating column 8220 to realize the up-and-down movement of the cylinder 8100.

As shown in FIG. 89 and FIG. 90, it can be understood that the spiral groove 8221 can be provided on the outer periphery of the rotating column 8220, and the protrusion 8110 is arranged on the inner wall of the second accommodating groove 8102. When the driving part drives the rotating column 8220 to rotate, the protrusion 8110 slides in the spiral groove 8221, thereby driving the cylinder 8100 to move along the first direction.

As shown in FIG. 87 and FIG. 88, it can be understood that the protrusion 8110 can be arranged on the outer periphery of the rotating column 8220, and the spiral groove 8221 is arranged on the inner wall of the second accommodating groove 8102. When the driving part drives the rotating column 8220 to rotate, the protrusion 8110 slides in the spiral groove 8221, thereby driving the cylinder 8100 to move along the first direction.

As shown in FIG. 85 and FIG. 86, it can be understood that a plurality of rotating parts 8210 are arranged, a gear structure 8211 is arranged on the periphery of the rotating parts 8210, adjacent rotating parts 8210 are in meshed connection, and the driving part is in driving connection with one of the rotating parts 8210. The plurality of rotating parts 8210 can improve the stability of moving the cylinder 8100. In order to prevent the cylinder 8100 from tilting caused by different speeds of the plurality of rotating parts 8210, adjacent rotating parts 8210 are in meshed connection. The driving part can drive any one of the rotating parts 8210 to rotate, so that the plurality of rotating parts 8210 are synchronously controlled to rotate at the same time, thereby improving control stability. Specifically, protrusions 8110 or spiral grooves 8221 can be arranged on the plurality of rotating parts 8210; protrusions 8110 and spiral grooves 8221 are correspondingly arranged on the cylinder 8100; the protrusions 8110 correspond to the spiral grooves 8221 one to one; a plurality of second accommodating grooves 8102 are provided at one end of the cylinder 8100 away from the first opening 8103, and the plurality of rotating parts 8210 are respectively arranged in the plurality of second accommodating grooves 8102 one by one; any rotating part 8210 and the accommodating receiving groove 8102 are respectively provided with a protrusion 8110 and a spiral groove 8221, and the protrusion 8110 is movably arranged between the rotating part 8210 and the second accommodating groove 8102.

As shown in FIG. 85, it can be understood that the cylinder 8100 is provided with a plurality of first accommodating grooves 8101. The cylinder 8100 is provided with a plurality of first accommodating grooves 8101 and a plurality of first openings 8103, and the plurality of first openings 8103 are connected with the plurality of first accommodating grooves 8101 one by one.

To address the issue of the limited number of microphones 810 that the cylinder body 8100 can accommodate, a plurality of first accommodating grooves 8101 are provided. The plurality of first accommodating grooves 8101 extend along the first direction, thereby forming a plurality of first openings 8103. The plurality of first openings 8103 are connected with the plurality of first accommodating grooves 8101 one by one. By providing the plurality of first accommodating grooves 8101 and the plurality of first openings 8103, the cylinder 8100 can accommodate a plurality of microphones 810. The plurality of first accommodating grooves 8101 are arranged at intervals in sequence along the same direction. Of course, according to actual conditions, one cylinder body 8100 can be provided with one first accommodating groove 8101, and multiple microphones 810 can be accommodated through one first accommodating groove 8101 to reduce the injection molding difficulty in manufacturing the cylinder body 8100.

As shown in FIG. 87 and FIG. 89, it can be understood that a magnetic attraction component 8120 is further comprised. The magnetic attraction component 8120 is connected to the cylinder 8100 and is configured to attract the microphone 810 in the first accommodating groove 8101. To prevent the microphone 810 from easily falling out of the cylinder 8100, the magnetic attraction component 8120 is arranged to limit the position of the microphone 810 in the first accommodating groove 8101, improve the stability of the microphone 810 in the first accommodating groove 8101, and reduce the possibility of the microphone 810 falling out of the first accommodating groove 8101. Specifically, the magnetic attraction component 8120 can be arranged on the bottom wall of the second accommodating groove 8102 to avoid collision between the magnetic attraction component 8120 and the microphone 810 in the first accommodating groove 8101. It can be understood that a limit block 8130 is arranged on the bottom wall of the first accommodating groove 8101. The limit block 8130 is designed to extend below the microphone 810 to restrict the microphone 810 from moving further downward.

To reduce damage caused by collision between the microphone 810 and the inner wall of the first accommodating groove 8101 when the cylinder body 8100 is shaken, a recess structure is arranged at the bottom of the microphone 810. After the microphone 810 is placed into the first accommodating groove 8101, the limit block 8130 can be inserted into the recess structure at the bottom of the microphone 8100, so that the limit block 8130 extends below the microphone 810 to restrict the microphone 810 from further moving downward. In this way, the position of the microphone 810 in the first accommodating groove 8101 is limited, the collision degree between the microphone 810 and the inner wall of the first accommodating groove 8101 is reduced, and the possibility of the microphone 810 falling out of the first accommodating groove 8101 is lowered. It can be understood that a protruding structure is arranged on the peripheral wall of the first accommodating groove 8101, which can reduce the contact area between the microphone 810 and the peripheral wall of the first accommodating groove 8101, increase the friction therebetween, and therefore reduce the possibility of the microphone 810 falling out of the first accommodating groove 8101. To prevent the microphone 810 from falling out of the first accommodating groove 8101 when the cylinder body 8100 is shaken, specifically, the protruding structures may be a plurality of hemispherical protrusion structures arranged at intervals around the first direction on the inner wall of the first accommodating groove 8101. The protruding structures may also be raised strips. A plurality of raised strips may be arranged at intervals around the first direction on the inner wall of the first accommodating groove 8101, with the length direction of the raised strips being the first direction. Alternatively, the plurality of raised strips may be arranged at intervals along the first direction on the inner wall of the first accommodating groove 8101, with the length direction of the raised strips perpendicular to the first direction. The raised strips can provide a shockproof effect and reduce the vibration of the microphone 810 inside the first accommodating groove 8101.

The smart device according to the second aspect of the invention is described below with reference to FIG. 84 to FIG. 94.

The smart device comprises the smart microphone 810 storage assembly and the box 820 according to the first aspect of the invention. The box 820 is provided with a passage opening for the microphone 810 to pass through. The cylinder 8100 is located below the passage opening, and the moving assembly 8200 is configured to push upward the microphone 810 such that the microphone 810 protrudes at least partially out of the passage opening.

The smart device comprises a box 820; a passage opening is provided on the box 820; both the cylinder 8100 and the moving assembly 8200 are arranged inside the box 820; the first opening 8103 on the cylinder 8100 is arranged opposite to the passage opening on the box 820, so that the microphone 810 can be inserted into the first receiving groove 8101 through the through opening. The moving assembly 8200 can be fixedly connected to the box 820, and the cylinder 8100 is connected to the moving assembly 8200. The moving assembly 8200 enables the box 820 to move back and forth along the first direction, which is easy to operate and produces low noise, thereby ensuring user experience. When the microphone 810 remains connected to the smart speaker, howling occurs if it is too close to the smart speaker, producing harsh sound that severely affects user experience. Especially when the microphone 810 is stored into the smart speaker, the probability of howling triggered by impact and friction noises between the microphone 510 and the smart speaker is even higher. The microphone 810 can be automatically powered off, preventing howling when the microphone 810 approaches the smart speaker or during the storage of the microphone 810 into the speaker. In the embodiment of the invention, the smart device can be a smart speaker.

In some embodiments, the smart speaker is provided with a storage structure, which can be a smart microphone 810 storage assembly. The storage structure can be a cavity for storing the microphone 810, wherein the cavity can be a first accommodating groove 8101 provided in the cylinder 8100, and the microphone 810 is stored in an insertion manner. The depth of the cavity is greater than or equal to the length of the microphone 810. The first accommodating groove 8101 comprises a first opening 8103, through which the microphone 810 is inserted vertically or horizontally into the cavity along its length direction to achieve storage. A fixing structure for the microphone 810 can be arranged inside or outside the first opening 8103 to fix the microphone 810 after storage. The first opening 8103 may be arranged at any position of the smart speaker, including the top surface, side surface and bottom surface of the smart speaker. The storage structure can also be a groove, into which the microphone 810 is inserted and stored in a placement manner. A fixing structure for the microphone 810 may be arranged inside or outside the groove to fix the microphone 810 after storage. The microphone 810 is placed vertically or horizontally into the groove along a direction perpendicular to its length to achieve storage. The groove may be arranged at any position of the smart speaker, including the top surface, side surface and bottom surface of the smart speaker.

As shown in FIG. 93, in some embodiments, the smart speaker can also be connected to a screen via a movable structure, and can further be provided with a screen storage groove 850, wherein the screen 840 is stored in the screen storage groove 850 after being closed. The storage structure may be arranged under the screen 840. After the screen 840 is closed, the microphone 810 is completely covered by the screen 840 and fully stored inside the smart speaker. In some embodiments, the microphone 810 is automatically turned off in such a manner that the sensing element senses a distance between the smart speaker and the microphone 810, and the microphone 810 is automatically turned off when the sensed distance between the smart speaker and the microphone 810 is less than or equal to a preset distance. One or more sensing elements may be distributed, which may be Hall element, distance sensor, infrared sensor, any other individual electronic component capable of sensing the distance between the smart speaker and the microphone 810, or any combination of the electronic components. The sensing element can be arranged on the smart speaker and/or the microphone 810. Specifically, when the microphone 810 is inserted into the cavity, the sensing element can be arranged at the first opening 8103 of the first accommodating groove, so that the microphone 810 is powered off immediately when it is just inserted into the first opening 8103. The sensing element can also be arranged at one end of the cavity away from the first opening 8103 to prevent aging of the sensing element caused by exposure to the outside due to the first opening 8103 facing outward. When the microphone 810 is inserted into the groove, the sensing element may be disposed at one end, the middle, or both ends of the groove.

In some specific embodiments, the sensing element is a Hall element; the storage structure and the microphone 810 of the smart speaker have corresponding positions respectively; the magnetic component is arranged at the corresponding position of the microphone 810, and the Hall element is arranged at the corresponding position of the smart speaker; or the Hall element is arranged at the corresponding position of the microphone 810, and the magnetic component is arranged at the corresponding position of the smart speaker. In some embodiments, the triggering condition of the Hall element may be that the detected magnetic field intensity reaches a preset value. When the detected magnetic field intensity is greater than or equal to the preset value, it indicates that the distance between the smart speaker and the microphone 810 may trigger howling, and the microphone 810 needs to be powered off. Preferably, the magnetic component is arranged at the corresponding position of the microphone 810, and the Hall element is arranged at the corresponding position of the smart speaker. Given that the microphone 810 is moved around freely during karaoke sessions, the microphone 810 may be moved to the areas with strong external magnetic fields. The Hall element arranged on the microphone 810 may trigger accidental power-off of the microphone 810, thereby adversely affecting the experience.

The microphone 810 can be stored in an insertion manner, and the Hall element is arranged at the first opening 8103 or at one end away from the first opening 8103. Of course, the microphone 810 can also be stored in a placement manner, and the Hall element is arranged at one end, the middle or both ends of the groove.

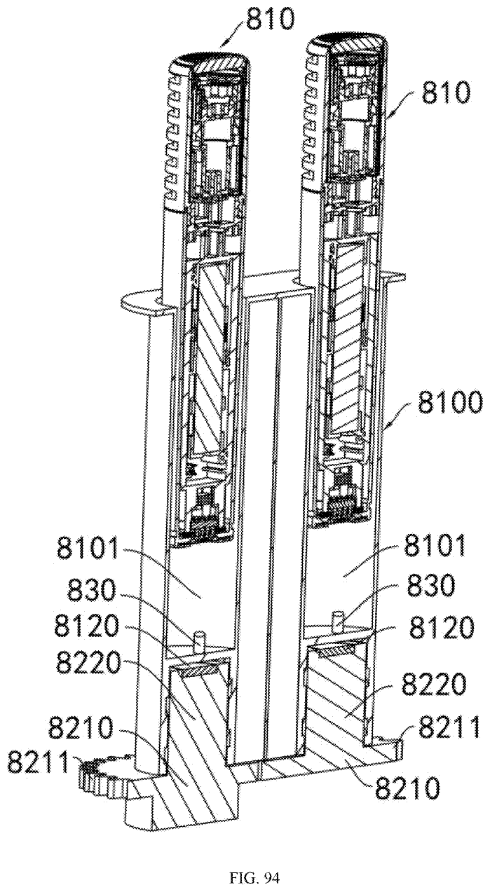

As shown in FIG. 94, in some specific embodiment, the sensing element is a Hall element; the smart speaker is correspondingly provided with a charging structure 830, which can be a charging pin; the microphone 810 is correspondingly provided with a power receiving structure. The triggering condition of the Hall element may be a magnetic field change caused at the moment of power-on when the microphone 810 is charged. When a magnetic field change is detected, it indicates that the distance between the smart speaker and the microphone 810 is sufficient to cause howling, and the microphone 810 needs to be powered off. The charging structure 830 can be arranged on the surface of the smart speaker or corresponding to the storage structure. The microphone 830 can be stored in an insertion manner; the charging structure 830 is arranged at one end of the cavity of the smart speaker away from the first opening 8103; a power receiving structure is correspondingly arranged at the bottom or the end bottom surface of the microphone 810; the Hall element is arranged near the charging structure 830 to sense a magnetic field change caused at the moment of power-on. The microphone 810 can be stored in a placement manner; the charging structure 830 is arranged at one end, the middle or both ends of the groove of the smart speaker; a power receiving structure is correspondingly arranged on the microphone 510; the Hall element is arranged near the charging structure 830 to sense a magnetic field change caused at the moment of power-on.

In some specific embodiments, the sensing element is a Hall element; the smart speaker is correspondingly provided with a charging structure 830, and both the storage structure and the microphone 810 are respectively provided with magnetic components, which are designed to fix the microphone 810 and are arranged outside the sensing trigger range of the Hall element. The microphone 810 can also be stored in a placement manner, and the charging structure 830 is arranged at one end, the middle or both ends of the groove for the smart speaker. The microphone 810 is correspondingly provided with a power receiving structure, and the Hall element is arranged near the charging structure 830. The Hall element can sense a magnetic field change caused at the moment of power-on. Preferably, the charging structure 830 is arranged at the bottom end of the first accommodating groove 8101, and the magnetic component is arranged at the other end or the middle of the groove of the first accommodating groove 8101. When the microphone 810 is cylindrical, a button is arranged on the surface of the microphone 810, the magnetic component is arranged on the opposite side of the button, so that the button of the microphone 810 faces the outside of the groove. Specifically, to prevent the microphone 810 from damaging the screen 840 on the smart speaker, a sensing structure can be arranged. When the screen is closed, the sensing structure detects the position of the screen 840 and controls the cylinder 100 to move downward to the first position, so that the microphone 810 retracts quickly. Alternatively, the speaker may prompt the user of potential interference between the microphone 810 and the screen 840. When the screen is opened, the sensing structure detects the position of the screen 840 and controls the cylinder 100 to move upward to the second position, so that the microphone 810 is automatically and rapidly raised for convenient use.

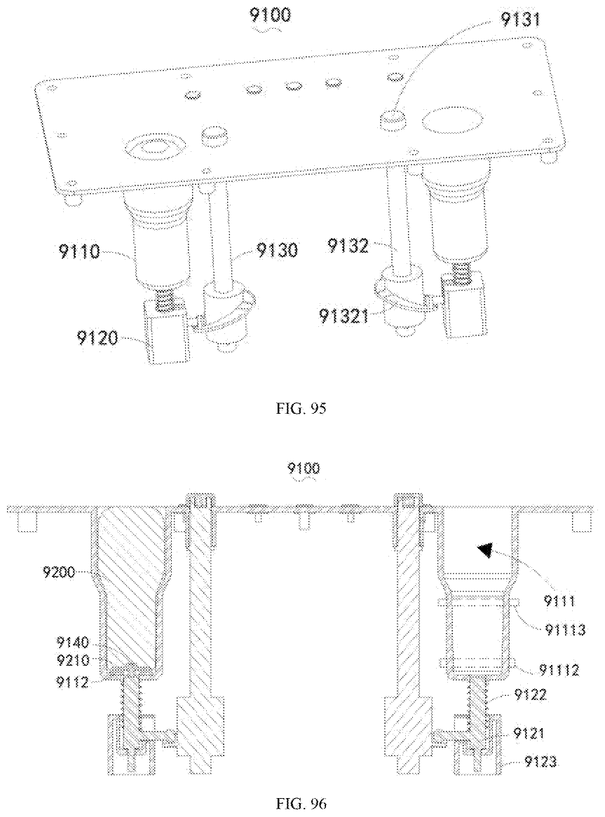

As shown in FIG. 95 to FIG. 102, the embodiment of the invention provides a microphone storage structure 9100, which comprises a storage assembly 9110, a jacking assembly 9120 and a knob assembly 9130. The storage assembly 9110 is formed with an accommodating cavity 9111 for placing the microphone 9200; at least part of the jacking assembly 9120 extends into the accommodating cavity 9111; the knob assembly 9130 is connected to the jacking assembly 9120, and the knob assembly 9130 rotates and drives the jacking assembly 9120 to drive the microphone 9200 in the accommodating cavity 9111 to move up and down. Exemplarily, the knob assembly 9130 comprises a drive component 9131 and a transmission rod 9132; the drive component 9131 is mounted at the end of the transmission rod 9132, and the transmission rod 9132 is in driving connection with the jacking assembly 9120. In this embodiment, the drive component 9131 is a knob. The user manually rotates the transmission rod 9132 via the drive component 9131, and the transmission rod 9132 drives the jacking component 9120 to move up and down to realize the access and storage of the microphone 9200. Anti-slip ridges can be arranged on the drive component 9131, which help increase the friction between the user's hand and the drive component 9131, thereby being convenient for the user to store and take the microphone 9200 by means of the drive component 9131. Of course, as an alternative, the drive component 9131 can also be configured as a handle, and the user can rotate the handle to lift or lower the jacking assembly 9120. Of course, as an alternative, a drive mechanism may be arranged to drive the transmission rod 9132 to rotate, and the user can control the start and stop of the drive mechanism via a switch button. The drive mechanism drives the jacking assembly 9120 to move up and down in an electrically driven manner. The drive mechanism is in driving connection with the jacking assembly 9120, and can drive the jacking assembly 9120 to move up and down by receiving signals from the control system. For example, when the user issues an instruction of “use microphone”, the drive mechanism drives the jacking assembly 9120 to move upward and push out the microphone 9200. When the user issues an instruction of “store microphone”, the drive mechanism drives the jacking assembly 9120 to move downward and safely store the microphone 9200 into the accommodating cavity 9111. More specifically, in the smart speaker, the user gives a command to the smart speaker via a voice command or other control method. After receiving the command, the control system of the speaker parses and converts it into a corresponding control signal, which is sent to the drive mechanism to trigger operation. The drive mechanism drives the knob assembly 9130 to rotate accordingly according to the command, and the rotation of the knob assembly 9130 drives the jacking assembly 9120 to move up or down to complete the removal or storage of the microphone 9200. Upon completion of the whole process, the system returns to the standby state and waits for the next command.

In some embodiments, the microphone storage structure 9100 may be an accommodating cavity 9111 for accommodating the microphone 9200. The depth of the accommodating cavity 9111 is greater than or equal to the length of the microphone 9200. The accommodating cavity 9111 comprises an opening 91111, through which the microphone 9200 is inserted vertically or horizontally into the accommodating cavity 9111 along its length direction to achieve storage. A fixing structure for the microphone 9200 may be arranged inside or outside the opening 91111 to fix the microphone 9200 after storage. The opening 91111 may be arranged at any position of the smart speaker 9300, including the top surface, side surface and bottom surface of the smart speaker.

As shown in FIG. 95, FIG. 96 and FIG. 99, the microphone storage structure 9100 in this embodiment is provided with a knob assembly 9130 and a jacking assembly 9120. During storage of the microphone 9200, the jacking assembly 9120 is controlled to move up and down by rotating the knob assembly 9130, thereby completing the storage and removal of the microphone 9200. In the application, the knob assembly 9130 and the lifting assembly 9120 are used to replace the conventional torsion spring and swing arm structure, thereby avoiding the risk that the microphone 9200 sometimes cannot be locked or ejected due to small compatible angle between the torsion spring and the swing arm.

This not only improves the stability of the storage structure itself, but also avoids noise during use, which is conducive to improving user experience. As shown in FIG. 95, FIG. 96 and FIG. 99, in a possible embodiment, the jacking assembly 9120 comprises a jacking component 9121, and the knob assembly 9130 is provided with a guide portion 91321, which is spirally arranged and abuts against the jacking component 9121. Exemplarily, the guide portion 91321 is formed on the transmission rod 9132 and located at one end away from the drive component 9131; the guide portion 91321 is spirally arranged and abuts against the jacking component 9121. As the knob assembly 9130 rotates, the guide portion 91321 guides the jacking component 9121 to move along a helical trajectory, thereby realizing the lifting and lowering of the microphone 9200. The spiral design of the guide portion 91321 provides precise control force and direction, ensuring stable movement of the jacking component 9121 and avoiding damage or instability caused by improper operation. The design of the guide portion 91321 helps improve the stability of the entire microphone storage structure 9100. The fit between the knob assembly 9130 and the jacking assembly 9120 replaces the conventional torsion spring and swing arm structure, reducing the risk that the microphone 9200 cannot be locked or ejected due to incompatible angles between the torsion spring and the swing arm. The fit between the guide portion 91321 and the knob assembly 9130 can avoid noise during storage of the microphone 9200, thereby improving user experience. This is of great importance for improving the overall user experience of the smart speaker 9300.

The user can conveniently control the storage and ejection of the microphone 9200 by rotating the knob assembly 9130, and the operation is simple and intuitive.

As shown in FIG. 95, FIG. 96 and FIG. 99, in a possible embodiment, the jacking assembly 9120 further comprises a first elastic element 9122, which abuts between the storage assembly 9110 and the lifting component 9121; the guide portion 91321 is provided with an upper abutting surface 91321A, and the lifting component 9121 abuts against the upper abutting surface 91321A. Exemplarily, the upper abutting surface 91321A is a specific plane or region designed on the guide portion 91321, configured to abut against the jacking component 9121.

Understandably, in this embodiment, the first elastic element 9122 is a compression spring; the jacking mechanism moves upward when the knob assembly 9130 rotates clockwise, and moves downward when the knob assembly 9130 rotates counterclockwise. Specifically, when the knob assembly 9130 rotates clockwise, the jacking component 9121 is driven upward by the upper abutting surface 91321A, and the first elastic element 9122 is compressed at this time. When the knob assembly 9130 rotates counterclockwise, the compression of the first elastic element 9122 is released, thereby lowering the jacking component 9121.

As shown in FIG. 95, FIG. 96 and FIG. 98, in a possible embodiment, the jacking assembly 9120 further comprises a fixing seat 9123, and the jacking component 9121 is slidably mounted on the fixing seat 9123. Exemplarily, the fixing seat 9123 provides a stable support platform for the jacking assembly 9120, and guides the movement of the jacking component 9121 through its internal structure.

As shown in FIG. 98 and FIG. 99, in a possible embodiment, the fixing seat 9123 comprises a sliding cavity 91231, a first through slot 91232 and a second through slot 91233. The first through slot 91232 and the second through slot 91233 are respectively connected to the sliding cavity 91231. The jacking component 9121 comprises an ejector rod 91211, a crossbar 91212 and a vertical rod 91213. The crossbar 91212 and the vertical bar 91213 are respectively connected to the ejector rod 91211. The ejector rod 91211 is slidably fitted with the sliding cavity 91231. The crossbar 91212 abuts against the guide portion 91321 through the first through slot 91232, and the crossbar 91212 is slidably fitted with the second through slot 91233. Exemplarily, the sliding cavity 91231 inside the fixing seat 9123 allows a smooth sliding fit between the ejector rod 91211 and the sliding cavity 91231, which facilitates stable lifting and lowering of the jacking assembly 9120. The second through slot 91233 provides a guiding function for the vertical bar 91213 in the jacking assembly 9120, ensuring that the jacking component 9121 can move along a predetermined trajectory. The design of the sliding cavity 91231 and the second through slot 91233 helps improve the stability of the entire jacking assembly 9120 and reduces shaking or displacement during use. The first through slot 91232 is configured for the crossbar 91212 to pass through and abut against the guide portion 91321. Meanwhile, the first through slot 91232 also functions to restrict rotation of the crossbar 91212, such that the crossbar 91212 can only reciprocate in a vertical direction.

As shown in FIG. 100, in a possible embodiment, the knob assembly 9130 further comprises a first stop block 91322 and a second stop block 91323; the first stop block 91322 and the second stop block 91323 are respectively arranged at two ends of the guide portion 91321 to prevent the jacking component 9121 from disengaging from the guide portion 91321. Exemplarily, the main functions of the first stop block 91322 and the second stop block 91323 are to limit the movement range of the lifting member 9121 and prevent the jacking component 9121 from excessive movement or disengagement from the guide portion 91321. The limitation by the first stop block 91322 and the second stop block 91323 ensures that the jacking component 9121 stops when moving up or down to a specific position, thereby guaranteeing accurate positioning and stable storage of the microphone 9200. During rotation of the knob assembly 9130, the first stop block 91322 and the second stop block 91323 prevent the jacking component 9121 from accidentally disengaging from the guide portion 91321, ensuring structural safety and reducing structural damage caused by accidental collision or improper operation. As shown in FIG. 100, in a possible embodiment, the guide portion 91321 is provided with a first abutting surface 91321C and a second abutting surface 91321D. Both the first abutting surface 91321C and the second abutting surface 91321D are flat surfaces. The first abutting surface 91321C is adjacent to the first stop block 91322, and the second abutting surface 91321D is adjacent to the second stopper. When the crossbar 91212 moves to the position of the first abutting surface 91321C, the crossbar 91212 abuts against the first stop block 91322.

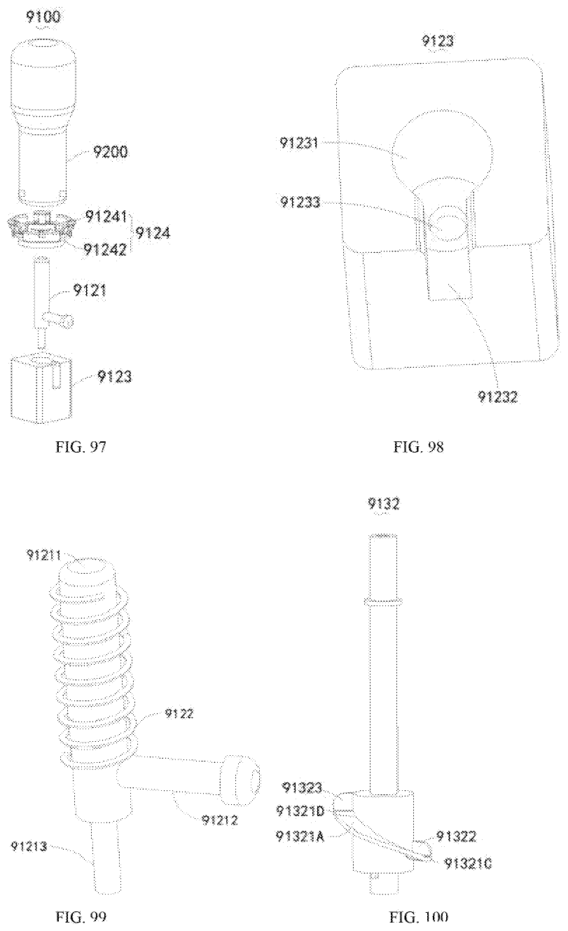

At this time, the microphone 9200 is in the storage position. When the crossbar 91212 moves to the second abutting surface 91321D, the crossbar 91212 abuts against the second stop block 91323, and the microphone 9200 is in the taking position. It can be understood that the first abutting surface 91321C and the second abutting surface 91321D are arranged to keep the crossbar 91212 stationary when reaching the storage position and the taking position. For example, in the taking position, the second abutting surface 91321D prevents the crossbar 91212 from moving under the action of the first elastic element 9122, thereby further improving the stability of the microphone storage structure 9100 of the application. As shown in FIG. 96 and FIG. 97, in a possible embodiment, the jacking assembly 9120 further comprises a clamping jaw 9124; the clamping jaw 9124 is connected to the jacking component 9121 and arranged in the accommodating cavity 9111; the microphone 9300 is provided with a notch 9220 matched with the clamping jaw 9124; the accommodating cavity comprises a first position and a second position; the first position is arranged close to the jacking assembly, and the second position is arranged away from the jacking assembly; the hole diameter of the first position is smaller than that of the second position. In other words, the hole diameter of the accommodating cavity 9111 gradually increases in a direction away from the jacking assembly 9120. Exemplarily, the clamping jaw 9124 comprises a clamping jaw body 91241 and a clamping jaw portion 91242; the clamping jaw portion 91242 extends from the clamping jaw body 91241 and is deformable under an external force. When the microphone 9200 is in the storage position, the clamping jaw 9124 is located at the bottom of the accommodating cavity 9111. At this time, the hole diameter of the accommodating cavity 9111 is small, and the clamping jaw portion 91242 is squeezed by the accommodating cavity 9111 and located in the notch 9220, thereby fixing the microphone 9200. When the jacking component 9121 rises to the taking position, the hole diameter of the accommodating cavity 9111 becomes large, and the clamping jaw portion 91242 is no longer squeezed by the accommodating cavity 9111. The clamping jaw portion 91242 is disengaged from the notch 9220, releasing the fixation of the microphone 9200, so that the user can conveniently take the microphone 9200.

As shown in FIG. 96, in a possible embodiment, the storage assembly 9110 further comprises a first magnetic element 9112; the first magnetic element 9112 is arranged at the bottom of the accommodating cavity 9111; a second magnetic element 9210 matched with the first magnetic element 9112 is arranged on the microphone 920; the microphone storage structure 9100 further comprises a charging portion 9140, which is arranged on the storage assembly 9110 or the jacking assembly 9120. Exemplarily, the first magnetic element 9112 and the second magnetic element 9210 are both magnets. When the microphone 9200 needs to be removed, the jacking assembly 9120 exerts a force greater than the attractive force between the two magnets, so that the microphone 9200 is forcibly pushed upward. The charging portion 9140 may be a plug-in charging pin, a contact charging probe or a wireless charging structure. It should be noted that the charging portion 9140 can be arranged either on the storage assembly 9110 or on the jacking assembly 9120. For example, the charging portion 9140 is arranged at the bottom of the accommodating cavity 9111 or on the ejector rod 91211 of the jacking component 9121.

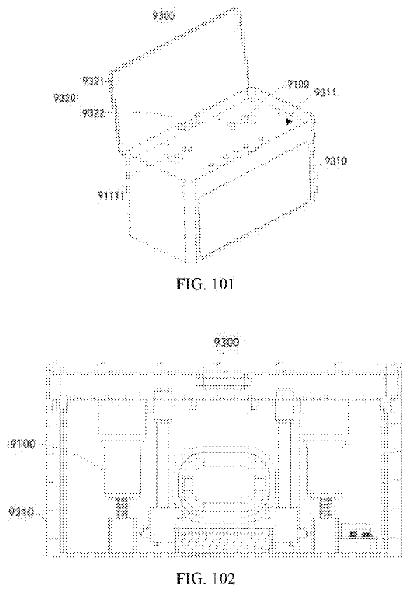

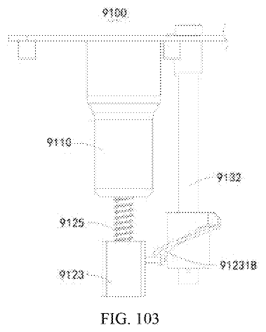

As shown in FIG. 101 and FIG. 102, the second purpose of the invention is to provide a smart speaker 9300, comprising a speaker body 9310 and the microphone storage structure 9100, wherein the microphone storage structure 9100 is installed in the speaker body 9310. Exemplarily, in this embodiment, the knob assembly 9130 is rotatably mounted on the speaker body 9310. As shown in FIGS. 101 and 102, the smart speaker 9300 further comprises a screen 9320; the speaker body 9310 is provided with a storage groove 9311 for storing the screen 9320; the screen 9320 comprises a screen body 9321 and a rotating shaft 9322; the screen body 9321 is rotatably mounted on the speaker body 9310 via the rotating shaft 9322; the screen body 9321 can be used to display various information, such as song information, and for the user to perform control operations on the smart speaker 9300; the accommodating cavity 9111 has an opening 91111, which is connected with the storage groove 9311. When being not in use, the screen body 9321 is stored in the storage groove 9311, and the display side of the screen body 9321 is close to the bottom surface of the storage groove 9311. On the one hand, this helps protect the screen body 9321. On the other hand, the screen body 9321 closes the opening 91111, so that the microphone is completely hidden when stored, preventing dust, moisture and other foreign matters from entering the microphone accommodating cavity and affecting charging, thereby achieving the purpose of protecting the microphone storage structure 9100. When the microphone 9200 remains connected to the smart speaker 9300, howling occurs if it is too close to the smart speaker 9300, producing harsh sound that severely affects user experience. Especially when the microphone 9200 is stored into the smart speaker 9300, the probability of howling triggered by impact and friction noises between the microphone 9200 and the smart speaker 9300 is even higher. The microphone 9200 can be automatically powered off, preventing howling when the microphone 9200 approaches the smart speaker 9300 or during the storage of the microphone 9200 into the smart speaker 9300.

In some embodiments, the smart speaker 9300 may also be connected to the screen 9320 via a movable structure, and a screen 9320 storage groove 9311 may be provided. After being closed, the screen 9320 is stored in the screen 9320 storage groove 9311. The storage structure may be arranged under the screen 9320. After the screen 9320 is closed, the microphone 9200 is completely covered by the screen 9320 and fully stored inside the smart speaker 9300. In some embodiments, the microphone 9200 is automatically turned off in such a manner that the sensing element senses a distance between the smart speaker 9300 and the microphone 9200, and the microphone 9200 is automatically turned off when the sensed distance between the smart speaker 9300 and the microphone 9200 is less than or equal to a preset distance. One or more sensing elements may be distributed, which may be Hall element, distance sensor, infrared sensor, any other individual electronic component capable of sensing the distance between the smart speaker 9300 and the microphone 9200, or any combination of the electronic components. The sensing element can be arranged on the smart speaker 9300 and/or the microphone 9200. Specifically, when the microphone 9200 is inserted into the accommodating cavity 9111, the sensing element can be arranged at the opening 91111 of the first accommodating cavity 9111, so that the microphone 9200 is powered off immediately when it is just inserted into the opening 91111. The sensing element can also be arranged at one end of the accommodating cavity 9111 away from the opening 91111 to prevent aging of the sensing element caused by exposure to the outside due to the opening 91111 facing outward.

In some specific embodiments, the sensing element is a Hall element; the storage structure and the microphone 9200 of the smart speaker 9300 have corresponding positions respectively; the magnetic component is arranged at the corresponding position of the microphone 9200, and the Hall element is arranged at the corresponding position of the smart speaker 9300; or the Hall element is arranged at the corresponding position of the microphone 9200, and the magnetic component is arranged at the corresponding position of the smart speaker 9300. In some embodiments, the triggering condition of the Hall element may be that the detected magnetic field intensity reaches a preset value. When the detected magnetic field intensity is greater than or equal to the preset value, it indicates that the distance between the smart speaker 9300 and the microphone 9200 may trigger howling, and the microphone 9200 needs to be powered off. Preferably, the magnetic component is arranged at the corresponding position of the microphone 9200, and the Hall element is arranged at the corresponding position of the smart speaker. Given that the microphone 9200 is moved around freely during karaoke sessions, the microphone 9200 may be moved to the areas with strong external magnetic fields. The Hall element arranged on the microphone 9200 may trigger accidental power-off of the microphone 9200, thereby adversely affecting the experience. The microphone 9200 may be stored in an insertable manner; the Hall element is arranged at the opening 91111 of the accommodating cavity 9111 of the smart speaker 9300 or at one end away from the opening 91111.

In some specific embodiments, the sensing element is a Hall element; the microphone storage structure 9100 is correspondingly provided with a charging portion 9140; the microphone 9200 is correspondingly provided with a power receiving structure. The triggering condition of the Hall element may be a magnetic field change caused at the moment of power-on when the microphone 9200 is charged. When a magnetic field change is detected, it indicates that the distance between the smart speaker 9300 and the microphone 9200 is sufficient to cause howling, and the microphone 9200 needs to be powered off. The charging portion 9140 can be arranged on the surface of the smart speaker 9300 or corresponding to the receiving structure. The microphone 9200 can be stored in an insertion manner. The charging portion 9140 is arranged at one end of the accommodating cavity 9111 of the smart speaker 9300 that is away from the opening 91111. A power receiving structure is correspondingly arranged at the bottom or end bottom surface of the microphone 9200. The Hall element is arranged near the charging portion 9140 and is capable of sensing a magnetic field change caused at the moment of power-on.

In some specific embodiments, the sensing element is a Hall element; the microphone storage structure 9100 is correspondingly provided with a charging portion 9140; a first magnetic component 9112 is arranged on the storage structure, and a second magnetic component 9210 is arranged on the microphone 9200; the microphone 9200 is fixed by the first magnetic component9112 and the second magnetic component9210; the magnetic components are arranged outside the sensing trigger range of the Hall element.

As shown in FIG. 103, compared with the first embodiment, this embodiment differs in the abutment position of the guide portion 91321. The specific solution is as follows:

As shown in FIG. 103, in a possible embodiment, the jacking assembly 9120 further comprises a second elastic element 9125, which is connected between the storage assembly 9110 and the jacking component 9121; the guide portion 91321 is provided with a lower abutting surface 91321B, and the jacking component 9121 abuts against the lower abutting surface 91321B. Exemplarily, the lower abutting surface 91321B provides a supporting point for the jacking component 9121. When the knob assembly 9130 rotates counterclockwise, the jacking component 9121 falls under the action of the lower abutting surface 91321B, ensuring that the jacking component 9121 can stably move to the storage position. The lower abutting surface 91321B is a specific plane or area designed on the guide portion 91321 to abut against the jacking component 9121. Understandably, in this embodiment, the second elastic element is an extension spring. The jacking mechanism falls when the knob assembly 9130 rotates clockwise, and rises when the knob assembly 9130 rotates counterclockwise. Specifically, when the knob assembly 9130 rotates clockwise, the jacking component 9121 falls under the action of the lower abutting surface 91321B, and the second elastic element 9125 is stretched at this time. When the knob assembly 9130 rotates counterclockwise, the tension and compression amount of the second elastic element 9125 is released, so that the jacking component 9121 rises. Except for the differences in the structures described above, the microphone storage structure 9100, the smart speaker 9300 and the components thereof in this embodiment are the same as those in Embodiment 1, and will not be described in detail herein.

The above embodiments only illustrate several implementation modes of the invention. Although the descriptions are relatively specific and detailed, they should not be construed as limiting the scope of the patent application. It should be pointed out that those skilled in the art can make several modifications and improvements without departing from the concept of the invention, and these all fall within the protection scope of the invention. Therefore, the protection scope of the invention patent shall be subject to the appended claims.

What is claimed is:

1. An automatic microphone lifting structure, comprising a speaker body and at least one microphone, wherein
a screen is connected to the speaker body; a storage groove for storing the microphone is formed on the speaker body; the storage groove is provided with a receiving assembly electrically connected to the screen or the speaker body; when the screen is opened or closed, the receiving assembly automatically lifts or stores the microphone in the storage groove.

2. The automatic microphone lifting structure according to claim 1, wherein a sensor is arranged in the screen or the speaker body, is electrically connected to the receiving assembly, and is used for sensing the rotation direction and angle of the screen or sensing the distance between the screen and the top surface of the placement slot to realize automatic lifting or storage of the microphone through the receiving assembly.

3. The automatic microphone lifting structure according to claim 1, wherein the upper surface of the speaker body is concave downward to form a placement slot, the screen is flipped and received in the placement slot, and the opening of the storage groove is located at the bottom of the placement slot.

4. The automatic microphone lifting structure according to claim 3, wherein the number of the storage grooves corresponds to the number of microphones one to one; the depth of each storage groove is greater than or equal to the height of the microphone; the microphone is movably lifted or stored in the storage groove.

5. The automatic microphone lifting structure according to claim 1, wherein a control button is arranged on the speaker body, is electrically connected to the receiving assembly and controls the operation of the receiving assembly; or a control button is arranged on the microphone, is electrically connected to the receiving assembly and controls the operation of the receiving assembly.

6. A smart speaker, comprising:
a speaker body;
a microphone storage assembly, arranged inside the speaker body and comprising a drive assembly and a bearing seat for bearing the microphone; the drive assembly is arranged opposite to the bearing seat and is connected to the bearing seat to drive the bearing seat to move along a first direction.

7. The smart speaker according to claim 6, wherein the drive assembly comprises a drive motor and a gear; the gear is connected to a drive end of the drive motor, and the bearing seat is formed with a rack portion engaged with the gear.

8. The smart speaker according to claim 6, wherein the microphone storage assembly further comprises a charging portion; the bearing seat is formed with a storage groove for storing the microphone; the storage groove is provided with an opening; the charging portion is arranged at one end of the storage groove remote from the opening.

9. The smart speaker according to claim 6, wherein the bearing seat is provided with a first magnetic attraction component; the microphone is provided with a second magnetic attraction component matched with the first magnetic attraction component.

10. The smart speaker according to claim 6, wherein the drive assembly is located on one side of the bearing seat.

11. The smart speaker according to claim 6, wherein the microphone storage assembly comprises a fixing seat; the fixing seat is formed with a mounting groove, and the bearing seat is slidably mounted in the mounting groove.

12. The smart speaker according to claim 11, wherein the fixing seat comprises a seat body and a guide post; the mounting groove is formed on the seat body; the guide post is arranged in the mounting groove; the bearing seat is slidably connected to the guide post.

13. The smart speaker according to claim 11, wherein the speaker body comprises a housing; the housing comprising a peripheral side plate, a top plate and a bottom plate; the top plate and the bottom plate are respectively connected to opposite sides of the peripheral side plate; diffusion slots are distributed on the peripheral side plate; assume the area of the peripheral side plate to be S1, and assume the total area of all diffusion slots on the peripheral side plate to be S2, then the ratio S2/S1 is not less than 0.4.

14. The smart speaker according to claim 13, wherein the guide post is mounted on the circumferential side plate or the bottom plate.

15. The smart speaker according to claim 11, wherein the housing comprises an inner housing and an outer housing; the inner housing is nested within the outer housing; the diffusion slots are arranged on the outer housing; the inner housing comprises a front shell plate and a rear shell plate arranged on opposite sides.

16. The smart speaker according to claim 15, wherein the speaker body further comprises a high-frequency speaker, a low-frequency speaker and a full-frequency speaker; the high-frequency speaker and the low-frequency speaker are mounted on the front shell plate, and the full-range speaker is mounted on the rear shell plate.

17. The smart speaker according to claim 13, wherein the speaker body further comprises a screen, a damping shaft and a sensor; the screen is rotatably connected to the top plate via the damping shaft to close or open the storage groove; the sensor is used to detect the position of the screen.

18. The smart speaker according to claim 6, wherein the microphone storage assembly further comprises:
a seat body, with an accommodating cavity open at one end;
a gear, which arranged beside the seat body and extending into the accommodating cavity such that the gear abuts against the microphone placed in the seat body;
a drive motor, which is arranged beside the gear, in driving connection with the gear and used for driving the gear to displace the microphone in the accommodating cavity.

19. The smart speaker according to claim 18, wherein the microphone storage assembly further comprises a support and guide assembly, which is arranged beside the gear; when the microphone is placed in the accommodating cavity, the support and guide assembly is used to guide or fix the microphone during storage.

20. The smart speaker according to claim 6, wherein the microphone storage assembly also comprises:
a seat body, which is located inside the speaker body;
a telescopic assembly, which is positioned in the seat body and extends and retracts along the seat body;
a drive motor, which is arranged on the seat body, in driving connection with the telescopic assembly and driving the telescopic assembly to extend and retract.

21. The smart speaker according to claim 20, wherein the drive motor comprises a rotary drive mechanism;
the telescopic assembly comprises a lifting component and a rotating component, and the rotating component is in driving connection with the drive end of the rotary drive mechanism;
the lifting component and the rotating component are connected through a transmission structure, which is used for converting the rotary motion of the rotating component into the lifting motion of the lifting component.

22. The smart speaker according to claim 6, wherein the microphone storage assembly further comprises a housing, a lifting assembly, a microphone and at least one storage groove for accommodating the microphone; an opening connected to the outer wall of the housing is arranged at one end of the storage groove; the lifting assembly is arranged at the end of the storage groove away from the opening; the lifting assembly is connected to the microphone to drive the microphone to reciprocate between a first position and a second position in the storage groove.

23. The smart speaker according to claim 22, wherein the lifting assembly is mounted inside the housing; and
the lifting assembly comprises a lifting motor, a fixing seat and a lead screw connected with the output shaft of the lifting motor; a threaded hole is formed at the bottom of the fixing seat, and the lead screw is in threaded connection with the threaded hole; when the lifting motor drives the lead screw to rotate, the lead screw drives the fixing seat to move; the microphone is detachably connected to the fixing seat, and the fixing seat is driven to move and drive the microphone to reciprocate between the first position and the second position in the storage groove.

24. A control method for a smart speaker, used for controlling the smart speaker, comprising:
when a first preset condition is satisfied, a microphone rises to a first position; otherwise, the microphone does not rise; wherein the smart speaker comprises:
a speaker body;
a microphone storage assembly, arranged inside the speaker body and comprising a drive assembly and a bearing seat for bearing the microphone; the drive assembly is arranged opposite to the bearing seat and is connected to the bearing seat to drive the bearing seat to move along a first direction.

25. The control method for the smart speaker according to claim 24, wherein when the first preset condition is satisfied, the method comprises the following: the smart speaker is powered on and started up, and a screen is opened;
detecting an included angle between the top surface of the smart speaker and the screen, wherein the included angle is greater than or equal to a preset angle.

26. The control method for the smart speaker according to claim 25, wherein when a second preset condition is satisfied, the microphone falls from the second position to the first position.

27. The control method for the smart speaker according to claim 26, wherein the second preset condition comprises:
the power supply of the speaker body is turned off; or
the included angle is smaller than the preset angle; or
the smart speaker receives a microphone storage instruction.

28. The control method for the smart speaker according to claim 26, wherein when a second preset condition is satisfied, the microphone falls at a first speed; when a third preset condition is satisfied, the microphone falls at a second speed, and the second speed is greater than the first speed.

29. The control method for the smart speaker according to claim 26, wherein when a fourth preset condition is satisfied, the microphone is determined to be unnecessary for use, and the microphone falls from the second position to the first position.

30. The control method for the smart speaker according to claim 26, wherein when a fifth preset condition is satisfied, the microphone is determined to need to be raised again, and the microphone rises from the second position to the first position.
